(19) United States
(12) Patent Application Publication
(10) Pub. No.: US 2025/0013209 A1
(43) Pub. Date: Jan. 9, 2025

(54) A SYSTEM AND METHOD FOR INTELLIGENTLY SELECTING SENSORS AND THEIR ASSOCIATED OPERATING PARAMETERS

(71) Applicant: SPORTS DATA LABS, INC., Royal Oak, MI (US)

(72) Inventors: Vivek KHARE, Cupertino, CA (US); Mark GORSKI, Royal Oak, MI (US); Stanley MIMOTO, Bethel Island, CA (US); Anuroop YADAV, Livingston, NJ (US)

(73) Assignee: SPORTS DATA LABS, INC., Royal Oak, MI (US)

(21) Appl. No.: 18/710,165

(22) PCT Filed: Nov. 15, 2022
(86) PCT No.: PCT/US2022/049946

§ 371 Date: May 14, 2024

Related U.S. Application Data
(60) Provisional application No. 63/279,321, filed on Nov. 15, 2021.

(51) Int. Cl. G05B 13/02

(52) U.S. Cl. CPC G05B 13/0265

(57) ABSTRACT

A system for intelligently selecting sensors and their associated operating parameters includes one or more source sensors that gather animal data from at least one targeted individual and a collecting computing device in electrical communication with the one or more source sensors. The collecting computing device is operable to utilize one or more Artificial Intelligence techniques to: (1) intelligently gather the animal data from the one or more source sensors; (2) create, modify, or access one or more commands; and (3) and intelligently transmit the one or more commands either directly or indirectly to the one or more source sensors to create or modify one or more sensor operating parameters.

### CROSS-REFERENCE TO RELATED APPLICATIONS

This application claims the benefit of U.S. provisional application Ser. No. 63/279,321 filed Nov. 15, 2021, the disclosure of which is hereby incorporated in its entirety by reference herein.

### TECHNICAL FIELD

In at least one aspect, the present invention relates to a system and method for collecting animal data with an intelligent system that selects sensors and their associated operating parameters.

### BACKGROUND

The collection and processing of sensor-based biological data from subjects, such as humans (e.g., athletes, healthcare patients, insurance customers) and other animals, is an emerging field. The collection of such data from sensors and sensing systems can be used to evaluate patients for illnesses, quantify the performance of athletes and other animals, create monetary value for data owners, and provide guidance for everyday living. Since this field in relatively new, technology needs to be developed to improve the collection, processing, distribution, and use of such data in a way that dynamically takes into account other sources of information, particularly in real-time or near real-time, that impacts the collection, processing, distribution, or use of such data.

### SUMMARY

In at least one aspect, a system for intelligently selecting sensors and their associated operating parameters is provided. The system includes one or more source sensors that gather animal data from at least one targeted individual and a collecting computing device in electrical communication with the one or more source sensors. The collecting computing device is configured to utilize one or more Artificial Intelligence techniques to: (1) intelligently gather the animal data from the one or more source sensors; (2) create and/or modify and/or access one or more commands that provide one or more instructions to the one or more source sensors to perform one or more actions; and (3) intelligently transmit the one or more commands either directly (e.g., directly to the one or more source sensors) or indirectly (e.g., via another one or more sensors; via another one or more computing devices in communication with the one or more source sensors) to the one or more source sensors to create or modify one or more sensor operating parameters. At least one variable is created, gathered, or observed (e.g., identified) by the collecting computing device, the at least one variable being utilized by the collecting computing device to derive information that either directly or indirectly induces the collecting computing device or other computing devices in communication with the collecting computing device to automatically initiate one or more actions to create or modify at least one evaluation indicator. The at least one evaluation indicator provides information (e.g., via its one or more outputs) to the collecting computing device or other computing device in communication with the collecting computing device that automatically initiates the collecting computing device to create, modify, or access one or more commands that provide one or more instructions to the one or more source sensors (e.g., to take one or more actions), and transmit the one or more commands to the one or more source sensors, the one or more commands including at least one of: (1) selecting and enabling (e.g., activating) the one or more source sensors to provide animal data to one or more computing devices (e.g., which can include the collecting computing device); (2) selecting and stopping (e.g., deactivating) the one or more source sensors from providing animal data to one or more computing devices; (3) creating, modifying, setting, or a combination thereof, one or more sensor parameters for each of the one or more source sensors which change one or more actions taken by the one or more source sensors or one or more computing devices in communication with the one or more source sensors; or (4) a combination thereof.

In at least another aspect, a method for intelligently selecting sensors and their associated operating parameters is provided. The method includes a step of gathering animal data from one or more source sensors from at least one targeted individual, the one or more source sensors configured to be in electronic communication with a collecting computing device. The method includes another step of creating and/or gathering, and/or observing, via the collecting computing device, at least one variable, the at least one variable being utilized by the collecting computing device to derive information that either directly or indirectly induces the collecting computing device or another computing device in communication with the collecting computing device to automatically initiate one or more actions to create or modify at least one evaluation indicator. The method includes another step of deriving, via the collecting computing device or other computing device in communication with the collecting computing device, information from the at least one evaluation indicator (e.g., via its one or more outputs), wherein at least a portion of the derived information automatically initiates the collecting computing device to take (e.g., intelligently) one or more actions, the one or more actions including one or all of: (1) creating and/or modifying and/or accessing one or more commands that provide one or more instructions to perform one or more actions to the one or more source sensors, and (2) transmitting the one or more commands to the one or more source sensors, the one or more commands including at least one of: (i) selecting and enabling the one or more source sensors to provide animal data to one or more computing devices (e.g., which can include the collecting computing device); (ii) selecting and deactivating the one or more source sensors (e.g., stopping the one or more source sensors from providing animal data to one or more computing devices); (iii) creating, modifying, setting, or a combination thereof, one or more sensor parameters for each of the one or more source sensors which change one or more actions taken by the one or more source sensors or one or more computing devices in communication with the one or more source sensors; or (iv) a combination thereof.

In at least another aspect, a system for intelligently selecting sensors and their associated operating parameters is provided. The system includes one or more source sensors that gather animal data from at least one targeted individual and a collecting computing device in electrical communication with the one or more source sensors. The collecting computing device is configured to utilize one or more artificial intelligence-based techniques to (i) intelligently gather animal data from the one or more source sensors either directly (e.g., directly from to the one or more source sensors) or indirectly (e.g., (e.g., via another one or more sensors; via another one or more computing devices in communication with the one or more source sensors); (ii) create, modify, and/or access one or more sensor commands that provide one or more instructions to the one or more source sensors, one or more computing devices in communication with the one or more source sensors (e.g., directly or indirectly), or a combination thereof, to perform one or more actions; and (iii) intelligently transmit the one or more commands either directly or indirectly to the one or more source sensors, the one or more computing devices in communication with the one or more source sensors, or a combination thereof. At least one variable is created, gathered, and/or observed (e.g., identified) by the collecting computing device. The creation, gathering, and/or observation of the at least one variable initiates the collecting computing device or other computing device in communication with the collecting computing device to evaluate (e.g., dynamically) the at least one variable using one or more artificial intelligence-based techniques via at least one evaluation indicator. The at least one evaluation indicator provides information (e.g., via its one or more outputs) to the collecting computing device or other computing device in communication with the collecting computing device that automatically initiates the collecting computing device to create, modify, and/or access (e.g., dynamically) one or more commands that provide one or more instructions to the one or more source sensors (e.g., to take one or more actions), the one or more computing devices, or a combination thereof, and transmit the one or more commands to the one or more source sensors, the one or more computing devices, or a combination thereof, the one or more commands including at least one of: (1) selecting and enabling (e.g., activating) the one or more source sensors to provide animal data to one or more computing devices; (2) selecting and enabling a computing device gathering animal data from the one or more source sensors to provide animal data to one or more computing devices; (3) selecting and stopping (e.g., deactivating) the one or more source sensors from providing animal data to one or more computing devices; (4) selecting and stopping a computing device gathering animal data from the one or more source sensors from providing animal data to one or more computing devices; (5) creating, modifying, setting, or a combination thereof, one or more sensor operating parameters for each, a subset, or all of the one or more source sensors which change one or more actions taken by the one or more source sensors or one or more computing devices in communication with the one or more source sensors; (6) creating, modifying, setting, or a combination thereof, one or more operating parameters for each, a subset, or all of the one or more computing devices in communication with the one or more source sensors which change one or more actions taken by the one or more computing devices, the one or more source sensors, one or more computing devices in communication with the one or more source sensors, or a combination thereof; or (7) a combination thereof.

In another aspect, a system for intelligently selecting sensors and their associated operating parameters is provided. The system includes one or more source sensors that gather animal data from one or more targeted individuals. The system also includes a collecting computing device (i) in direct electrical communication with the one or more source sensors, (ii) in indirect electrical communication with the one or more source sensors via one or more other computing devices that are in electrical communication with the collecting computing device and configured to access at least a portion of the animal data derived from the one or more source sensors, or (iii) a combination thereof. At least one variable is created, gathered, identified, or observed by the collecting computing device or the one or more other computing devices based upon one or more digital sources of media, the at least one variable being derived from, at least in part, (1) one or more identifications of the one or more targeted individuals or one or more characteristics related to the one or more targeted individuals via one or more digital sources of media; (2) one or more actions [taken by one or more users and] (e.g., via one or more users; taken by one or more users) associated with the one or more targeted individuals, one or more characteristics related to the one or more targeted individuals, or a combination thereof; (3) one or more observations of (or related to) the one or more actions [taken by the one or more users and] (e.g., via the one or more users; taken by the one or more users) associated with the one or more targeted individuals and the one or more characteristics related to the one or more targeted individuals or a combination thereof. The one or more identifications, actions, observations, or a combination thereof induce the system to: create, modify, or access, and transmit one or more commands to (i) one or more source sensors associated with the one or more targeted individuals, (ii) the one or more other computing devices in direct or indirect communication with the one or more source sensors associated with the one or more targeted individuals, or (iii) a combination thereof, and provide animal data derived from the one or more source sensors and associated with the one or more targeted individuals to the collecting computing device (e.g., based upon the at least one variable). The system configured to intelligently identify, gather, select, create (e.g., combine), modify, or a combination thereof, one or more digital sources of media based upon (i) the one or more identifications, actions, observations, or a combination thereof; (ii) the one or more commands transmitted to the one or more source sensors, the one or more computing devices in direct or indirect communication with the one or more source sensors (e.g., that are configured to access animal data derived from the one or more source sensors), or a combination thereof; (iii) the provision of animal data derived from the one or more source sensors and associated with the one or more targeted individuals to the collecting computing device, or (iv) a combination thereof, and provide the one or more digital sources of media to the collecting computing device.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

For a further understanding of the nature, objects, and advantages of the present disclosure, reference should be made to the following detailed description, read in conjunction with the following drawings, wherein like reference numerals denote like elements and wherein:

FIG. 1 provides a schematic illustration of a system for intelligently selecting sensors and their associated operating parameters.

### DETAILED DESCRIPTION

Reference will now be made in detail to presently preferred embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

It is also to be understood that this invention is not limited to the specific embodiments and methods described herein, as specific components, parameters, and/or conditions may, of course, vary. Furthermore, the terminology used herein is used only for the purpose of describing particular embodiments of the present invention and is not intended to be limiting in any way.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise. Additionally, the sequential series (e.g., order) in which the one or more steps, methods, or processes occur in the one or more embodiments can be modified depending on the one or more configurations of the system while producing the same or similar output or end result, unless expressly stated otherwise.

It must also be noted that, as used in the specification and the appended claims, the singular form “a,” “an,” and “the” comprise plural referents unless the context clearly indicates otherwise. For example, reference to a component in the singular is intended to comprise a plurality of components.

The phrase “data is” is meant to include both “datum is” and “data are,” as well as all other possible meanings, and is not intended to be limiting in any way.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

With respect to the terms “comprising.” “consisting of,” and “consisting essentially of,” where one of these three terms is used herein, the presently disclosed and claimed subject matter can include the use of either of the other two terms.

With respect to the terms “bet” and “wager,” both terms mean an act of taking a risk (e.g., which can be monetary or non-monetary in nature) on the outcome of a current or future event. Risk includes both financial (e.g., monetary) and non-financial risk (e.g., health risk). A risk can be evaluated against another one or more parties (e.g., an insurance company deciding whether to provide insurance; a healthcare system deciding whether to administer one drug versus another drug or quantity of drug, or one treatment plan versus another treatment plan, to an individual in a healthcare setting; an individual deciding whether to place a sports wager with another individual or with another entity; an individual deciding whether to sell their animal data to another party on the basis that the value of the animal data could increase or decrease in the future; and the like) or against oneself (e.g., an individual deciding whether to obtain insurance for themselves), on the basis of an outcome, or the likelihood of an outcome, of a future event. Examples include gambling (e.g., sports betting), insurance, security, healthcare, wellness, animal data monetization, and the like. Where one of these two terms are used herein, the presently disclosed and claimed subject matter can use either of the other two terms interchangeably.

It should also be appreciated that integer ranges explicitly include all intervening integers. For example, the integer range 1-10 explicitly includes 1, 2, 3, 4, 5, 6, 7, 8, 9, and 10. Similarly, the range 1 to 100 includes 1, 2, 3, 4 . . . 97, 98, 99, 100. Similarly, when any range is called for, intervening numbers that are increments of the difference between the upper limit and the lower limit divided by 10 can be taken as alternative upper or lower limits. For example, if the range is 1.1. to 2.1 the following numbers 1.2, 1.3, 1.4, 1.5, 1.6, 1.7, 1.8, 1.9, and 2.0 can be selected as lower or upper limits.

In a refinement, when referring to a numerical quantity, the term “less than” includes a lower non-included limit that is 5 percent of the number indicated after “less than.” A lower non-includes limit means that the numerical quantity being described is greater than the value indicated as a lower non-included limited. For example, “less than 20” includes a lower non-included limit of 1 in a refinement. Therefore, this refinement of “less than 20” includes a range between 1 and 20. In another refinement, the term “less than” includes a lower non-included limit that is, in increasing order of preference, 20 percent, 10 percent, 5 percent, 1 percent, or 0 percent of the number indicated after “less than.”

With respect to electrical devices, the term “connected to” means that the electrical components referred to as connected to are in electrical communication. In a refinement, “connected to” means that the electrical components referred to as connected to are directly wired to each other. In another refinement, “connected to” means that the electrical components communicate wirelessly or by a combination of wired and wirelessly connected components. In another refinement, “connected to” means that one or more additional electrical components are interposed between the electrical components referred to as connected to with an electrical signal from an originating component being processed (e.g., filtered, amplified, modulated, rectified, attenuated, summed, subtracted, etc.) before being received to the component connected thereto.

The term “one or more” means “at least one” and the term “at least one” means “one or more.” The terms “one or more” and “at least one” include “plurality” and “multiple” as a subset. In a refinement, “one or more” includes “two or more.” In another refinement, “at least one of” means any combination of the components indicated, including a combination of all the components indicated.

The terms “configured to” or “operable to” mean that the processing circuitry (e.g., a computer or computing device) is configured or adapted to perform one or more of the actions set forth herein, by software configuration and/or hardware configuration. The terms “configured to” and “operable to” can be used interchangeably.

When a computing device is described as performing an action or method step, it is understood that the computing device is operable to and/or configured to perform the action or method step typically by executing one or more lines of source code. The one or more action or method steps can be encoded onto non-transitory memory (e.g., hard drives, optical drive, flash drives, and the like).

It should be appreciated that when a device, and in particular, a computing device is described as performing a list of actions or configured to perform a list of actions, the device can perform any one of the actions or any combination of the actions. Similarly, when an item is described by a list of item choices (e.g., whereby each, a subset, or all of the one or more choices can be selected), the item can be any one of the item choices or any combination of the item choices.

The term “derivative” wherein referring to data means that the data is mathematically transformed to produce the derivative as an output. In a refinement, a mathematic function receives the data as input and outputs the derivative as an output.

The term “or its one or more derivatives” can be interchangeable with “and its one or more derivatives” depending on the use case and is not intended to be limiting in any way.

The term “substantially,” “generally,” or “about” may be used herein to describe disclosed or claimed embodiments. The term “substantially” may modify a value or relative characteristic disclosed or claimed in the present disclosure. In such instances, “substantially” may signify that the value or relative characteristic it modifies is within +0%, 0.1%, 0.5%, 1%, 2%, 3%, 4%, 5% or 10% of the value or relative characteristic.

Throughout this application, where publications are referenced, the disclosures of these publications in their entireties are hereby incorporated by reference into this application to more fully describe the state of the art to which this invention pertains.

The term “server” refers to any computer or computing device (including, but not limited to, desktop computer, notebook computer, laptop computer, mainframe, mobile phone, smart phone, smart watch, smart contact lens, head-mountable unit such as smart-glasses, headsets such as augmented reality headsets, virtual reality headsets, mixed reality headsets, and the like, hearables, augmented reality devices, virtual reality devices, mixed reality devices, unmanned aerial vehicles, and the like), distributed system, blade, gateway, switch, processing device, or a combination thereof adapted to perform the methods and functions set forth herein.

The term “computing device” refers generally to any device that can perform at least one function, including communicating with another computing device. In a refinement, a computing device includes a central processing unit that can execute program steps and memory for storing data and a program code.

When a computing device is described as performing an action or method step, it is understood that the one or more computing devices are operable to perform the action or method step typically by executing one or more lines of source code. The actions or method steps can be encoded onto non-transitory memory (e.g., hard drives, optical drives, flash drives, and the like).

The term “electronic communication” or “electrical communication” means that an electrical signal is either directly or indirectly sent from an originating electronic device to a receiving electronic device. Indirect electronic communication can involve the processing of the electrical signal, including but not limited to filtering of the signal, amplification of the signal, rectification of the signal, modulation of the signal, attenuation of the signal, adding of the signal with another signal, subtracting the signal from another signal, subtracting another signal from the signal, and the like. Electronic communication can be accomplished with wired components, wirelessly-connected components, or a combination thereof.

The processes, methods, functions, actions, or algorithms disclosed herein can be deliverable to or implemented by a computer, controller, or other computing device, which can include any existing programmable electronic control unit or dedicated electronic control unit. Similarly, the processes, methods, functions, actions, or algorithms can be stored as data and instructions executable by a computer, controller, or other computing device in many forms including, but not limited to, information permanently stored on non-writable storage media such as ROM devices and information alterably stored on writable storage media such as floppy disks, magnetic tapes, CDs, RAM devices, other magnetic and optical media, shared or dedicated cloud computing resources, and the like. The processes, methods, functions, actions, or algorithms can also be implemented in an executable software object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software, and firmware components.

The terms “subject” and “individual” are synonymous, interchangeable, and refer to a human or other animal, including birds, reptiles, amphibians, and fish, as well as all mammals including, but not limited to, primates (particularly higher primates), horses, sheep, dogs, rodents, pigs, cats, rabbits, bulls, cows, and the like. The one or more subjects or individuals can be, for example, humans participating in athletic training or competition, horses racing on a race track, humans playing a video game, humans monitoring their personal health or having their personal health monitored, humans providing their animal data to a third party (e.g., insurance system, health system, animal data-based monetization system), humans participating in a research or clinical study, cows or other animals grazing, humans participating in a fitness class, and the like. A subject or individual can also be a derivative of a human or other animal (e.g., lab-generated organism derived at least in part from a human or other animal), one or more individual components, elements, or processes of a human or other animal (e.g., cells, proteins, biological fluids, amino acid sequences, tissues, hairs, limbs) that make up the human or other animal, one or more digital representations that share at least one characteristic with a human or other animal (e.g., data set representing a human that shares at least one characteristic with a human representation in digital form—such as sex, age, biological function as examples—but is not generated from any human that exists in the physical world; a simulated individual or digital individual that is based on, at least in part, a real-world human or other animal, such as a digital representation of an individual or avatar in a virtual environment or simulation such as a video game or metaverse, or a representation of an individual featured in synthetic media), or one or more artificial creations that share one or more characteristics with a human or other animal (e.g., lab-grown human brain cells that produce an electrical signal similar to that of human brain cells). In a refinement, the subject or individual can be one or more programmable computing devices such as a machine (e.g., robot, autonomous vehicle, mechanical arm) or network of machines that share at least one biological-based function with a human or other animal and from which one or more types of biological data can be derived, which can be, at least in part, artificial in nature (e.g., data from Artificial Intelligence-derived activity that mimics biological brain activity; biomechanical movement data derived a programmable machine that mimics, at least in part, biomechanical movement of an animal).

The term “animal data” refers to any data obtainable from, or generated directly or indirectly by, a subject that can be transformed into a form that can be transmitted to a server or other computing device. Typically, the animal data is transmitted electronically via a wired or wireless connection, or a combination thereof. Animal data includes, but is not limited to, any subject-derived data, including any signals, readings (e.g., metrics), and/or other information that can be obtained from one or more sensors (e.g., which can include sensing equipment and/or other sensing systems), and in particular, biological sensors (i.e., biosensors) that capture biological data, as well as its one or more derivatives. Animal data also includes any biological phenomena capable of being captured from a subject and converted to electrical signals that can be captured by one or more sensors. Animal data also includes descriptive data related to a subject (e.g., name, age, height, gender, anatomical information, other characteristics related to the subject), auditory data related to a subject (e.g., including audio information related to one or more biological signals or readings, voice data, and the like), visually-captured data related to a subject (e.g., image, likeness, video featuring the subject, observable information related to the subject), neurologically-generated data (e.g., brain signals from neurons), evaluative data related to a subject (e.g., skills of a subject), data that can be manually entered/inputted or gathered related to a subject (e.g., medical history, social habits, feelings of a subject, mental health data, financial information, social media activity, virtual activity, subjective data, and the like), and the like (e.g., other attributes/characteristics of the individual). The term “animal data” can be meant to include one or more types of animal data. It can include animal data in both its raw and/or processed form. In a refinement, the term “animal data” is inclusive of any derivative of animal data, including one or more computed assets, insights, evaluation indicators (e.g., if derived from at least a portion of animal data or its one or more derivatives), or predictive indicators, artificial data (e.g., simulated animal data in or derived from a virtual environment, video game, or other simulation derived from a digital representation of the subject), or a combination thereof. In another refinement, animal data includes one or more attributes or characteristics related to the subject or the animal data. In another refinement, animal data includes one or more inputs (e.g., signals, readings, other data) from one or more non-animal data sources (e.g., as metadata). In another refinement, animal data includes any metadata gathered or associated with the animal data. In another refinement, animal data includes at least a portion of non-animal data that provides contextual information related to the animal data. In another refinement, animal data includes the one or more digital sources of media associated with the animal data. In another refinement, animal data includes at least a portion of simulated data. In yet another refinement, animal data is inclusive of simulated data.

The term “reference data” refers to data or other information used as a reference or baseline to classify, categorize, compare, evaluate, analyze, and/or value other data, as well as to derive information from other data. The term “reference data” is inclusive of the term “reference animal data,” which is animal data used as a reference or baseline (e.g., a base for measurement) to classify, categorize, compare, evaluate, analyze, and/or value other animal data, as well as to derive information from other data. Reference data can include any available, accessible, or gathered data, including any type of animal data and/or non-animal data and associated metadata, either directly or indirectly related to (or derived from) the one or more targeted subjects (e.g., including associated medical conditions, biological responses, and the like) use cases (e.g., including associated data collection plans, schedules, data requirements such as requirements to fulfill one or more data collection, analysis or distribution requirements, obligations, targets, and the like implemented by the system using one or more sensors and with one or more specified operating parameters), or events associated with the one or more targeted subjects that enables one or more forecasts, predictions, probabilities, assessments, comparisons, evaluations, possibilities, projections, determinations, or recommendations related to one or more outcomes, or execution (e.g., fulfillment) of one or more requirements or targets for one or more use cases, for one or more current or future events or sub-events to be calculated, computed, derived, extracted, extrapolated, quantified, simulated, created, modified, assigned, enhanced, estimated, inferred, evaluated, established, determined, converted, deduced, observed, communicated, or actioned upon. Reference data can be gathered from any number of subjects (e.g., one, tens, hundreds, thousands, millions, billions, and the like) and data sources (e.g., data that can be gathered from sensors or computing devices, manually inputted, artificially created, derived from one or more actions, and the like). It can be structured (e.g., created, curated, transformed, modified) in a way to facilitate one or more evaluations (e.g., comparisons) of (or between) data sets derivatives of data sets, and/or other information (e.g., via one or more evaluation indicators). Reference data can also be categorized and associated with one or more profiles (e.g., type of individual, characteristics associated with one or more individuals, type of biological response, type of sensor(s), type of operating parameters associated with each or subset—with “subset” including all sensors in some variations—of the one or more sensors, the type of data generated from each or subset of the one or more sensors with the associated one or more operating parameters in light of the associated contextual data, type of target use case/requirements, type of target monetary value, and the like) and tagged in order to make the datasets searchable and accessible. In this regard, the system can utilize reference data to create or modify (e.g., including update) one or more digital records (e.g., which can include the system creating or customizing one or more profiles based upon the one or more requirements or targets) which can include categorized and searchable reference data information related to one or more individuals (e.g., including one or more characteristics related to the individual), reference data information related to the one or more computing devices collecting data from the one or more sensors or other computing devices (e.g., type of computing device, specifications related to the computing device, actions taken by the computing device, and the like), reference data information related to the type of data generated from each or subset of the one or more sensors and their associated one or more operating parameters, reference data information related to one or more characteristics of the data generated (e.g., quality, volume, and the like), reference data information related to the associated contextual data (e.g., activity the data was collection in, conditions, reference data information related to the subject, monetary or non-monetary value(s) if applicable, and the like), reference data information related to the state of the system (e.g., what processing occurred during data collection, analysis, or distribution; how much is free storage space or empty space did the system have during data collection; what actions was the system taking any given time during data collection; what RAM or processor does the system have; what type of computing device(s) is the system comprised of; and the like), reference data information related to other hardware, software, and/or firmware information gathered by the system and related to the data collected from the one or more sensors or other computing devices (e.g., including any algorithms used to transform or action upon the data), reference data information related to one or more use cases, and the like. Reference data can also include any previously collected animal data and non-animal data (e.g., historical animal data, baseline animal data for one or more individuals or group of individuals, other baseline data), including derivatives of animal data and its associated contextual data, which can include other animal data, non-animal data, or a combination thereof, previously collected animal data derived from one or more sensors, and non-sensor based animal data. In another refinement, reference data includes at least a portion of non-animal data (e.g., including non-animal contextual data to provide more context to the animal data). In another refinement, reference data includes at least a portion of simulated data. In another refinement, reference data includes metadata gathered or associated with the animal data, the subject, the one or more sensors, one or more computing devices associated with the one or more sensors, one or more computing devices associated with system, the one or more use cases, or a combination thereof. The metadata associated with the animal data, subject, the one or more sensors, one or more computing devices associated with the one or more sensors, one or more computing devices associated with system, the one or more use cases, or combination thereof can include sensor type, sensor configurations (e.g., sensor operating parameters including sampling rate, units of measure, recorded frequency such as how often data is stored per second, storage rate, and the like), ancillary information related to data collection (e.g., for an infusion pump, information like flow rate, delivery rate, starting rate, starting volume, drug calculations, alerts, and the like; note that the types of information can vary based on the type of sensor being used such as anesthesia systems, blood pressure-based systems, capnometer systems, EEG monitors, PTM monitors, polysomnography monitors, EMG Monitors, fetal monitors, Holter monitors, infusion pumps, IOM systems, irrigation pumps, multi-metric patient monitors, vital sign monitors, pulse oximetry systems, spirometer systems, respiration flow systems, stress test systems, thermometers, tourniquet systems, vascular therapy systems, ventilator systems, and the like; note that this is not an exhaustive list of systems and monitors, and the invention can be applied to any system or monitor that utilizes one or more sensors), data type (e.g., including raw or processed data; high sampling vs low sampling data; type of data; requisite data type based on use case), placement of sensor, body composition of the subject (e.g., including impediments or other characteristics that can impact data collection or one or more characteristics of data, such as quality), bodily condition of the subject, one or more medical conditions of or related to the subject (e.g., including one or more medical conditions of other individuals that share one or more characteristics with the subject), outcome-related data (e.g., outcome of the treatment; life outcome) health information of or related to the subject (e.g., including health deterioration or health improvement data, particularly over time), biological response data (e.g., activity the subject is engaged in while collecting the animal data; bodily response or biological phenomenon capable of being converted to electrical signals that can be captured by one or more sensors including a biological state; a medical event), environmental conditions (e.g. if the data was collected in a dangerous condition, rare or desired condition; the environment in which the data was collected in; and the like), quality of data (e.g., a rating or other indices applied to the data, completeness of a data set, noise levels within a data set, whether data is missing), size of the data set (e.g., size or volume of the required data set; size of the data set as to not exceed certain storage thresholds), rules or restrictions related to the data (e.g., any permissions or restrictions related of the data based upon one or more pre-existing agreements or preferences established by the data owner or administrator), one or more values associated with the data (e.g., monetary values; non-monetary values; range of values), one or more use cases associated with the data, one or more characteristics of the data, characteristics of the one or more computing devices (e.g., specifications) collecting the data, the type of software or firmware associated with the collecting computing device or other computing device in communication with the collecting computing device collecting the data, state of the system that gathers the animal data, characteristics related to the transmission subsystem used to collect the data, and the like. Characteristically, the system can be configured to modify (e.g., update, enhance) reference data (e.g., including the one or more digital records, tags, and the like) and information associated with reference data as new information is gathered by the system. In another refinement, reference data can include previously collected animal data for a targeted individual. In another refinement, reference data can include data that is not derived directly or indirectly from the targeted individual or the one or more sensors but shares at least one attribute (e.g., characteristic) with the one or more targeted individuals, their biological responses (e.g., the activity the subject is undertaking, bodily response or biological phenomenon capable of being converted to electrical signals that can be captured by one or more sensors including a biological state; a medical event such as a heart attack or stroke), their one or more medical conditions or potential medical conditions based upon one or more shared characteristics with one or more other individuals, or the one or more sensors. In another refinement, reference data can include identifiable, de-identified (e.g., pseudonymized), semi-anonymous, or anonymous data tagged with metadata. In another refinement, reference data includes data derived from the one or more biological responses derived from anonymized, semi-anonymized, or de-identified (e.g., pseudonymized) sources. In another refinement, reference data can be categorized or grouped together, to form one or more units of such data (e.g., including one or more digital assets that can be distributed for consideration). In another refinement, reference data can be dynamically created, modified, or enhanced with one or more additions, changes, or removal of non-functioning data (e.g., data that the system will remove or stop using). In another refinement, at least a portion of the reference data can be weighted based upon one or more characteristics of (or related to) the one or more sensors (e.g., reference animal data from sensors that produce average quality data may have a lower weighted score than reference animal data from sensors that produce high quality data), the one or more individuals or groups of individuals, the contextual data associated with the animal data (e.g., other animal data, non-animal data), the use case (e.g., the value of the use case based upon the potential monetary return), or a combination thereof. In another refinement, the system can be operable to conduct one or more data audits on reference data. For example, the system may recall reference data originating from one or more sensors based upon one or more sensor characteristics (e.g., a faulty data gathering functionality within the one or more sensors could cause the system to recall and remove the data from the reference animal data database), or may change one or more tags or characteristics of reference data based upon new information (e.g., a new disease identified based upon people with certain characteristics can modify the characteristics—type, volume, duration, etc.—of data the system collects, including the sensors used and the operating parameters created or modified). In another refinement, reference data include variable information related to animal data (e.g., the administration of one or more substances in areas such as infusion therapy that can impact animal data readings; administration of stimuli or other stimulation that can impact animal data readings).

In a refinement, reference data includes contextual data associated with the animal data, the contextual data including one or more associated monetary values (e.g., pricing value(s) or other information) and/or non-monetary values (e.g., the equivalent value of the animal data in the context of one or more goods, services, and the like) of the collected data based upon the metadata associated with the animal data (e.g., the type of sensor used to collect the animal data, sensor settings, type of algorithms used, and the like). In this example, the system is configured to learn what sensors, sensor parameters, animal data characteristics, and subject characteristics are associated with any given price point or value for the data, enabling the system to recommend one or more sensor parameters based upon the creation or modification of one or more monetary targets or thresholds.

Reference data can also include, or be utilized—at least in part—to create or modify, one or more evaluation indicators, including one or more: digital signatures (e.g., unique biological-based digital signatures, non-unique biological-based digital signatures), identifiers (e.g., non-unique identifiers, unique identifiers), identifications, patterns (e.g., any type of pattern including time slice, spatial, spatiotemporal, temporospatial, and the like), rhythms, trends, scores, features, thresholds, graphs, charts, plots, visual representations, measurements, outliers, abnormalities, anomalies, readings, signals, data sets, characteristics/attributes (e.g., including unique characteristics), commands, actions, instructions, recommendations, predictions, probabilities, possibilities, forecasts, assessments, summaries, other communication medium readable or interpretable by an animal or computing device, or a combination thereof, which may or may not be biological-based in nature, derived from one or more calculations, computations, derivations, extractions, extrapolations, simulations, creations, combinations, modifications, enhancements, estimations, evaluations, comparisons, inferences, establishments, determinations, conversions, deductions, requests, targets, requirements, interpretations, or observations from animal data, at least in part, that enable the creation, modification, and/or transmission of one or more commands to one or more sensors either directly or indirectly (e.g., via computing devices in communication with the one or more sensors), as well as the identification of one or more characteristics or other information related to the individual, their associated animal data (e.g., identification that the individual is, in fact, having a medical episode; characteristics related to the quality, completeness, uniqueness, relatedness, usability, and/or value of the animal data), one or more sensors, one or more computing devices (e.g., including associated software/firmware/hardware), one or more use cases, or a combination thereof. In a variation, such signatures, identifiers, identifications thresholds, patterns, rhythms, trends, scores, features, graphs, charts, plots, visual representations, measurements, outliers, abnormalities, anomalies, readings, signals, data sets, characteristics/attributes, commands, actions, instructions, recommendations, predictions, probabilities, possibilities, forecasts, assessments, summaries, other communication medium readable or interpretable by an animal or computing device, or a combination thereof, enables identification of an individual based upon their animal data, enables identification of one or more characteristics associated with the individual, enables identification of one or more medical conditions (e.g., including potential medical conditions, future medical conditions related medical conditions, and the like), enables identification of one or more biological responses, enables identification of one or more characteristics related to creating, modifying, or enhancing one or more monetary values for the animal data, enables the creation, modification, or enhancement of one or more monetary values for the animal data, enables the identification of the one or more requirements, obligations, or targets as established by the system related to the collection of animal data, enables the identification of one or more use cases-including the one or more requirements or obligations as established by the system related to the collection of animal data for the one or more use cases, enables fulfillment of one or more requirements, obligations, or targets as established by the system (e.g., based upon the information provided, gathered, observed, or created/derived by the system) related to the collection of animal data (e.g., based upon the sensor systems being utilized, the type of animal data being collected, the medical condition being monitored, and the like; based upon one or codes that require specific types of animal data to be gathered with specified operating parameters in specified conditions), or the like. In other variations, such signatures, identifiers, patterns, rhythms, trends, features, measurements, outliers, anomalies, characteristics, and the like may include at least a portion of non-animal data, artificial data, contextual data (e.g., which can include a combination of animal and non-animal data), or a combination thereof. In another refinement, reference data can include one or more variables (e.g., information related to the at least one variable) that enable identification, creation, modification, or a combination thereof, of other reference data. In another refinement, derivatives of reference data (e.g., which can also be categorized as reference data) can be created or modified based on one or more variables (e.g., the evaluation of one or more variables, from which information is derived), which may be inputted by a user or created (e.g., derived), gathered, provided, or observed by one or more computing devices. The one or more variables can include, but are not limited to, time (e.g., over a duration of time, when the information is required, duration of the data collection period), animal data (e.g., one or more animal data readings), reference data, contextual data, one or more sensor readings (e.g., achievement of a threshold or milestone within the data collection period), data storage thresholds (e.g., for the one or more systems in communication with the one or more sensors), monetary considerations (e.g., data storage costs, cost thresholds or allotted storage based on cost; the amount a third party has paid to access the data, which may induce the system to provide one or more commands to one or more sensors; monetary performance; one or more monetary targets established by the one or more individuals or other users; pricing or monetary target for the animal data), one or more preferences (e.g., terms, conditions, permissions, restrictions, rights, requirements, requests, and the like established by the data provider, data acquirer, or a combination thereof, and associated with the animal data; consent from the data provider, owner, licensee, licensor, administrator, or other controller of data), latency information (e.g., latency requirements, speed at which data is provided), sensor signal strength, use case (e.g., the animal data being used as an input to create a real-time or near real-time prediction; the data being used to create a new sports wager; requirements or obligations derived from the one or more use cases; targets; and the like), one or more inputs (e.g., requirements or obligations inputted that the system is required to fulfill based upon one or more inputs, such as an input to create a real-time wager or prediction, or an input to collect data to fulfill one or more codes such as a CPT code), one or more actions, one or more targets (e.g., monetary targets, data targets such as achievement of a threshold or goal), one or more requirements (e.g., requirements for data collection), power availability (e.g., battery life of the sensor), requests by one or more users (e.g., medical professional, insurance company, fitness provider, sports betting operator), sensor type, data type (e.g., raw vs processed data), placement of sensor, body composition of the subject, bodily condition of the subject, one or more medical conditions of the subject, health information of or related to the subject, activity (e.g., activity in which the animal data is collected), environmental conditions (e.g. if the data was collected in a dangerous condition, rare or desired condition, and the like), one or more previous sensor readings, quality of data (e.g., a rating or other indices applied to the data, completeness of a data set, noise levels within a data set, whether data is missing), size of the data set (e.g., size of the required data set; size of the data set as to not exceed certain storage thresholds), rules or restrictions related to the data (e.g., any permissions or restrictions related of the data based upon one or more pre-existing agreements or preferences established by the data owner or administrator), one or more other characteristics of the data, information related to the one or more sensor readings or its derivatives derived from one or more other sensors or one or more computing devices, information related to the animal data that is being monitored, measured, or gathered by the system (e.g., via the one or more source sensors, one or more computing devices, or a combination thereof), or a combination thereof, and the like. In another refinement, reference data includes any data that enables the one or more evaluations, verifications, or validations to occur with the animal data (e.g., evaluation, verification, or validation of the data or targeted individual; identification of a medical condition or biological response such as a stroke or heart attack based upon the data identification of a future heart attack or future stoke based upon the animal data and the reference data, and the like) and/or any sensors or computing devices associated with the animal data. In another refinement, reference data includes one or more evaluation indicators that become reference evaluation indicators once created or modified by the system (e.g., the system can be configured to automatically convert evaluation indicators into reference evaluation indicators). In another refinement, reference data include one or more reference evaluation indicators (e.g., historical evaluation indicators). In another refinement, reference data includes previously collected animal data that are typically actioned upon (e.g., analyzed, transformed) and characterized. In another refinement, reference data is accessed by the system via one or more digital records directly or indirectly associated with one or more individuals, animal data, metadata, one or more sensors (e.g., including the one or more sensor operating parameters), one or more computing devices, one or more biological responses, one or more medical conditions, one or more use cases, one or more monetary values, one or more non-monetary values, one or more transmission subsystems, or a combination thereof. In another refinement, reference data can also include one or more values (e.g., monetary values, non-monetary values, historical pricing information, predicted or projected pricing information, and the like) and other information related to the value of any given reference animal data set (or combinations of sets), collected animal data sets, or future animal data sets derived from, at least in part, one or more sensors and their corresponding one or more operating parameters. In another refinement, reference data includes reference valuation data (e.g., pricing data) from one or more sources (e.g., historical values of data sales of any given data set or related data sets or similar assets or asset classes derived from the system; third party sources that have valued similar data, similar attributes related to data, similar assets or similar asset classes; dissimilar data, dissimilar attributes, dissimilar assets, or dissimilar asset classes from which one or more monetary values can be inferred or extracted; and the like). The reference valuation data can be included in one or more models created and/or utilized by the system that establish one or more monetary values for one or more data sets. In another refinement, reference data is utilized by the system, at least in part, in its one or more calculations, computations, derivations, extractions, extrapolations, simulations, creations, modifications, enhancements, estimations, evaluations, inferences, establishments, determinations, combinations, comparisons, conversions, deductions, or observations: (1) to create or modify one or more markets (e.g., bets, odds); (2) to accept one or more wagers; (3) to create, enhance, modify, acquire, offer, or distribute one or more products; (4) to evaluate, calculate, derive, modify, enhance, or communicate one or more predictions, probabilities, or possibilities; (5) to formulate one or more strategies; (6) to take one or more actions; (7) to identify, evaluate, assess, mitigate, prevent, or take one or more risks; (8) as one or more signals or readings utilized in one or more simulations, computations, or analyses; (9) as part of one or more simulations, an output of which directly or indirectly engages with one or more users; (10) to create or modify one or more outputs that recommend one or more actions; (11) as one or more core components or supplements to one or more mediums of consumption; (12) in one or more promotions; (13) evaluate, assess, or optimize animal data-based performance for one or more targeted individuals; or (14) a combination thereof.

In another refinement, reference data is stored, categorized, and accessed by the system with associated contextual data (e.g., metadata). In another refinement, reference data has associated contextual data which comprises, at least in part, the reference data. In another refinement, reference data includes at least a portion of simulated animal data (e.g., the system may generate artificial animal data as reference data; the system may run one or more simulations, the output of which can be reference data; one or more animal data sets may include simulated data; and the like). In another refinement, reference data includes the output of one or more simulations (e.g., predicted monetary information such as predicted predicting information based upon an existing or pre-defined animal data set). In another refinement, reference data can include one or more legal agreements and other language that can be used to generate one or more terms (and in some variations, one or more agreements that enables the exchange of the animal data for consideration). In another refinement, reference data includes one or more previously established terms (e.g., user preferences, rules, conditions, permissions, conditions, rights, and the like) associated with the animal data (e.g., one or more uses of the animal data) established by the data owner/provider, data acquirer, one or more previous agreements which establish one or more terms for the animal data (e.g., with one or more agreements and the one or more terms accessible via one or more digital records), or a combination thereof. In another refinement, some reference data (e.g., pricing data for animal data) can be modified based on one or more variables, which may be inputted by a user, collected by one or more computing devices based upon any given scenario, or adjusted via one or more Artificial Intelligence techniques. For example, the value of data may change over time (e.g., data be more or less today than in the future), or a user may want to know the value of reference data based upon the changing of the one or more variables. In another refinement, reference data includes other animal data (e.g., which can include one or more sets of animal data) with one or more comparison characteristics (e.g., contextual data such as assigned monetary values or associated monetary information; information associated with one or more medical conditions or biological responses; information associated with the fulfillment of one or more requirements; and the like) that enables the system to evaluate and characterize other animal data (e.g., assign one or more monetary values to other animal data based upon a comparison with reference data; identify a medical condition or biological response in other animal data based upon a comparison with reference data; confirm a requirement has been fulfilled in other data based upon a comparison with reference data; and the like). In another refinement, reference data can include monetary information (e.g., what data is worth based on the one or more sensor parameters set and in which environment, etc.).

In another refinement, reference data can include information related to one or more rules (e.g., variables such as guidelines, instructions, requirements, and the like) or targets (e.g., requisite data for a given target) for data collection, analysis, distribution (e.g., including monetization), or a combination thereof, from one or more sensors based upon the input or selection of one or more use cases (e.g., executing one or more studies; a request for data from a user or data acquirer or system—including another system—to create an insight, predictive indicator, computed asset, or a bet for a sports wager based upon sensor-based animal data, from which the system automatically takes one or more actions to collect the requisite data from one or more sensors with the requisite operating parameters; and the like) that enable the system to create or modify at least evaluation indicator which initiates the computing device to create, modify (e.g., with the term “modification” including “enhancing” in some variations), or access one or more commands that instruct the one or more sensors to take one or more actions, the one or more actions including at least one of: create, modify, set, or a combination thereof, one or more sensor parameters for one or more sensors (including a subset of sensors or all sensors) across one or more targeted individuals, enable or disable (e.g., stopping, pausing) the one or more sensors from providing (or to provide) animal data to one or more computing devices, or a combination thereof. In another refinement, reference data can include information related to one or more reimbursement codes (e.g., CPT codes) that provides the system with one or more rules derived from, at least in part, the at least one variable (e.g., the one or more codes) that instruct the system on the one or more actions required to be taken by the system, the one or more sensors, the one or more individuals, or a combination thereof, (e.g., how to collect data from at least one sensor, including the one or more sensor parameters associated with the one or more codes; what data to collect; quantity of data; quality of data; other characteristics of data and the like) in order to comply with the one or more reimbursement codes. For example, the system can be configured to ensure it meets the one or more requirements for gathered data, or configured to ensure the system fulfills the one or more obligations or achieves one or more targets related to data collection, transformation (e.g., with act of transforming data including at least one of: normalize, timestamp, aggregate, tag, store, manipulate, denoise, process, enhance, format, organize, visualize, simulate, anonymize, synthesize, summarize, replicate, productize, compare, price, or synchronize the data), distribution, or a combination thereof, to ensure the data collected meets the criteria for reimbursement, and the like. The information related to the one or more reimbursement codes can include information for each reimbursement code or subset of reimbursement codes (e.g., which can include all codes) that instructs the system of the one or more requisite source sensors and the one or more requisite sensor parameters for each of the one or more source sensors (or subset of sensors or all sensors) required to fulfill the one or more obligations (e.g., the actions the system—including the associated sensors—have to take in order to fulfill the one or more obligations) or adhere to the one or more requirements (e.g., data type/volume/quality, thresholds, limits, flow rates, resolution, administration rates, and the like) of the one or more codes (e.g., user input or input from the system or another system regarding the requisite sensor parameters, from which the system learns the requisite sensor parameters for each of the one or more sensors; the system learning about the requisite sensors and their associated parameters in association with one or more codes from one or more previously collected data sets—including metadata that can include their associated sensor parameters—their associated code(s), and information regarding whether or not the collected data—such as the animal data and metadata—and their associated sensor parameters fulfilled the requirements of the code; and the like). In this example, a user can input (e.g., manually input, select) one or more codes (e.g., one or more variables) and the system can automatically create the one or more commands to configure the one or more sensors (e.g., including setting the one or more parameters related to each of the one or more sensors; enabling or disabling sensors from providing animal data; and the like) to fulfill reimbursement criteria (e.g., which can be included as part of the one or more rules) of the one or more codes. In this example, the one or more codes can automatically initiate the system to create or modify an evaluation indicator based upon the one or more codes, which further initiates the system to create, modify, or access one or more commands to configure the one or more sensors. In a variation, the system can automatically identify which one or more reimbursement codes can be fulfilled based upon the one or more sensors being utilized (e.g., including which sensors are operable) and their one or more configurable parameters. In another variation, the system can be configured to intelligently identify one or more codes automatically based upon the one or more sensors being utilized for any given data collection period. In another variation, the system can be configured to make one or more recommendations, determinations, predictions, or the like related to which one or more reimbursement codes are applicable based upon the operable and/or available sensors in communication with, or operable to be in communication with, the collecting computing device or one or more computing devices in communication with the collecting computing device. In another refinement, the reference data combines the one or more rules from the one or more reimbursement codes with reference animal data that fulfills the requirements of the one or more codes in order to monitor (e.g., which can be via one or more evaluation indicators) and, if required, make one or more modifications to the one or more sensor parameters from the one or more source sensors based upon the gathered animal data in order to ensure the gathered animal data is compliant with the one or more reimbursement codes (e.g., based upon previously complaint animal data). For example, if the system identifies that the animal data being collected from the one or more source sensors does not meet the requirements of the one or more reimbursement codes (e.g., via one or more evaluation indicators), the system can be configured to take one or more actions automatically (e.g., create one or more commands that changes one or more sensor parameters or provide one or more instructions to one or more other computing devices; turn on one or more sensors; and the like) in order to meet the requirements of the one or more codes.

The term “artificial data” refers to artificially-created data that is derived from, based on, or generated using, at least in part, animal data or one or more derivatives thereof, or other data associated with animal data (e.g., non-animal contextual data). It can be created by running one or more simulations utilizing one or more Artificial Intelligence (“AI”) techniques or statistical models, and can include one or more inputs (e.g., signals, readings, other data) from one or more non-animal data sources. In a refinement, artificial data includes any artificially-created data that shares at least one biological function with a human or another animal (e.g., artificially-created vision data, artificially-created movement data). The term “artificial data” is inclusive of “synthetic data,” which can be any production data applicable to a given situation that is not obtained by direct measurement. Synthetic data can be created by statistically modeling original data and then using the one or more models to generate new data values that reproduce at least one of the original data's statistical properties. In some variations, synthetic data includes associated synthetic media. In another refinement, the term “artificial data” is inclusive of any derivative of artificial data. In another refinement, artificial data is generated utilizing at least a portion of reference data. For the purposes of the presently disclosed and claimed subject matter, the terms “simulated data” and “synthetic data” are synonymous and used interchangeably with “artificial data” (and vice versa), and a reference to any one of the terms should not be interpreted as limiting but rather as encompassing all possible meanings of all the terms. In another refinement, the term “artificial data” is inclusive of the term “artificial animal data.”

In a refinement, artificial data can be derived (e.g., generated) from one or more simulated events, concepts, objects, or systems, and can be generated using one or more statistical models or Artificial Intelligence techniques. In another refinement, artificial data can be used to assess one or more biological-based occurrences of participants and/or the behavior of one or more sensors (e.g., including their one or more behaviors derived from their one or more operating parameters) in a simulation, with the simulation being operable to enable the modification of one or more variables in order to generate simulated data with desired conditions (e.g., generating a specific type of animal data when the individual is participating in a specific activity in specific environmental conditions with specific medical conditions associated with the individual; in some variations, the simulated data can include information related to the type of sensor(s) and associated sensor parameters associated with the simulated data). Advantageously, artificial data can be used to predict one or more outcomes (e.g., future biological outcomes for any given targeted individual; data outcomes based upon one or more sensor settings) or recommend one or more actions based upon one or more characteristics related to one or more individuals, the one or more sensors (e.g., including their one or more operating parameters), the animal data (e.g., including other metadata such as the activity in which the animal data was collected), contextual data, reference data, or a combination thereof. In this regard, the artificial data can be utilized as a baseline (e.g., for any given individual, medical condition, biological response, sensor, and the like) to compare current animal data readings or its derivatives and its associated metadata (e.g., which can include information related to the one or more sensors used to derive the animal data readings and their one or more sensor parameters) with predicted readings. In some variations, artificial data can also be used to predict sensor behavior and data derived from the one or more sensors based on one or more settings/parameters and contextual data (e.g., via one or more simulations). In other variations, the one or more simulations enable one or more modifications to the one or more sensors and their associated sensor parameters in the simulation (e.g., as a tunable parameter) to better understand the impact of the one or more modifications on animal data (e.g., via the simulated animal data) in light of the context. In a refinement, artificial data can be incorporated as part of the reference data to derive, modify, or enhance the evaluation indicator, and/or as part of the one or more data sets gathered from the one or more source sensors to derive, modify, or enhance the evaluation indicator. In another refinement, artificial data can be the at least one variable.

The term “insight” refers to one or more descriptions, characterizations, or indicators that can be assigned to a targeted individual, data associated with the targeted individual (e.g., including their animal data), information derived from the one or more sensors (e.g., including their one or more parameters/configurations/settings, and the like), information derived from one or more computing devices, or a combination thereof, that describes a condition or status of, or related to, the targeted individual, their associated data, the one or more sensors, the one or more computing devices, or a combination thereof. Examples can include descriptions or other characterizations related to an individual's stress levels (e.g., high stress, low stress), energy levels, fatigue levels, bodily responses, medical conditions, and the like, or related to a sensor(s) its associated setting(s) or status (e.g., low battery), or related to the animal data (e.g., a score related to the quality of the animal data), or related to a computing device's status (e.g., low storage, limited bandwidth), and the like. An insight can be quantified by one or more numbers (e.g., including a plurality of one or more numbers) in an animal and/or machine-readable or interpretable format, and/or and may be represented as a probability or similar odds-based indicator. An insight may also be quantified, communicated, or characterized by one or other metrics or indices of performance that are predetermined (e.g., codes, graphs, charts, plots, colors or other visual representations, plots, readings, numerical representations, descriptions, text, physical responses such as a vibration, auditory responses, visual responses, kinesthetic responses, or verbal descriptions). An insight can include one or more visual representations related to a condition or status of the of one or more targeted subjects (e.g., an avatar or digital depiction of a targeted subject visualizing future weight loss goals on the avatar or digital depiction of the targeted subject), the one or more sensors, or their associated computing devices. In a refinement, an insight is a score (e.g., personal score) or other indicator related to one or more targeted individuals or groups of targeted individuals that utilizes at least a portion of animal data to (1) evaluate, assess, prevent, or mitigate animal data-based risk, (2) evaluate, assess, or optimize animal data-based performance (e.g. biological performance, monetary performance, sensor performance, computing device performance, transmission performance, other hardware/software/firmware performance, and the like), or a combination thereof. The score or other indicator score can be utilized by the one or more targeted individuals from which the animal data or one or more derivatives thereof are derived from, the administrator operating the system, or one or more third parties (e.g., insurance organizations, financial lenders, goods/services providers, healthcare providers or professionals, sports performance coaches, medical billing organizations, fitness trainers, employers, virtual environment operators, synthetic media operators, sports betting companies, data monetization companies, and the like). In a variation, the personal score can be attributed to the one or more sets of animal data or its one or more derivatives (e.g., reputational score, data quality score, value score, and the like), and/or its metadata (e.g., the one or more sensors, their one or more associated operating parameters, the associated one or more computing devices, and the like). In another refinement, an insight is derived from one or more computed assets, predictive indicators, evaluation indicators, reference data, or a combination thereof. In another refinement, an insight is derived from two or more types of animal data. In another refinement, an insight is derived related to a targeted subject or group of targeted subjects using at least a portion of animal data not derived from the targeted subject or group of targeted subjects. In another refinement, an insight includes one or more inputs (e.g., signals, readings, other data) from one or more non-animal data sources in one or more computations, calculations, measurements, derivations, incorporations, simulations, extractions, extrapolations, modifications, enhancements, creations, combinations, estimations, deductions, inferences, conversions, determinations, processes, communications, and the like. In another refinement, an insight is comprised of a plurality of insights. In another refinement, an insight is assigned to a collection of animal data or multiple collections of animal data (e.g., collections that include at least a portion of the same animal data), one or more sensors, one or more sensor parameters, one or more computing devices, one or more individuals, or a combination thereof. In another refinement, an insight is assigned to multiple targeted individuals, sensors, sensor parameters, computing devices, or a combination thereof. In another refinement, an insight is assigned to one or more groups of targeted individuals, sensors, sensor parameters, computing devices, or a combination thereof. In another refinement, an insight is derived utilizing at least a portion of reference data.

The term “computed asset” refers to one or more numbers, a plurality of numbers, values, metrics, readings, insights, graphs, charts, or plots that are derived from at least a portion of the animal data or one or more derivatives thereof (e.g., which can be inclusive of simulated data). For example, in the context of sensor-derived animal data, the one or more sensors used herein initially provide an electronic signal. The computed asset is extracted or derived, at least in part, from the one or more electronic signals or one or more derivatives thereof. The computed asset can describe or quantify an interpretable property of (or related to) the one or more targeted individuals or groups of targeted individuals based upon the extracted or derived information. For example, a computed asset such as electrocardiogram readings can be derived from analog front end signals (e.g., the electronic signal from the sensor), heart rate data (e.g., heart rate beats per minute) can be derived from electrocardiogram or PPG sensors, body temperature data can be derived from temperature sensors, perspiration data can be derived or extracted from perspiration sensors, glucose information can be derived from biological fluid sensors, DNA and RNA sequencing information can be derived from sensors that obtain genomic and genetic data, brain activity data can be derived from neurological sensors, hydration data can be derived from in-mouth saliva or sweat analysis sensors, location data can be derived from GPS/optical/RFID-based sensors, biomechanical data can be derived from optical or translation sensors, breathing rate data can be derived from respiration sensors, and the like. In a refinement, a computed asset includes one or more inputs (e.g., signals, readings, other data) from one or more non-animal data sources in one or more computations, measurements, calculations, derivations, incorporations, simulations, extractions, extrapolations, modifications, enhancements, creations, combinations, estimations, deductions, inferences, conversions determinations, processes, communications, and the like. In another refinement, a computed asset is derived from two or more types of animal data. In another refinement, a computed asset is comprised of a plurality of computed assets. In another refinement, a computed asset may be derived utilizing at least a portion of simulated data.

The term “evaluation indicator” refers to at least one of or any combination of digital signatures (e.g., unique digital signatures, non-unique digital signatures), thresholds (e.g., including a goal, limit, amount, level, rate, minimum, maximum), identifiers (e.g., non-unique identifiers, unique identifiers), identifications, patterns (e.g., any type of pattern including time slice, spatial, spatiotemporal, temporospatial, and the like), rhythms (e.g., biological-based rhythms), trends, scores (e.g., risk score; probability score, data score based on quality, volume, and/or other characteristics; and the like), commands, actions, features, measurements, outliers, anomalies, characteristics (e.g., including unique characteristics, consistencies, inconsistencies), lines of codes, graphs, charts, plots, summaries, visual representations (e.g., color), readings, numerical representations, descriptions, text, predictions, probabilities, summaries, possibilities, forecasts, evaluations, comparisons, assessments, instructions, projections, recommendations, or other communication medium readable or interpretable by an animal or computing device (collectively the “one or more outputs” of the at least one evaluation indicator in some variations), derived from one or more calculations, computations, derivations, extractions, extrapolations, simulations, creations, combinations, comparisons, modifications, enhancements, estimations, evaluations, inferences, establishments, determinations, conversions, deductions, requests, targets, requirements, interpretations, or observations from at least a portion of animal data (e.g., including its associated metadata), the one or more subjects, the one or more sensors (e.g., including the one or more sensor parameters), the at least one variable, reference data, contextual data (if different from the aforementioned data types), or a combination thereof, that enables the identification, evaluation, creation and/or modification of the one or more actions taken by the system—if any—related to selecting, creating, modifying, setting, or a combination thereof, one or more sensor operating parameters (e.g., with “sensor operating parameters” being a variation of “sensor parameters” which can include sensor parameters, sensor settings, sensor configurations, sensor functionalities, and the like) for each of the one or more sensors (e.g., settings, configurations) or subset of sensors (e.g., with the term “subset” including all sensors), which can include enabling sensors to provide data or stopping sensors from providing data. In a refinement, the evaluation indicator can include one or more calculations, computations, derivations, extractions, extrapolations, simulations, creations, combinations, comparisons, modifications, enhancements, estimations, evaluations, inferences, establishments, determinations, conversions, deductions, interpretations, or observations (e.g., via a computing device, an individual, a sensor, or the like) derived from or related to one or more requests, targets, requirements, or the like that enable the identification, evaluation, creation and/or modification of the one or more actions taken by the system-if any-related to selecting, creating, modifying, setting, or a combination thereof, one or more sensor operating parameters for each of the one or more sensors or subset of sensors, as well as activating or deactivating sensors (e.g., enabling sensors to provide data or stopping sensors from providing data). The evaluation indicator can be created or modified during data collection, prior to data collection, or after data collection. In another refinement, the evaluation indicator is used to intelligently (e.g., via one or more Artificial Intelligence techniques) identify one or more actions that are required to be taken by one or more computing devices (e.g., the collecting computing device, other computing devices), one or more sensors (e.g., one or more source sensors, one or more other sensors in communication with the one or more source sensors), one or more users (e.g., administrators, targeted subjects), or a combination thereof, in relation to the one or more sensors (e.g., selection of the one or more sensors; one or more modifications to its functionalities, behavior(s), output(s), and the like) or the one or more computing devices associated with the one or more sensors and in response to (e.g., either directly or indirectly) information derived from the at least one variable. For example, the collecting computing device utilizes the information derived from the evaluation indicator (e.g., its one or more outputs) to intelligently identify one or more actions required to be performed by the one or more sensors (e.g., an action required to be performed related to the one or more sensors based on the evaluation indicator output). In response to the identification of the one or more actions, the collecting computing device creates, accesses, modifies (e.g., which can include “enhance,” “update,” or other similar terms), or a combination thereof, one or more commands (e.g., via one or more lines of code) to transmit to the one or more sensors in order for the one or more sensors to perform the one or more actions. In a refinement, the one or more outputs of the one or more evaluation indicators results in the system creating, accessing, modifying, or a combination thereof (e.g., accessing and modifying), one or more commands that provide one or more instructions to the one or more source sensors to perform one or more actions. In a variation, the one or more evaluation indicators are used to create or modify the one or more instructions, identify the one or more actions required to be performed (e.g., by the one or more sensors, by one or more computing devices), and the like. Actions can include, but are not limited to, what one or more sensor(s) to modify, what one or more operating parameters for each or a subset of the one or more sensors (e.g., including subset of sub-sensors within each sensor) to modify, how to modify, when to modify, where to modify, and the like (e.g., duration of modification, where to send the data, volume of data to send, frequency of sending data, type of data to send, and the like). Such commands and instructions can be contemplated, and such actions can be taken, in the context of one or more plans created, modified, or implemented by the system to collect data with one or more sensors and their one or more operating parameters specified for any given use case or requirement, the environment the data is being collected, or in light of any other variable (with the one or more actions being included as part of the reference data based upon the at least one variable). In another refinement, the one or more outputs of the one or more evaluation indicators are used by the system to direct the system on the manner in which to gather (e.g., intelligently; in some variations, automatically) the animal data from the one or more source sensors, communicate (e.g., intelligently; in some variations, automatically) with one or more computing devices (e.g., the system may need to understand how much storage is available on any collecting computing device so it communicates with the computing device to gather information related to the computing device's capacity/limitations in order to create an evaluation indicator to determine the one or more ways in which to modify the one or more sensor operating parameters to comply with the computing device capacity/limitations), transmit (e.g., intelligently; in some variations, automatically) the one or more commands either directly or indirectly to the one or more source sensors to create or modify one or more sensor operating parameters (and/or turn on or off activating/deactivating one or more sensors), and the like. In another refinement, the at least one evaluation indicator uses animal data derived from two or more sensors to create, modify, or enhance the at least one evaluation indicator. In another refinement, the at least one evaluation indicator uses two or more types of animal data to create, modify, or enhance the at least one evaluation indicator. In another refinement, the at least one evaluation indicator uses two or more types of animal data derived from the same source sensor to create, modify, or enhance the at least one evaluation indicator. In another refinement, the at least one evaluation indicator uses two or more types of animal data derived from two or more sensors to create, modify, or enhance the at least one evaluation indicator. In another refinement, the at least one evaluation indicator includes at least a portion of non-animal data. In another refinement, the creation, modification, or enhancement of the at least one evaluation indicator utilizes at least a portion of artificial data (e.g., simulated data, synthetic data, and the like). In another refinement, the at least one evaluation indicator is created, modified, or enhanced by utilizing at least a portion of metadata. In another refinement, the at least one evaluation indicator is created, modified, or enhanced by utilizing two or more variables. In another refinement, the at least one evaluation indicator enables authentication of, or related to, the one or more sensors (e.g., authenticating that the one or more sensors are, in fact, being used to collect animal data from the targeted subject; authentication of one or more readings (e.g., including derivatives such as computed assets, insights, or predictive indicators) derived from the one or more sensors or other information derived from animal data via one the or more sensors) and/or verification of the one or more subjects and/or the associated animal data (e.g., verifying that the animal data is derived from the targeted subject via one or more biological-based signatures, identifiers, and the like in the animal data that identify the targeted subject; verifying the one or more readings derived from the one or more sensors or other information derived from animal data via one the or more sensors). In another refinement, the at least one evaluation indicator enables identification and/or verification of one or more biological responses associated with the targeted subject and derived from at least a portion of sensor data (e.g., identification and/or verification that the subject is, in fact, experiencing a specific medical episode, has abnormalities in one or more of their animal data readings such as abnormal breathing or heart rate, and the like) or medical condition (e.g., verification that the targeted subject has a condition such as a heart arrhythmia or diabetes). In another refinement, the at least one evaluation indicator is created, modified, or enhanced from two or more types of animal data that are captured across one or more time periods and one or more activities. For example, an evaluation indicator may be created for an individual based upon multiple computed assets or insights, captured across multiple time periods and multiple activities, and the like. In another refinement, the at least one evaluation indicator is created, modified, or enhanced using two or more types of animal data, collected across two or more time periods, collected when the targeted subject is engaged in one or more activities, or a combination thereof. In another refinement, the at least one evaluation indicator is created, modified, or enhanced using animal data derived from two or more subjects with at least one of the subjects being the targeted subject. In another refinement, the one or more outputs of the one or more evaluation indicators are utilized, at least in part, as one or more inputs to derive (e.g., create), modify, or enhance one or more evaluation indicators. In another refinement, the at least one evaluation indicator can be unique to a targeted individual, the animal data, the one or more sensors, the one or more sensor parameters e.g., operating parameters which can include sensor configurations, sensor settings, and the like), the system, the biological response, the medical condition, the one or more computing devices, the use case/requirement, or a combination thereof. In another refinement, the at least one evaluation indicator is not unique to a targeted individual, the animal data, the one or more sensors, the one or more sensor parameters, the system, the biological response, the medical condition, the one or more computing devices, the use case/requirement, or a combination thereof (e.g., including subset(s)) and can be applied to multiple targeted individuals, sensors, sensor parameters, systems, biological responses, medical conditions, computing devices, the use case/requirement, or a combination thereof. In another refinement, the at least one evaluation indicator is created, modified, or enhanced using one or more Artificial Intelligence techniques (e.g., including Machine Learning, Deep Learning, Statistical Learning, and the like). In another refinement, the at least one evaluation indicator is created, modified, or enhanced using one or more Artificial Intelligence techniques (e.g., which include “Artificial Intelligence-based techniques” and vice versa) that produce one or more biological-based representations of the targeted individual (e.g., interpretable information related to the targeted individual's biological responses—derived from their animal data—in one or more contexts, including a plurality of contexts) for the purposes of understanding one or more biological functions or processes of the targeted individual based upon their animal data (e.g., a personalized biological baseline for that individual, such as a digital map of biological responses for each individual associated with contextual data—including the outcome associated with each biological function or combination of biological functions—that enables the system to learn and understand about that individual's body on a granular level) to create, modify, or enhance the at least one evaluation indicator. In another refinement, an evaluation indicator is comprised of a plurality of evaluation indicators. In another refinement, the evaluation indicator is comprised of, at least in part, one or more lines of code which instruct the one or more sensors to take one or more actions. In another refinement, upon creation, modification or enhancement of the evaluation indicator, the evaluation indicator becomes a reference evaluation indicator, which can be included as part of one or more digital records associated with the targeted individual, the one or more sensors, the one or more sensor parameters, the system, the one or more medical conditions, the one or more biological responses, the one or more computing devices, the one or more users (e.g. administrators), the one or more use cases/requirements, or a combination thereof. In another refinement, the system creates or modifies one or more tags for, or based on, the least one evaluation indicator to support the system's indexing and search functions related to the at least one evaluation indicator. In another refinement, the one or more outputs of the at least one evaluation indicator initiates the computing device to take no action at all. In another refinement, the number of evaluation indicators created, as well as the number of times an evaluation indicator is modified, can be a tunable parameter based upon the at least one variable (e.g., the use case). For example, a plurality of evaluation indicators may be created by the system for any data collection period (e.g., the system may create an evaluation indicator that establishes thresholds for one or more data characteristics required for each data type to fulfill one or more requirements—such as a reimbursement code—or use cases; the system may create a plurality of evaluation indicators that establish multiple thresholds for the one or more data characteristics required for each data type at any given time—such as data quality, volume and the like—to fulfill one or more requirements or use cases, which the system evaluating the data every n seconds, minutes, hours, days, or the like). In another refinement, two or more evaluation indicators are utilized to create or modify another one or more evaluation indicators. In another refinement, two or more outputs from one or more evaluation indicators are utilized to create or modify another one or more evaluation indicators. In a refinement, the evaluation indicator can be created based on a variable (e.g., user input of a code). Moreover, many evaluations can be created for any data collection period. The evaluation indicator can determine how much data is being collected to fulfill one or more reimbursement codes or use cases. Therefore, multiple evaluation indicators may be created at any given time to ensure the data with the desired characteristics (e.g., correct volume, quality, and the like).

In another refinement, the at least one evaluation indicator is used to evaluate one or more monetary (e.g. cash, digital currency) or non-monetary (e.g., goods, services, benefits) values (e.g., the actual one or more monetary values or range of values the animal data can be sold or exchanged for; the goods, services, and the like the animal data can be exchanged for; monetary or non-monetary potential of the animal data, including one or more future values; and the like) associated with animal data gathered by the collecting computing device or other computing device, animal data not yet collected but capable of being collected based upon the one or more sensors, other animal data, contextual data (e.g., including one or more terms/preferences established for the animal data), reference data (e.g., including one or more previously established terms/preferences established for the animal data), or a combination thereof. In another refinement, the one or more outputs of the at least one evaluation indicator includes one or more recommendations, predictions, possibilities, or probabilities created or modified for a targeted individual, user (e.g., administrator), or computing device related to the requisite data (e.g., the type of animal and/or non-animal data to be collected, the type of contextual data to be collected, the type of reference data to be included, the type of preferences/terms to be associated with the collected data), and the like), the requisite one or more sensors (e.g., the type(s) of sensors to be used to collect the requisite data), the requisite one or more sensor parameters (e.g., the associated one or more operating parameters of the one or more sensors to collect the requisite data), or a combination thereof, to achieve one or more monetary or non-monetary values (e.g., with the term “values” including thresholds, targets, and the like) associated with the animal data for one or more use cases or requirements (e.g., which can be defined or inputted by the targeted individual, other data owner/provider, data acquirer, administrator, other user, or a combination thereof). In a variation, the at least one evaluation indicator can be used to evaluate revenue and/or costs related to the achievement of one or more monetary or non-monetary values (e.g., cost of acquiring, storing, and providing data from one or more sensors and/or other computing devices compared to the revenue opportunity for the distribution of that data on a per use-case or requirement basis). Characteristically, the system can be configured to generate multiple monetary or non-monetary values (or a combination thereof) for multiple use cases or requirements/targets (e.g., which can include obligations based upon the one or more use cases) based upon (e.g., using) at least a portion of the same animal data. For example, the system can be configured to provide a party in control of animal data (e.g., targeted individual, data owner, administrator, data provider, other user) with an option to “accept” the one or more recommendations, predictions, possibilities, or probabilities to provide animal data and associated metadata (e.g., contextual data) with one or more tunable parameter requirements (e.g., established by a data acquirer, individual/entity in control of the animal data, or a combination thereof) associated with the data (e.g., type(s) of animal data to be collected, duration of animal data collection, frequency of animal data collection, requisite activity associated with animal data collection, time period for animal data collection, contextual data required, and the like) for consideration (e.g., via one or more displays; one-click or gestural “accept” option), enabling the system to automatically configure the one or more sensors with the applicable one or more operating parameters to gather the requisite animal data and associated metadata in contemplation of the one or more tunable parameter requirements to achieve the monetary target. In another refinement, the system automatically accepts the one or more recommendations, predictions, possibilities, or probabilities on behalf of the data owner or provider based on their one or more established preferences.

In another refinement, the at least one evaluation indicator is used to evaluate (e.g., assess) one or more sensor and contextual data requirements, including one or more sensor parameter requirements (e.g., operating parameter requirements), to achieve one or more targets or thresholds (e.g., monetary targets, non-monetary targets, or a combination thereof) or fulfill one or more use cases, targets, or requirements (e.g., a system's obligation/requirement to fulfill one or more insurance reimbursement codes such as CPT codes; a system's requirement to monitor a targeted individual until their body temperature decreases to n; a system's requirement to provide a specified type of animal data and associated contextual data to a computing device to create one or more predictions or products for sports betting; and the like). In another refinement, the output of the at least one evaluation indicator includes one or more instructions created or modified by the system and provided to the one or more sensors to gather (e.g., collect) animal data based upon a monetary/non-monetary target, monetary/non-monetary threshold, a requirement (e.g., which can be derived from one or more requests from one or more data acquirers, or from an obligation established by the system based upon one or more use cases or requests, or the like), a use case (e.g., which can dictate the one or more obligations or requirements), or a combination thereof. For example, a targeted individual may input a variable such as a monetary target related to their animal data in order for the individual to monetize their animal data. Based upon the input(s), the system can evaluate—via the evaluation indicator—the requisite animal data, the requisite one or more sensors to collect the requisite animal data, the requisite one or more sensor parameters associated with the requisite one or more sensors, the requisite contextual data (e.g., type of data required, quantity of data required, volume of data required, conditions in which the data needs to be collected, data terms/preferences related to use of the data by the acquirer, and the like), the requisite reference data, the requisite computing parameters required to gather the data, the requisite costs (e.g., including costs related to collecting, storing, transforming, and/or distributing data), or a combination thereof, to achieve the monetary target and automatically configure the one or more sensors (e.g., turn on/off one or more sensors, change sensor parameters) to collect animal data to achieve the monetary target. In some variations, the system can also configure one or more computing devices (e.g., modify their one or more operating parameters) based upon the at least one variable in order to gather the requisite animal data as instructed by the system (e.g., based upon the use case/requirement/obligation/target and the like). In another refinement, the system uses one or more monetary targets or thresholds, one or more data provider or data acquirer preferences (e.g., including requests), or a combination thereof, to derive the evaluation indicator.

In another refinement, the at least one evaluation indicator is used to evaluate one or more sensor requirements (e.g., in light of the at least one variable), which can include the use of one or more sensors (e.g., type of sensors used) and/or one or more sensor parameters, in conjunction with animal data, contextual data (e.g., including the one or more use cases), reference data, or a combination thereof, to: (1) create or modify one or more markets (e.g., bets); (2) accept one or more wagers; (3) create, enhance, modify, acquire, offer, or distribute one or more products; (4) evaluate, calculate, derive, modify, enhance, or communicate one or more predictions, probabilities, or possibilities; (5) formulate one or more strategies; (6) take one or more actions; (7) identify, evaluate, assess, mitigate, prevent, or take one or more risks; (8) collect animal data that can be utilized as one or more signals or readings utilized in one or more simulations, computations, or analyses; (9) collect animal data that can be utilized as part of one or more simulations, an output of which directly or indirectly engages with one or more users; (10) create or modify one or more outputs that recommend one or more actions; (11) collect animal data that can be utilized as one or more core components or supplements to one or more mediums of consumption; (12) collect animal data that can be utilized in one or more promotions; (13) evaluate, assess, or optimize animal data-based performance for one or more targeted individuals; or (14) a combination thereof. In a variation, the at least one evaluation indicator is used to evaluate one or more sensor requirements in conjunction with the one or more computing devices in communication (e.g., direct or indirect communication) with the one or more sensors. For example, the system can be configured to evaluate one or more characteristics or variables associated with or related to the animal data (e.g., sampling rate, environmental factors) and make one or more determinations related to one of the aforementioned actions (e.g., the system may make a determination that it needs more animal data of a certain type in order to create a requisite product or prediction, but checks with the one or more computing devices to ensure the computing device can support the gathering of that data in the requisite variables such as required time frame, required data volume, required latency, or the like). In another refinement, the at least one evaluation indicator is utilized by the system or user (e.g., data provider, data acquirer, administrator, and the like) to make one or evaluations in conjunction with—or based upon—the at least one variable (e.g., animal data, contextual data, the one or more use cases, reference data, sensor information, one or more requirements, which can include sensor requirements, the one or more types of sensors to be used, data requirements to fulfill one or more obligations, and the like), wherein the one or more outputs of the one or more evaluations enables the system or user to: (1) create or modify one or more markets (e.g., bets); (2) accept one or more wagers; (3) create, enhance, modify, acquire, offer, or distribute one or more products; (4) evaluate, calculate, derive, modify, enhance, or communicate one or more predictions, probabilities, or possibilities; (5) formulate one or more strategies; (6) take one or more actions; (7) identify, evaluate, assess, mitigate, prevent, or take one or more risks; (8) collect animal data that can be utilized as one or more signals or readings utilized in one or more simulations, computations, or analyses; (9) collect animal data that can be utilized as part of one or more simulations, an output of which directly or indirectly engages with one or more users; (10) create or modify one or more outputs that recommend one or more actions; (11) collect animal data that can be utilized as one or more core components or supplements to one or more mediums of consumption; (12) collect animal data that can be utilized in one or more promotions; (13) evaluate, assess, or optimize animal data-based performance for one or more targeted individuals; or (14) a combination thereof.

In a refinement, the act of “evaluating” refers to an identification and/or assessment of information derived from one or more data sets, which can include animal and non-animal data sets (e.g., including its one or more derivatives, reference data, or a combination thereof) and/or other gathered information (e.g., contextual data) derived from one or more individuals, sensors, computing devices (e.g., including one or more inputs via the one or more computing devices), use cases, or a combination thereof. The one or more acts of evaluating can include the creation or modification of one or more digital signatures, identifiers, patterns (e.g., any type of pattern including time slice, spatial, spatiotemporal, temporospatial, and the like), rhythms, trends, summaries, scores (e.g., data score based on data quality completeness, terms/permissions/conditions associated with the animal data, and/or other characteristics), features, measurements, outliers, anomalies, or characteristics (e.g., unique characteristics) derived from one or more calculations, computations, derivations, extractions, extrapolations, simulations, creations, combinations, comparisons, modifications, enhancements, estimations, evaluations, inferences, establishments, determinations, conversions, deductions, requests, targets, requirements, interpretations, or observations from the gathered information that derives other information that enables the system to make one or more evaluations. In a refinement, the act of evaluating can include the one or more calculations, computations, derivations, extractions, extrapolations, simulations, creations, combinations, comparisons, modifications, enhancements, estimations, evaluations, inferences, establishments, determinations, conversions, deductions, interpretations, or observations that enables to make one or more evaluations derived from or related to one or more requests, targets, requirements, or the like (e.g., via one or more use cases). In a refinement, the act of evaluating can occur prior to data collection, during data collection, or after data collection. In a refinement, act of evaluating can include identifying, verifying, validating, authenticating, or a combination thereof. In a refinement, the act of evaluating includes the use of at least one evaluation indicator. In another refinement, the system creates two or more evaluation indicators, at least one of which is derived from—at least in part—the animal data (e.g., or its one or more derivatives), the one or more sensors, the one or more computing devices, or a combination thereof (e.g., with “at least in part” in this context meaning other information may also be included), and at least one of which is derived from—at least in part—the reference data, to make the one or more evaluations related to the animal data, the one or more sensors, the one or more computing devices, or a combination thereof. In another refinement, the system can create or modify and assign an insight or other indicator associated with the evaluated animal data, one or more sensors, one or more computing devices, or a combination thereof, to provide context to the evaluation (e.g., data quality score) or identify the type of evaluation required to occur (e.g., what data needs to be evaluating, the purpose of evaluation, what type of evaluation indicator needs to be created or modified, and the like) based upon the context (e.g., the at least one variable). In some variations, the insight or other indicator can provide verification that an evaluation has occurred (e.g., a notification that an evaluation has occurred).

In a refinement, one or more evaluations that include one or more comparisons or a step of comparing occur when the system utilizes one or more programs, which can incorporate one or more techniques (e.g., Artificial Intelligence techniques which can include, but are not limited to, Machine Learning techniques, Deep Learning techniques, Statistical Learning techniques, or other statistical techniques), to measure, observe, calculate, derive, extract, extrapolate, simulate, create, combine, modify, enhance, estimate, evaluate, infer, establish, determine, convert, or deduce one or more similarities, dissimilarities, or a combination thereof, between two or more animal data sets (e.g., which can include one or more derivatives of animal data and its associated metadata), at least one of which is derived from reference animal data and at least one of which is derived—at least in part—from one or more source sensors. In one scenario, a comparison occurs when the system utilizes a sophisticated ensemble clustering algorithm that uses a combination of clustering algorithms that can include Density-Based Spatial Clustering Of Applications With Noise (DBSCAN), BIRCH, Gaussian Mixture Model (GMM), Hierarchical Clustering Algorithm (HCA) and Spectral-based clustering while using metrics of similarity grouping that can include inertia and silhouette scoring, as well as information criteria scores to identify the group or cluster. The output of the above methodology map gives data to a cluster or group. Within the created group, one or more additional algorithms (e.g., Machine Learning algorithms) can be used that measure the nearness of data to similar sub-groups to identify, at least in part, the potential target the given data belongs to.

In another refinement, “compare” can mean “evaluate” and/or “analyze,” and vice versa. For example, a step of comparing two or more data sets (e.g., a data set to a reference data set) via at least one evaluation indicator to configure one or more sensors (e.g., activate or deactivate a sensor; create, modify, set, or a combination thereof, one or more sensor parameters for each source sensor or subset of source sensors; modify one or more actions of the one or more computing devices) can involve forming insights for one or more sensors (e.g., types of sensors, types of data derived from sensors, configurable operating parameters for each sensor, and the like) based upon the individual (or subset of individuals) and the at least one variable, which can be included as part of the reference data as reference insights. Reference insights can be created or assigned (e.g., assigned to data) in which predetermined ranges of sensors, sensor parameters, and data (e.g., including characteristics of data such as data type, quality, the source sensor(s), the individual the data was derived from, volume of the data set, associated metadata, and the like) are associated with predefined variables (e.g., use cases). Therefore, in this context, “compare” means to select the appropriate one or more reference data sets, reference evaluation indicators, or a combination thereof, based upon the at least one variable, the one or more sensors (e.g., source sensors), and the one or more targeted individuals, in order to enable identification of the requisite sensors, sensor parameters, and data by the system.

The term “predictive indicator” refers to a metric or other indicators (e.g., one or more colors, codes, numbers, values, graphs, charts, plots, readings, numerical representations, descriptions, text, physical responses, auditory responses, visual responses, kinesthetic responses, and the like) derived from at least a portion of animal data from which one or more forecasts, predictions, probabilities, assessments, possibilities, projections, or recommendations related to one or more outcomes for one or more events that include one or more targeted individuals, or one or more groups of targeted individuals, can be calculated, computed, derived, extracted, extrapolated, quantified, simulated, created, modified, assigned, enhanced, estimated, evaluated, inferred, established, determined, converted, deduced, observed, communicated, or actioned upon. In a refinement, the predictive indicator is derived from sensor-based data (e.g., information related to the one or more source sensors and their associated operating parameters) and related to the one or more sensors and their one or more operating parameters (e.g., a prediction related to sensor behavior or future characteristics of data derived from one or more sensors based upon the sensor, the associated operating parameters, the one or more targeted individual, the at least one variable, other contextual data, the one or more computing devices, or a combination thereof). In another refinement, a predictive indicator is a calculated computed asset. In another refinement, a predictive indicator includes one or more inputs (e.g., signals, readings, other data) from one or more non-animal data sources as one or more inputs in the one or more calculations, computations, derivations, extractions, extrapolations, simulations, creations, combinations, comparisons, modifications, assignments, enhancements, estimations, evaluations, inferences, establishments, determinations, conversions, deductions, observations, interpretations, or communications of its one or more forecasts, predictions, probabilities, possibilities, comparisons, evaluations, assessments, projections, or recommendations. In another refinement, a predictive indicator includes at least a portion of simulated data as one or more inputs in the one or more calculations, computations, derivations, extractions, extrapolations, simulations, creations, combinations, comparisons, modifications, assignments, enhancements, estimations, evaluations, inferences, establishments, determinations, conversions, deductions, observations, interpretations, or communications of its one or more forecasts, predictions, probabilities, possibilities, comparisons, evaluations, assessments, projections, or recommendations. In another refinement, a predictive indicator is derived from two or more types of animal data. In yet another refinement, a predictive indicator is comprised of a plurality of predictive indicators. In yet another refinement, a created, modified, or enhanced predictive indicator is used as training data for one or more Artificial Intelligence techniques to create, modify, or enhance of one or more subsequent predictive indicators.

For the purposes of this invention, any reference to the collection or gathering of animal data from one or more source sensors from a subject includes gathering the animal data from one or more computing devices associated with the one or more source sensors (e.g., a cloud server or other computing device associated with the one or more source sensors where the data is gathered, stored and/or accessible). Additionally, the terms “gathering” and “collecting” can be used interchangeably, and reference to any one of the terms should not be interpreted as limiting but rather as encompassing all possible meanings of both terms. In a refinement, the terms “gathering” and “collecting” can be used interchangeably with the term “receiving” (and vice versa), and reference to any one of the terms should not be interpreted as limiting but rather as encompassing all possible meanings of all the terms.

The term “modify” can be inclusive of “revise.” “amend,” “update.” “enhance.” “adjust,” “change.” and “refine” (and vice versa). In some variations, “modify” can also include “enable” and “disable” or like terms. Additionally, the term “create” can be inclusive of “derive” and vice versa. Similarly, “create” can be inclusive of “generate” and vice versa. In a refinement, “create” can also include an action that is calculated, computed, derived, extracted, extrapolated, simulated, modified, enhanced, estimated, evaluated, inferred, established, determined, converted, or deduced. As set forth below, one or more Artificial Intelligence techniques (e.g., including Machine Learning, Deep Learning, Statistical Learning, and the like) are utilized to perform (e.g., intelligently) at least one of the one or more actions. The term “enhance” refers to an improvement of quality or value in data and in particular the animal data or one or more derivatives thereof (e.g., evaluation indicator, predictive indicator, insight, reference data, and the like).

In a refinement, a modification or enhancement of data can occur (1) as new data (e.g., animal data, non-animal data) is gathered by the system; (2) based upon one or more evaluations of existing data (e.g., one or more new patterns, trends, features, measurements, outliers, abnormalities, anomalies, readings, signals, data sets, characteristics/attributes, and the like that are identified in existing data sets or new data sets by the system); (3) as existing data is removed, replaced, or amended in the system; (4) as the system learns one or more new methods of transforming existing data into new data sets or deriving new data sets from existing data (e.g., the system learns to derive respiration rate data from raw sensor data that is traditionally used to extrapolate ECG data); (5) as new data sets are generated artificially; (6) as a result of one or more simulations; and the like. For example, new data entering the system may enhance the accuracy of an evaluation indicator created by the system. In another example, a data set or animal data derivative can be modified if data is removed from, or replaced in, the system (e.g., the system's removal of data from the reference animal data database may enable a more accurate identification of a targeted individual or sensor operating parameters required based upon the at least one variable). In some variations, modification may result in a decrease in quality or value of the animal data or its one or more derivatives (e.g., a decrease in prediction accuracy or accuracy in identifying the requisite one or more sensor operating parameters based upon the at least one variable).

The term “or a combination thereof” can mean any subset of possibilities or all possibilities. In a refinement, “or a combination thereof” includes both “or combinations thereof” and “and combinations thereof” and vice versa.

The term “neural network” refers to a Machine Learning model that can be trained with training input to approximate unknown functions. In a refinement, neural networks include a model of interconnected digital neurons that communicate and learn to approximate complex functions and generate outputs based on a plurality of inputs provided to the model. Typically, a trained neural network can be used to make the one or more selections described herein. Moreover, the training input includes data with known outcomes for a selection of a sensor (e.g., activation of a sensor or identification to send commands to). Once trained with the training input, the trained neural input can predict a sensor selection for the real-world situation (e.g., an unknown system status with respect to selecting a sensor.)

The terms “use”, “uses”, or “used” when referring to actions taken by a computing system mean that the item being “used” is received as an input for a calculation performed by the computing system to provide an indicated output.

In some variations, when a computing device performs an action of accessing information, it is also performing an action of selecting that information.

In some variations, when a computing device performs an action “automatically,” it may also be configured to perform the action dynamically with little or no user input or interaction.

In some variations, when a computing device or sensor performs an action “intelligently,” it is meant that the computing device or sensor performs the action via the use of one or more Artificial Intelligence techniques. In a refinement, the action can occur dynamically and/or automatically. In some refinements, an action performed intelligently is an action identified by the Artificial Intelligence technique (e.g., a trained neural network). Such identified action are typically optimized actions as determined by the Artificial Intelligence technique (e.g., a trained neural network).

In a refinement, when referring to the system “intelligently selecting” sensors and their associated operating parameters, the present disclosure is referring to the implementation of one or more techniques (e.g., Artificial Intelligence techniques which can include, but are not limited to, Machine Learning techniques, Deep Learning techniques, Statistical Learning techniques, or other statistical techniques) that selects one or more sensors, which can include one or more sub-sensors and/or subsets of sensors or sub-sensors, to create, modify, set, or a combination thereof, one or more sensor settings from a set comprising of all the source sensors that can be targeted by this system.

In a refinement, when referring to the system “intelligently gathering” animal data from the one or more source sensors, the present disclosure is referring to the implementation of one or more techniques (e.g., Artificial Intelligence techniques which can include, but are not limited to, Machine Learning techniques, Deep Learning techniques, Statistical Learning techniques, or other statistical techniques) to derive information from the at least one variable, the at least one evaluation indicator, or a combination thereof, that informs the system of the requisite animal data to be gathered. For example, if the system determines that more precise data readings or different types of data are needed based on the at least one variable, evaluation indicator, or a combination thereof, the system can intelligently change rate of data collection from n per second to y per millisecond, or intelligently modify the type of the data being gathered (e.g., from an existing source sensor or from a new source sensor) in order to intelligently gather the requisite animal data.

In a refinement, when referring to the system “intelligently transmitting” one or more commands either directly or indirectly to the one or more source sensors to create or modify one or more sensor operating parameters (e.g., including activating or deactivating one or more source sensors), the present disclosure is referring to the implementation of one or more techniques (e.g., Artificial Intelligence techniques which can include, but are not limited to, Machine Learning techniques, Deep Learning techniques, Statistical Learning techniques, or other statistical techniques) to make one or more determinations related to the transmission of the one or more commands (e.g., timing of the transmission; frequency of the transmission, including one or more retries; the order in which the one or more commands are sent) based upon information derived from the at least one variable, the at least one evaluation indicator, or a combination thereof. For example, the system can create two commands simultaneously or concurrently, with one command increasing the rate of data collection for source sensor A and another command reducing the rate of data collection for source sensor B. The system can intelligently combine these commands to comprise a single command distributed to multiple source sensors to perform the different functions. In a variation, these combined commands can be transmitted intelligently such that the reduction of rate for source sensor B happens prior to the increase in rate of data collection for source sensor A, after the increase in rate of data collection for source sensor A, or simultaneously with the increase in rate of data collection for source sensor A.

In a refinement, when referring to “one or more sensors” or related terms (e.g., “one or more source sensors”), it can be understood that one or more sub-sensors (e.g., sub-source sensors) that comprise each sensor (e.g., source sensor) are included as part of the one or more sensors. For example, if the system sends one or more commands to each of the one or more sensors, it is understood that the system is sending the one or more commands to the sensor, to each of the one or more sub-sensors that comprise the sensor or a selection of the one or more sub-sensors (with “selection” including only a single sub-source sensor or a subset of source sensors which can include “all” of the sub-source sensors in some variations) that comprise the sensor, or a combination thereof, depending on the type of sensor, the at least one variable (e.g., the use case), and the like. In another refinement, when referring to “one or more sensors,” the application is also referring to its components, including the one or more sub-sensors. In another refinement, reference to “one or more sensors” or related terms (e.g., one or more source sensors) includes reference to one or more sub-sensors.

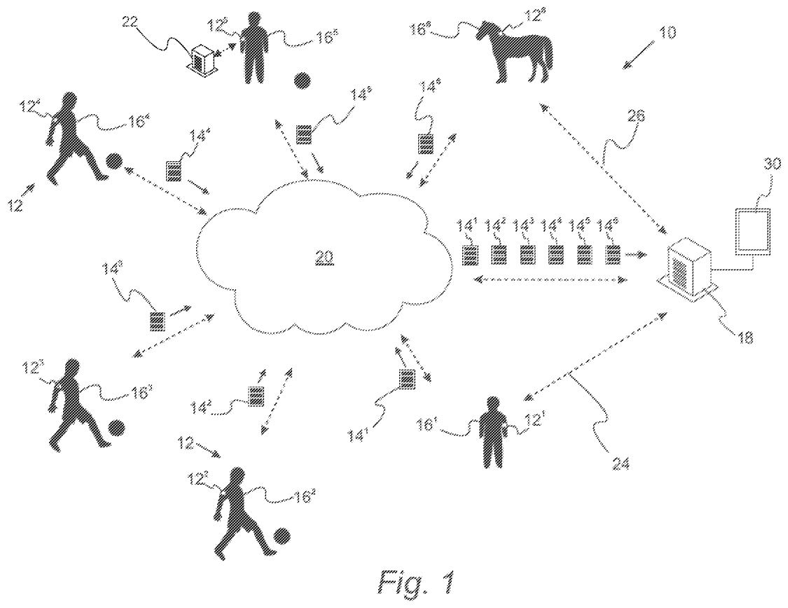

With reference to FIG. 1, a schematic of a system for intelligently selecting sensors and their associated operating parameters is provided. System 10 includes one or more source sensors 12ⁱ that gather animal data 14^{j} from at least one targeted individual 16^{k}, where i, j, and k are integer labels. In this context, animal data can refer to any data related to one or more subjects. For example, sensors can be selected for receiving data therefrom or sending commands thereto. In some embodiments, animal data refers to data related to a subject or a subject's body derived from, at least in part, one or more sensors and, in particular, biological sensors (also referred to as biosensors). The one or more source sensors 12ⁱ can include one or more biological sensors. In some variations, one or more source sensors 12ⁱ can be one or more sub-source sensors contained (e.g., included) within (e.g., or as part of, attached to, and the like) the one or more source sensors, or include one or more sub-source sensors as part of the one or more sensors 12ⁱ. In many useful applications, targeted individual 16^{k} is a human (e.g., an athlete, a soldier, a healthcare patient, an insurance client, an employee, a research subject, a participant in a fitness class, a video gamer or virtual environment participant, and the like) and the animal data 14^{j} is human data.

Animal data can be derived from (e.g., collected or gathered from) a targeted individual or multiple targeted individuals (e.g., including a targeted group of multiple targeted individuals, multiple targeted groups of multiple targeted individuals). Animal data can be derived from a variety of sources, including sensors and other computing devices. In the case of sensors, the animal data can be obtained from a single sensor gathering information from each targeted individual, or from multiple sensors gathering information from each targeted individual. Each sensor 12ⁱ gathering animal data 14^{j} from targeted individual 16^{k} can be classified as a source sensor. In some cases, a single sensor can capture data from multiple targeted individuals, a targeted group of multiple targeted individuals, or multiple targeted groups of multiple targeted individuals (e.g., an optical-based camera sensor that can locate and measure distance run, respiratory data, or the like for a targeted group of targeted individuals). Each sensor can provide a single type of animal data or multiple types of animal data. In a variation, sensor 12ⁱ can include multiple sensing elements (e.g., sub-sensors) to measure one or more parameters within a single sensor (e.g., heart rate data and accelerometer data). One or more sensors 12ⁱ can collect data from a targeted individual engaged in a variety of activities including strenuous activities (e.g., a subject engaged in an athletic competition) that can change one or more biological signals or readings in a targeted individual such as blood pressure, heart rate, or biological fluid levels. Activities may also include sedentary activities such as sleeping, sitting, walking, working, driving, flying, and the like where changes in biological signals or readings may have less variance. One or more sensors 12ⁱ can also collect data before and/or after one or more other activities (e.g., before and after a run, after waking up, after ingesting one or more substances or medications, and any other activity suitable for data collection from one or more sensors). In a refinement, one or more sensors 12ⁱ can include one or more computing devices. In another refinement, one or more sensors 12ⁱ can be classified by a computing device with one or more computing capabilities. In a variation, intelligent monitoring system 10 can also gather (e.g., receive, collect) animal data not obtained directly from sensors (e.g., animal data that is inputted or gathered via a computing device, animal data sets that include artificial data values not generated directly from a sensor, animal data derived from one or more sensors but gathered from another computing device or system, animal data derived from another computing device or system). This can occur via collecting computing device 18 or via one or more other computing devices in communication with collecting computing device 18 that gathers animal data (e.g., a computing device that is local to the targeted individual; a cloud server; and the like). In a refinement, collecting computing device 18 is local to the targeted individual and gathers animal data from a single targeted individual. In another refinement, collecting computing device 18 gathers animal data from a plurality of targeted individuals. In another refinement, one or more sensors 12ⁱ are operable to collect or provide at least a portion of non-animal data. In another refinement, at least one sensor of the one or more source sensors captures two or more types of animal data. In another refinement, at least one sensor of the one or more source sensors is comprised of two or more sensors (i.e., the at least one sensor is comprised of two or more sub-sensors). In another refinement, the one or more sensors can be configured to collect data over a continuous period of time, at regular or irregular intervals (e.g., intermittently), at a point in time, or a combination thereof. In many variations, one or more sensors 12ⁱ are operable for real-time or near real-time communication. In another refinement, one or more sensors 12ⁱ are operable to provide at least a portion of streaming animal data (e.g., the sensor may be operable to providing streaming data for all animal data types it collects, the sensor may be operable to provide one streaming data type while providing another data type at a point in time, a sub-sensor of a given sensor may be operable to provide streaming data while another sub-sensor of the same sensor may be operable to only provide point-in-time data, and the like). In another refinement, one or more sensors 12ⁱ are operable for two-way communication (e.g., send one or more signals and receive one or more signals) with one or more computing devices, one or more other sensors, or a combination thereof. In a variation, one or more sensor functionalities, parameters, settings, programs, or properties (e.g., which can collectively be referred to as “parameters” in some variations) are operable to be configured either directly or indirectly (e.g., via another one or more other computing devices) by the system. Figure

One or more sensors 12ⁱ can include one or more biological sensors (also referred to as biosensors). Biosensors collect biosignals, which in the context of the present embodiment are any signals or properties in, or derived from, animals that can be continuously, continually, intermittently, or periodically (e.g., point-in-time) measured, monitored, observed, calculated, computed, or interpreted, including both electrical and non-electrical signals, measurements, and artificially-generated information. A biosensor can gather biological data (including readings and signals, both in raw or manipulated/processed form) such as physiological data, biometric data, chemical data, biomechanical data, genetic data, genomic data, glycomic data, location data, or other biological data from one or more targeted individuals. For example, some biosensors may measure, or provide information that can be converted into or derived from, biological data such as eye tracking & recognition data (e.g., pupillary response, movement, pupil diameter, iris recognition, retina scan, eye vein recognition, EOG-related data), blood flow data and/or blood volume data (e.g., photoplethysmogram (PPG) data, pulse transit time, pulse arrival time), biological fluid data (e.g., analysis derived from blood, urine, saliva, sweat, cerebrospinal fluid), body composition data (e.g., bioelectrical impedance analysis, weight-based data including weight, body mass index, body fat data, bone mass data, protein data, basal metabolic rate, fat-free body weight, subcutaneous fat data, visceral fat data, body water data, metabolic age (e.g., biological age), skeletal muscle data, muscle mass data), pulse data, oxygenation data (e.g., SpO2), core body temperature data, galvanic skin response data, skin temperature data, perspiration data (e.g., rate, composition), blood pressure data (e.g., systolic, diastolic, MAP), glucose data (e.g., fluid balance I/O, glycogen usage), hydration data (e.g., fluid balance I/O), heart-based data (e.g., heart rate, average HR, HR range, heart rate variability, HRV time domain, HRV frequency domain, autonomic tone, ECG-related data including PR, QRS, QT, R-R intervals, echocardiogram data, thoracic electrical bioimpedance data, transthoracic electrical bioimpedance data), neurological data and other neurological-related data (e.g., EEG-related data), genetic-related data (e.g., performance enhancing polymorphisms (PEPs) such as ACTN3, ACE, ADRB2, AMPD1, BDKRB2, APOE, and others), genomic-related data, skeletal data, muscle data (e.g., EMG-related data including surface EMG, amplitude, adenosine triphosphate (ATP) data, muscle fiber types, muscle contraction velocity, muscle elasticity, soft-tissue strength), respiratory data (e.g., respiratory rate, respiratory pattern, inspiration/expiration ratio, tidal volume, spirometry data), and the like. Some biosensors may detect biological data such as biomechanical data which may include, for example, angular velocity, joint paths, kinetic or kinematic loads, gait description, step count, reaction time, or position or accelerations in various directions from which a subject's movements can be characterized. Some biosensors may gather biological data such as location and positional data (e.g., GPS, ultra-wideband RFID-based data; posture data), facial recognition data, posterior profiling data, audio data (e.g., audio signals derived from one or more biological functions; voice data; hearing data), kinesthetic data (e.g., physical pressure captured from a sensor located at the bottom of a shoe or sock), other biometric authentication data (e.g., fingerprint data, hand geometry data, voice recognition data, keystroke dynamics data-including usage patterns on computing devices such as mobile phones, signature recognition data, car acoustic authentication data, eye vein recognition data, finger vein recognition data, footprint and foot dynamics data, body odor recognition data, palm print recognition data, palm vein recognition data, skin reflection data, thermography recognition data, speaker recognition data, gait recognition data, lip motion data), or auditory data (e.g., speech/voice data, sounds made by the subject, emotion captured derived from verbal tone or words used) related to the one or more targeted individuals. Some biological sensors may be image or video-based and collect, provide and/or analyze video or other visual data (e.g., still or moving images, including video, MRIs, computed tomography scans, ultrasounds, echocardiograms, X-rays) upon which biological data can be detected, measured, monitored, observed, extrapolated, calculated, or computed (e.g., biomechanical movements or location-based information derived from video data, a fracture detected based on an X-Ray, or stress or a disease of a subject observed based on video or image-based visual analysis of a subject; observable animal data such as facial movements, bodily movements or a wince which can indicate pain or fatigue). Some biosensors may derive information from biological fluids such as blood (e.g., venous, capillary), saliva, urine, sweat, and the like including (but not limited to) triglyceride levels, red blood cell count, white blood cell count, adrenocorticotropic hormone levels, hematocrit levels, platelet count, ABO/Rh blood typing, blood urea nitrogen levels, calcium levels, carbon dioxide levels, chloride levels, creatinine levels, glucose levels, hemoglobin A1c levels, lactate levels, sodium levels, potassium levels, bilirubin levels, alkaline phosphatase (ALP) levels, alanine transaminase (ALT) levels, and aspartate aminotransferase (AST) levels, albumin levels, total protein levels, prostate-specific antigen (PSA) levels, microalbuminuria levels, immunoglobulin A levels, folate levels, cortisol levels, amylase levels, lipase levels, gastrin levels, bicarbonate levels, iron levels, magnesium levels, uric acid levels, folic acid levels, vitamin B-12 levels, and the like. In a variation, some biosensors may collect biochemical data including acetylcholine data, dopamine data, norepinephrine data, serotonin data, GABA data, glutamate data, hormonal data, and the like. In addition to biological data related to one or more targeted individuals, some biosensors may measure non-biological data (e.g., ambient temperature data, humidity data, elevation data, barometric pressure data, and the like). In a refinement, one or more sensors provide biological data that include one or more calculations, computations, predictions, probabilities, possibilities, combinations, estimations, evaluations, inferences, determinations, deductions, observations, projections, recommendations, comparisons, assessments, or forecasts that are derived, at least in part, from animal data. In another refinement, the one or more biosensors are capable of providing at least a portion of artificial data. In another refinement, the one or more biosensors are capable of providing two or more types of data, at least one of which is biological data (e.g., heart rate data and VO2 data, muscle activity data and accelerometer data, VO2 data and elevation data, or the like). In another refinement, the one or more sensors is a biosensor that gathers physiological, biometric, chemical, biomechanical, location, environmental, genetic, genomic, glycomic, or other biological data from one or more targeted individuals. In another refinement, one or more biosensors collect image/imagery data and/or video data (e.g., one or more images of the subject, one or more videos of the subject, or a combination thereof) via one or more image-based sensors (e.g., including optical sensors that capture static imagery or video). In some variations, the one or more image-based are also operable to gather other animal data (e.g., audio data). In another refinement, the one or more biosensors collect at least a portion of non-animal data.

In another refinement, source sensor 12ⁱ and/or one or more appendices thereof can be affixed to, are in contact with, or send one or more electronic communications in relation to or derived from, one or more targeted subjects including the one or more targeted subjects' body, skin, eyeball, vital organ, muscle, hair, veins, biological fluid, blood vessels, tissue, or skeletal system, embedded in one or more targeted subjects, lodged or implanted in one or more targeted subjects, ingested by one or more targeted subjects, or integrated to include at least a subset of one or more targeted subjects. For example, a saliva sensor or biomechanical sensor (e.g., collecting accelerometer, gyroscope, magnetometer data) affixed to a tooth, a set of teeth, or an apparatus that is in contact with one or more teeth, a sensor that extracts DNA information derived from a targeted subject's biological fluid or hair (or other particle), a sensor that is wearable (e.g., on a human or other animal body), a sensor in a computing device (e.g., phone) that is tracking a targeted individual's location information or collecting other biometric information (e.g., facial recognition, voice, fingerprint), one or more sensors integrated within a head-mountable unit such as smart glasses or a virtual/augmented/mixed reality headset that track eye movements and provide eye tracking data and recognition data, one or more sensors that are integrated into one or more computing devices that analyze animal data (e.g., biological fluid data), a sensor affixed to or implanted in the targeted subject's brain that may detect brain signals from neurons, a sensor that is ingested by a targeted subject to track one or more biological functions, a sensor attached to, or integrated with, a machine (e.g., robot) that shares at least one characteristic with an animal (e.g., a robotic arm with an ability to perform one or more tasks similar to that of a human; a robot with an ability to process information similar to that of a human), and the like. Advantageously, the machine itself can include one or more sensors, and may be classified as both a sensor and a subject. In another refinement, the one or more sensors 12ⁱ are integrated into or as part of, affixed to, or embedded within, a textile, fabric, cloth, material, fixture, object, or apparatus that contacts or is in communication with a targeted individual either directly or via one or more intermediaries or interstitial items. Examples include, but are not limited to, a sensor attached to the skin via an adhesive, a sensor integrated into a watch or head-mountable unit (e.g., augmented reality or virtual reality headset, smart glasses, hat, headband, and the like), a sensor integrated or embedded into clothing (e.g., shirt, jersey, shorts, wristband, socks, compression gear), a sensor integrated into a steering wheel, a sensor Integrated into a computing device controller (e.g., video game or virtual environment controller, augmented reality headset controller, remote control for media), a sensor integrated into a ball that is in contact with an extremity of a targeted subject's body such as their hands (e.g. basketball) or feet (e.g., soccer), a sensor integrated into a ball that is in contact with an intermediary being held by the targeted subject (e.g., bat), a sensor integrated into a hockey stick or a hockey puck that is in intermittent contact with an intermediary being held by the targeted subject (e.g., hockey stick), a sensor integrated or embedded into the one or more handles or grips of fitness equipment (e.g., treadmill, bicycle, row machine, bench press, dumbbells), a toilet or other object (e.g., urinal) with one or more sensors that can analyze one or more biological fluids, stool, or other animal excretions, a sensor that is integrated within a robot (e.g., robotic arm) that is being controlled by the targeted individual, a sensor integrated or embedded into a shoe that may contact the targeted individual through the intermediary sock and adhesive tape wrapped around the targeted individual's ankle, and the like. In another refinement, one or more sensors can be interwoven into, embedded into, integrated with, or affixed to, a flooring or ground (e.g., artificial turf, grass, basketball floor, soccer field, a manufacturing/assembly-line floor, yoga mat, modular flooring), a seat/chair, helmet, a bed, an object that is in contact with the targeted subject either directly or via one or more intermediaries (e.g., a subject that is in contact with a sensor in a seat via a clothing intermediary), and the like. In another refinement, one or more sensors can be integrated with or affixed to one or more aerial apparatus such as an unmanned aerial vehicle (e.g., drone, high-altitude long-endurance aircraft, a high-altitude pseudo satellite (HAPS), an atmospheric satellite, a high-altitude balloon, a multirotor drone, an airship, a fixed-wing aircraft, or other altitude systems), manned aerial vehicle (e.g., airplane, helicopter), or other aerial computing device that utilizes one or more sensors (e.g., optical, infrared) to collect animal data (e.g., skin temperature, body temperature, heart rate, heart rate variability, respiratory rate, facial recognition, gait recognition, location data, image/video data, one or more subject characteristics or attributes, and the like) from one or more targeted subjects or groups of targeted subjects. In another refinement, the sensor and/or its one or more appendices can be in contact with one or more particles or objects derived from the targeted subject's body (e.g., tissue from an organ, hair from the subject) from which the one or more sensors derive, or provide information that can be converted into, biological data. In yet another refinement, one or more sensors can be optically-based (e.g., camera-based) and provide an output from which biological data can be detected, measured, monitored, observed, extracted, extrapolated, inferred, deducted, estimated, determined, combined, calculated, or computed. In yet another refinement, one or more sensors can be light-based and use infrared technology (e.g., temperature sensor or heat sensor) to gather or calculate biological data (e.g., skin or body temperature) from an individual or the relative heat of different parts of an individual. In another refinement, a single sensor can be comprised of two or more sensors (e.g., sub-sensors within a single sensor). In yet another refinement, the one or more sensors gather animal data related to one or more attributes (e.g., characteristics) or states of being of an individual (e.g., an optical sensor that gathers animal data such as skin color, facial hair, eye color, conditions of the skin, and the like; an optical sensor that detects pain, fatigue, injury, a medical event/episode/condition, and the like).

In a refinement, a single source sensor can include one or more sub-source sensors (e.g., multiple sensors or sensing elements within a single sensor). In another refinement, the one or more source sensors are sub-source sensors included within a single source sensor or across multiple source sensors. In another refinement, a single source sensor is comprised of two or more source sensors (e.g., the source sensor is comprised of multiple sub-source sensors). In another refinement, a single source sensor includes two or more biological sensors (e.g., sub-source sensors generating different types of biological data or the same type of biological data within the single source sensor). In another refinement, the one or more source sensors includes two or more biological sensors. In some variations, the one or more source sensors can include one or more sub-source sensors that gather non-animal data. In another refinement, a single source sensor includes two or more sensors, at least one of which gathers animal data and at least one of which gathers non-animal data. In another variation, the one or more source sensors generate at least a portion of non-animal data. In another refinement, at least one of the one or more source sensors gathers at least a portion of non-animal data (e.g., which may be standalone or included as one or more sub-sensors within a single sensor or sensing system collecting animal data). In another refinement, one or more source sensors are included within multiple source sensors.

In a refinement, the system can be configured to communicate with each of the one or more sub-sensors that comprise the sensor, or a subset of sub-sensors that comprise the sensor. In another refinement, the system can be configured to communicate with the sensor and each of the one or more sub-sensors that comprise the sensor independently or collectively, or communicate with the sensor and a subset of sub-sensors that comprise the sensor (e.g., with the communication to the sensor and the subset occurring independently or collectively by the system).

Characteristically, the animal data 14^{j} is transmitted electronically with either a wired or wireless connection, or a combination thereof, to collecting computing device 18. In a refinement, the data can be transferred from the one or more sensors 12 to collecting computing device 18 directly, via a cloud server, via a computing device local to the targeted individual, via an intermediary server that mediates the sending of animal data 14^{j} to collecting computing device 18, or a combination thereof. In another refinement, at least a portion of animal data 14^{j} is transferred via a wireless network such as the Internet. In some variations, collecting computing device 18 may also include a transmission subsystem that enables electronic communication with one or more source sensors 12ⁱ to collect animal data 14^{j}. In this variation, collecting computing device 18 receives and collects the animal data 14^{j} via the transmission subsystem. Typically, the transmission subsystem includes a transmitter and a receiver, or a combination thereof (e.g., transceiver). The transmission subsystem can include one or more receivers, transmitters and/or transceivers having a single antenna or multiple antennas (e.g., which may be configured as part of a mesh network to operate as part a system). In some variations, the transmission subsystem can include one or more receivers, transmitters, transceivers, and/or supporting components (e.g., dongle) that utilize a single antenna or multiple antennas, which may be configured as part of a mesh network and/or utilized as part of an antenna array. The transmission subsystem and/or its one or more components may be housed within the one or more computing devices or may be external to the computing device (e.g., a dongle connected to the computing device which is comprised of one or more hardware and/or software components that facilitates wireless communication and is part of the transmission subsystem). In a refinement, one or more components of the transmission subsystem and/or one or more of its components are integral to, or included within, the one or more sensors 12ⁱ.

In a variation, the transmission subsystem can communicate electronically with the one or more sensors 12ⁱ from the one or more targeted individuals 16 using one or more wired or wireless methods of communication, or a combination thereof, via one or more communication links. In a variation, the transmission subsystem enables the one or more source sensors 12ⁱ to transmit data wirelessly via one or more transmission (e.g., communication) protocols. In this variation, intelligent monitoring system 10 can utilize any number of communication protocols and conventional wireless networks, including any combination thereof (e.g., BLE and LoRa to create hybrid connectivity for combined short and long-range communication), to communicate with one or more sensors 12ⁱ including, but not limited to, Bluetooth Low Energy (BLE), ZigBee, cellular networks, LoRa/LPWAN, NFC, ultra-wideband, Ant+, WiFi, and the like. Note that the present invention is not limited to any type of technology or electronic communication links (e.g., radio signals) the one or more sensors 12ⁱ or any other computing device utilized to transmit and/or receive signals. Advantageously, the transmission subsystem can be configured to enable the one or more sensors 12ⁱ to transmit data (e.g., wirelessly) for real-time or near real-time communication, as well as receive commands when configured to exhibit such functionality. In this context, near real-time means that the transmission is not purposely delayed except for necessary processing by the sensor and any other computing device taking one or more actions on, with, or related to the data. In a refinement, one or more apparatus with one or more onboarded computing devices (e.g., such as an aerial apparatus like an unmanned aerial vehicle or other remote computing device) can be configured to operate as a transmission subsystem to collect and distribute animal data gathered from one or more sensors from one or more targeted subjects or groups of targeted subjects. In a variation, the one or more apparatus can have one or more sensors attached, or integrated, as part of the apparatus to collect animal data. In another refinement, collecting computing device 18 can be configured to gather animal data 14 from one or more source sensors 12ⁱ directly via a wired connection. In another refinement, collecting computing device 18 can be configured to gather animal data 14 from a combination of wired and wireless connections via one or more source sensors 12ⁱ. In another refinement, the transmission subsystem can be comprised of multiple transmission subsystems. In another refinement, the transmission subsystem is a computing device.

In a refinement, the system can be configured to transmit one or more commands to the one or more sensors in order to enable the one or more sensors to utilize two or more transmission protocols (e.g., BLE and LoRa) to create a hybrid connectivity in order to transmit data. For example, the system may need to provide collected animal data to multiple endpoints, some of which may be short distances away from the computing device and some of which may be long distances away from the computing device. In this scenario, the system and sensor can be configured to achieve optimal data transmission performance by combining the usage of two or more transmission protocols (e.g., BLE and LoRa) in order communicate with the system. In this example, BLE can be utilized to send large data files over shorter distances and LoRa can be utilized to send smaller data packets over longer distances. The usage of both transmission protocols by one or more sensors enables optimal data distribution to the collecting computing device and associated computing devices in communication with the collecting computing device (e.g., the computing subsystem) in both short and long-distance scenarios. In a refinement, the system can be configured to make one or more calculations, computations, estimations, evaluations, inferences, determinations, deductions, or observations related to one or more characteristics of the one or more sensors (e.g., including its one or more parameters) including, but not limited to, the volume of data to send, the type of data to send, how often to send data, where to send data, from which sensor(s) to send data, any modifications to one or more parameters related to the sensor (e.g., sampling rate, storage parameters, whether to record data on the sensor or not) based upon the transmission protocol being used, and the like. For example, if the system determines that the sensor is communicating in close range with a computing device, it may utilize BLE-based transmission in order to send more data to the system. If the system determines that the sensor is communicating at a longer range with a computing device, the system may change one or more sensor settings in order to reduce the amount of data being collected and/or sent, and change the transmission mechanism (e.g., from BLE to LoRa) in order to provide the data to the computing device. In another refinement, the system automatically selects the transmission protocol being utilized by evaluating at least one of: data volume, data type, data frequency (e.g., how often to send data), data storage (e.g., whether to store data; where to store data; how much data to store), data requirements (e.g., by the receiving computing device), distance from sensor to the computing device, and the like. In another refinement, one or more of the sensors are operable to utilize two or more transmission protocols simultaneously, concurrently, or a combination thereof.

Still referring to FIG. 1, collecting computing device 18 includes an operating system that coordinates interactions between one or more types of hardware and software. Collecting computing device 18 can be comprised of a single computing device or multiple computing devices as part of one or more systems. A system can be one or more sets of one or more interrelated or interacting components which work together towards achieving one or more common goals or producing one or more desired outputs. The one or more components of a system can include one or more applications (e.g., native, web browser-based, and the like), frameworks, platforms or other subsystems, which may be integral to the system or separate from the system but part of a network or multiple networks linked with the system and operable to achieve the one or more common goals or produce the one or more desired outputs. In a refinement, collecting computing device 18 incudes a plurality of collecting computing devices 18. Collecting computing device 18 can also be configured to utilize one or more network connections, such as an internet connection or cellular network connection or other network connection (e.g., wired, wireless, or a combination thereof), which may include hardware and software aspects, or pre-loaded hardware and software aspects that do not necessitate an internet connection. Collecting computing device 18 can be operable for wired communication, wireless communication, or a combination thereof.

Still referring to FIG. 1, collecting computing device 18 can be configured to receive animal data or groups of animal data from a single targeted individual or multiple targeted individuals as raw or processed (e.g., manipulated) animal data from a single sensor or multiple sensors. In a refinement, collecting computing device 18 can be operable to receive a single type of animal data (e.g., heart rate data) and/or multiple types (e.g., including groups/data sets) of animal data (e.g., raw analog front end data, heart rate data, muscle activity data, accelerometer data, hydration data) from a single sensor and/or multiple sensors derived from a single targeted individual and/or multiple targeted individuals.

Collecting computing device 18 can also gather contextual data from one or more sensors 12, one or more other sensors, one or more programs operating via collecting computing device 18 (e.g., if the contextual data is manually entered or gathered), one or more programs operating via one or more other computing devices, or a combination thereof. Contextual data can include any set of data that describes and provides information about other data, including data that provides context for other data (e.g., the activity a targeted individual is engaged in while the animal data is collected, the outcome of the activity the targeted subject is engaged in, animal data to provide context for other animal data). Contextual data can be animal data, non-animal data, or a combination thereof. Upon being gathered by collecting computing device 18, the collecting computing device can be configured to take one or more actions with the contextual data to enable the collecting computing to utilize such data as context for animal data, the one or more actions including at least one of: normalize, timestamp, aggregate, tag, store, manipulate, denoise, process, enhance, format, organize, visualize, simulate, anonymize, synthesize, summarize, replicate, productize, compare, price, or synchronize the data. In a refinement, upon being gathered by collecting computing device 18, contextual data can be assigned as reference data.

In a refinement, contextual data can be characterized as metadata associated with the animal data, or other information gathered, and vice versa (i.e., metadata can be characterized as contextual data). In many variations, animal data 14 collected by collecting computing device 18 can include or have attached thereto metadata, which can include one or more characteristics directly or indirectly related to the animal data, including characteristics related to the one or more sensors (e.g., identity of the sensor, sensor type, sensor brand, sensing type, sensor model, firmware information, sensor positioning on or related to a subject, sensor operating parameters, sensor configurations, sensor properties, sampling rate, mode of operation, data range, gain, battery life, shelf life/number of times the sensor has been used, timestamps, and the like), characteristics of the one or more targeted individuals, origination of the animal data (e.g., event, activity, or situation in which the animal data was collected, duration of data collection period, quality of data, when the data was collected), type of animal data, source computing device of the animal data, data format, algorithms used, quality of the animal data, quality of data, size/volume/quantity of the data, latency information/requirements, speed at which the animal data is provided, environmental condition, bodily condition, and the like. Metadata can also be associated with the animal data after it is collected. Metadata can include non-animal data, animal data, or a combination thereof. Metadata can also include one or more attributes directly or indirectly related to the one or more targeted individuals. Characteristically, metadata can provide context for animal data in the creation or modification of the at least evaluation indicator. Metadata can also provide information that directs the system in its access, creation, or modification of reference data.

In a refinement, contextual data is metadata (and vice versa) associated with the animal data, the one or more targeted subjects, the one or more sensors (e.g., including one or more components associated with the one or more sensors), the one or more events associated with the one or more targeted subjects, or a combination thereof. In another refinement, contextual data is data derived from one or more Artificial Intelligence techniques that provides context to other data. In another refinement, contextual data includes one or more terms (e.g., user preferences, rules, conditions, permissions, conditions, rights, and the like) associated with the animal data (e.g., one or more uses of the animal data) established by the data owner/provider, data acquirer, one or more previous agreements associated with animal data (e.g., including current or future animal data being collected, with one or more terms for the current or future animal data accessible via one or more digital records), or a combination thereof.

In a variation, the system can be configured to create, modify, or enhance one or more tags based upon the metadata associated with, or the contextual data related to (if different), the animal data (e.g., including contextual information and other metadata), the one or more targeted subjects, the one or more sensors, the one or more events associated with the one or more targeted subjects, or a combination thereof. Tags (e.g., including classifications or groups that a targeted subject can be assigned to such as basketball team, individuals with a specific type of disease or blood type, and the like, or classifications or groups that medical conditions associated with the targeted individual can be assigned to) can be identifiers for data, can support the indexing and search process for one or more computing devices or data acquirers (e.g., tags can simplify the search process as one or more searchable tags), can support the creation of, modification of, or access to, one or more commands that configure the one or more sensors or their associated operating parameters, can support the monetary valuation process for one or more data sets, and can be based on data collection processes, practices, quality, or associations, as well as targeted individual characteristics. A characteristic can include personal attributes or personal characteristics of the one or more subjects or groups of subjects from which the animal data is derived (e.g., name, weight, height, corresponding identification or reference number, medical history, personal history, health history, medical condition, biological response, and the like), as well as information related to the animal data (e.g., including the animal data itself and its one or more derivatives which describe a feature or attribute of a targeted individual), its associated metadata, and the one or more sources of the animal data such as sensor type, sensor model, sensor brand, firmware information, sensor positioning, timestamps, sensor properties, classifications, specific sensor configurations, operating parameters (e.g., sampling rate, mode, gain, sensing type), mode of operation, data range, location, data format, type of data, algorithms used, size/volume/quantity of the data, analytics applied to the animal data, data value (e.g., actual, perceived, future, expected), when the data was collected, associated organization, associated activity, associated event (e.g., simulated, real world), latency information (e.g., speed at which the data is provided), environmental condition (e.g. if the data was collected in a dangerous condition/environment, rare or desired condition/environment, and the like), bodily condition (e.g., if a person has stage 4 pancreatic cancer or other bodily condition), context (e.g., data includes a monumental moment/occasion, such as achievement of a threshold or milestone within the data collection period may make the data more valuable; time of day in which the data set is collected), duration of data collection period, quality of data (e.g., a rating or other indices applied to the data, completeness of a data set, noise levels within a data set, data format), missing data, monetary considerations (e.g., cost to create or acquire, clean, and/or structure the animal data; value assigned to the data), non-monetary considerations (e.g., how much effort and time it took to create or acquire the data), and the like. It should be appreciated that characteristics related to animal data (e.g., characteristics related to the data, the one or more sensors, the metadata, the one or more targeted subjects, the one or more medical conditions, the one or more biological responses, and the like) can be assigned or associated as contextual data, which can include one or more tags. Characteristically, the one or more tags associated with the animal data can contribute to creating, modifying, or enhancing an associated value (e.g., monetary, non-monetary) for the animal data, as well as creating or modifying the at least one evaluation indicator. In a refinement, one or more Artificial Intelligence techniques (e.g., Machine Learning, one or more neural networks, Statistical Learning) are utilized to assign, create, modify, remove, or a combination thereof, one or more tags related to the animal data (e.g., including its metadata), the one or more targeted subjects, the one or more source sensors, the one or more events associated with the one or more targeted subjects, or a combination thereof. In another refinement, the collecting computing device verifies the one or more tags associated with the targeted individual, the one or more source sensors, the animal data (e.g., including its metadata), the one or more events associated with the one or more targeted subjects, or a combination thereof. In another refinement, one or more tags are created, modified, or enhanced for reference animal data based upon reference contextual data.

In a refinement, a targeted individual's one or more characteristics/attributes (e.g., from which contextual data can be derived) can include name, age, weight, height, birth date, race, eye color, skin color, hair color (if any), country of origin, country of birth (if different), area of origin, ethnicity, current residence, addresses, phone number, reference identification (e.g., social security number, national ID number, digital identification), gender of the targeted individual from which the animal data originated, data quality assessment, information (e.g., animal data) gathered from medication history, medical history, medical records, health records, genetic-derived data, genomic-derived data (e.g., including information related to one or more medical conditions, traits, health risks, inherited conditions, drug responses, DNA sequences, protein sequences, and structures), biological fluid-derived data (e.g., blood type), drug/prescription records, allergies, family history, health history (including mental health history), manually-inputted personal data, physical shape (e.g. body shape), historical personal data, training regimen, nutritional history/nutrition regime (e.g., what foods are ingested, timing/quantity of ingestion, food allergies), one or more preferences associated with collection, transformation, distribution and/or use of the animal data (e.g., terms, conditions, permissions, restrictions, requirements, requests, rights, and the like associated with their animal data by the individual, data acquirer, other data owner, licensee/licensor, administrator, or the like), and the like. The targeted individual's one or more attributes can also include one or more activities the targeted individual is engaged in while the animal data is collected, one or more associated groups (e.g., if the individual is part of a sports team, or assigned to a classification based on one or more medical conditions), one or more habits (e.g., tobacco use, alcohol consumption, exercise habits, nutritional diet, the like), education records, criminal records, financial information (e.g., bank records, such as bank account instructions, checking account numbers, savings account numbers, credit score, net worth, transactional data), social data (e.g., social media accounts, social media history, social media content, records, internet search data, social media profiles, metaverse profiles, metaverse activities/history), employment history, marital history, relatives or kin history (in the case the targeted subject has one or more children parents, siblings, and the like), relatives or kin medical history, relatives or kin health history, manually inputted personal data (e.g., one or more locations where a targeted individual has lived, emotional feelings, mental health data, preferences), historical personal data, and/or any other individual-generated data (e.g., including data about or related to the individual). In a refinement, one or more characteristics/attributes associated with another one or more subjects can be associated with one or more targeted individuals as metadata. For example, in the event the targeted individual has children, the subject's (i.e., child's) health condition can be associated with the one or more targeted individuals as a characteristic associated with the one or more targeted individuals' data (e.g., if the child is sick, the parent can be under considerable stress or have deteriorating mental health which may impact their animal data). In another example, the one or more characteristics/attributes of the targeted individual's avatar or representation in a digital environment, video game, or other simulation (e.g., including their actions, experiences, conditions, preferences, habits, and the like) can be associated with the targeted individual as metadata and can be included as part of the targeted individual's animal data. In another refinement, animal data is inclusive of the targeted individual's one or more characteristics/attributes (i.e., the one or more characteristics/attributes can be categorized as animal data). In another refinement, at least a portion of gathered data can be classified as both animal data and metadata. In another refinement, the system may associate metadata with one or more types of animal data prior to its collection (e.g., the system may collect one or more attributes related to the targeted individual prior to the system collecting animal data and associate the one or more attributes in the targeted individual's profile to the one or more types of animal data prior to its collection).

In the context of a sporting event, contextual data in can include, but are not limited to, event data such as traditional sports statistics collected during an event (e.g., any given outcome data, including game score, set score, match score, individual quarter score, halftime score, final score, points, rebounds, assists, shots, goals, pass accuracy, touchdowns, minutes played, and other similar traditional statistics), in-game data (e.g., whether the player is on-court vs off-court, whether the player is playing offense vs defense, whether the player has the ball vs not having the ball, the player's location on the court/field at any given time, specific on-court/field movements at any given time, who the player is guarding on defense, who is guarding the player on offense, ball speed, ball location, exit velocity, spin rate, launch angle), streaks (e.g., consecutive points won vs lost; consecutive matches won vs lost; consecutive shots made vs missed), competition (e.g., men, women, other), round of competition (e.g., quarterfinal, finals), matchup (e.g., player A vs. player B; team A vs team B), opponent information, type of event (e.g., exhibition vs real competition), date, time, location (e.g., specific court, arena, field, and the like), crowd size, crowd noise levels, prize money amount, number of years associated with the event (e.g., number of years a player has been playing within a specific league or with a specific team), ranking or standing/seeding, the type of sport, level of sport (professional vs amateur), career statistics (e.g., in the case of individual athletes in racquet sports as an example, number of: tournaments played, titles, matches played, matches won, matches lost, games played, games won, games lost, sets, sets won, sets lost, points played, points won, points lost, retirements, and the like), points won vs. points played, games (e.g., sets) won vs. games played, matches won vs. matches played, any given round rate (e.g., finals win/loss rate or semi-finals win/loss rate; number of times a player makes any given round in any given tournament (e.g., number of times a player makes the semifinals in any given tournament can be on a yearly or career basis), title win rate (e.g., how many times the player has won this year or any given year or over a career; how many times a player has won that particular tournament), match retirement history, court surface (e.g., hard court vs clay court), and the like. Contextual data can also include information such as historical animal data/reference animal data (e.g., outcomes that happened which are cross referenced with what was happening with the athlete's body and factors surrounding it such as their heart rate and HRV data, body temperature data, distance covered/run data for a given point/game/match, positional data, biological fluid readings, hydration levels, muscle fatigue data, respiration rate data, any relevant baseline data, an athlete's biological data sets against any given team, who the player guarded in any given game, who guarded the player in any given game, the player's biological readings guarding any given player, the player's biological readings being guarded by any given player, minutes played, court/ground surface, the player's biological readings playing against any given offense or defense, minutes played, on-court locations and movements for any given game, other in-game data), comparative data to similar and dissimilar players in similar and dissimilar situations (e.g., other player stats when guarding or being guarded by a specific player, playing against a specific team) injury data (e.g., including injury history), recovery data (e.g., sleep data, rehabilitation data), training data (e.g., how the player performed in training in the days or weeks leading up to a game), nutrition data, a player's self-assessment data (e.g., how they're feeling physically, mentally, or emotionally), nutritional data, mental health data, and the like. It can also include information such as country of origin, height, weight, dominant hand or handedness (e.g., right hand dominant vs left hand dominant), residence, equipment manufacturer, coach, race, nationality, habits, activities, genomic information, genetic information, medical history, family history, medication history, and the like. Contextual information can also be scenario-specific. For example, in the sport of tennis, contextual information can be related to when a player is winning 2-0 or 2-1 in sets or losing 1-2 or 0-2 in sets, or the time of day the player is playing, or the specific weather conditions the game is played in. Contextual information can also be related to head-to-head matchups. In the sport of squash, for example, head-to-head information can be related to the number of head-to-head matches, games, the number of times a player has been in a specific scenario vs the other player (e.g., in terms of game score: 3-0, 3-1, 3-2, 2-3, 1-3, 0-3, 2-0, 2-1, 1-2, 0-2, or retired). Contextual information can also include how that player has performed in that particular tournament (e.g., matches played, matches won, games played, games won/lost, sets played, sets won/lost, court time per match, total court time, previous scores and opponents, and the like). Characteristically, the system can be configured to evaluate a single type of data or a plurality of data (e.g., data types, data sets) simultaneously. For example, in the context of a sport like tennis, the system may evaluate multiple sources of data and data types simultaneously utilizing one or more Artificial Intelligence techniques such as sensor-based animal data readings (e.g., positional data, location data, distance run, physiological data readings, biological fluid data readings, biomechanical movement data), non-animal data sensor data (e.g., humidity, elevation, and temperature for current conditions; humidity, elevation, and temperature for previous match conditions), length of points, player positioning on court, opponent, opponent's performance in specific environmental conditions, winning percentage against opponent, winning % against opponent in similar environmental conditions, current match statistics, historical match statistics based on performance trends in the match, head-to-head win/loss ratio, previous win/loss record, ranking, a player's performance in the tournament in previous years, a player's performance on court surface (e.g., grass, hard court, clay), length of a player's previous matches, current match status of a tennis player (e.g., athlete A is in Game 3 of Set 1 aand is losing 5-2) and their historical data in the context of the current match status (e.g., all of athlete A match results when athlete A is in Game 3 of Set 1 and is losing 5-2, first serve percentage in second sets after playing n number of minutes, unforced errors percentage on the backhand side after hitting three n topspin backhands), and the like, which can occur in conjunction with contextual data such as video data (e.g., one or more optical cameras generating one or more video feeds of the event which feature the one or more individuals) and other information (e.g., contextual data such as timing & scoring data and other statistical information). In a refinement, any contextual data related to an event (either directly or indirectly) can be categorized as event data for (or associated with) the event. In another refinement, contextual data is inclusive of event data. In another refinement, event data is comprised of any contextual data associated either directly or indirectly with the event. In another refinement, event data includes at least a portion of contextual data.

It should be appreciated that such examples of contextual data, including contextual data in the context of a sports competition/event, are merely exemplary and not exhaustive, and similar types of information can be collected for all sports and events. In the context of non-sporting events, similar types of contextual data and methodologies can be utilized. In a refinement, contextual data in the context of non-sports related events can also include outcome-related information that may or may not provide context to other data. In a refinement, the at least one variable is contextual data. In another refinement, contextual data includes the at least one variable. In another refinement, at least a portion of contextual data is created, gathered, or observed (e.g., which includes “identified”) by the system as one or more variables (i.e., the at least one variable), the at least a portion of contextual data inducing the collecting computing device or other computing device in communication with the collecting computing device to automatically initiate one or more actions to create, modify, access, or a combination thereof, at least one evaluation indicator. For example, in the context of a sporting event, contextual data such as the score in a game/match, a biological response exhibited by an athlete, the environmental temperature, the amount of time left in the game, and the like can each be a variable—or a subset of variables—from which an evaluation indicator is created, modified, or accessed.

Still referring to FIG. 1, collecting computing device 18 is in electronic communication with the one or more source sensors. Communication can be wired, wireless, or a combination thereof. Communication can be direct (e.g., collecting computing device 18 communicating directly with the one or more source sensors) or indirect (e.g., collecting computing device 18 communicating with the one or more source sensors via cloud server 20 or another computing device). In some variations, collecting computing device 18 can be operable to manage the one or more source sensors (e.g., including the one or more functionalities associated with each or a subset of the one or more sensors or sub-sensors), the one or more individuals associated with the one or more sensors, and the one or more data streams from the one or more source sensors. In a refinement, the management and/or administration of a sensor can include functionality such as scanning for, and pairing, one or more sensors with the system (e.g., which can occur automatically), connecting the sensor to the system, assigning one or more sensors (if required) to one or more individuals within the system, assigning the one or more sensors and/or individuals to an organization or event, verifying the one or more source sensors are placed correctly on the subject, verifying the one or more source sensors are streaming or gathering desired data once applied on subject, setting and verifying one or more thresholds, ranges, or programs for one or more sensor functionalities, gathering data associated with one or more digital records associated with the one or more individuals, the one or more sensors, or a combination thereof, and the like. It can also include functionality to control one or more sensor parameters, support continuous, intermittent, and/or periodic collection of data from the one or more sensors to the system, including an auto-reconnect function when the one or more sensors disconnect or when a lapse in streaming occurs, and the real-time or near real-time streaming of the one or more sensors. In some variations, the system can be configured provide one or more alerts based on one or more sensor characteristics or functionalities such as sensor disconnection, sensor failure (including battery failure), sensor degradation (e.g., producing a quality of data that does not meet a minimum established standard or threshold), one or more sensor functionalities (e.g., discharge of fluids, such as an alert when a bag of fluid is near empty; stimulation alerts), storage limits, threshold or range limits, one or more checks and balances related to data quality, accuracy, repeatability, and reliability, and the like. In a refinement, the collecting computing device is operable to gather information from the one or more source sensors by communicating directly with the one or more source sensors, its associated cloud server, an application (e.g., native, web browser-based, hybrid) associated with the one or more source sensors, or other computing device that has received information from the one or more source sensors. In another refinement, the collecting computing device is operable to send one or more commands to the one or more sensors to change one or more sensor parameters (e.g., which include settings, configurations, and the like). In some variations, the system can be configured to send one or more commands to the one or more sensors (e.g., including a plurality of sensors or multiple sensors within one or more sensors) simultaneously or concurrently. For example, such commands can cause an individual source sensor to be turned on or off, to be paired with the system, to initiate a battery savings mode for energy saving, to start or stop (e.g., including pause) streaming, record data, save data, store data, erase data, to increase or decrease the amount of data throughput to accommodate the bandwidth available for streaming, to adjust the one or more outputs of the one or more sensors (e.g., flow rate, delivery rate, starting rate, starting volume, and the like for an infusion pump), and the like. As another example, such commands can increase or decrease the data collection frequency of, sensor sensitivity gain of, audio volume of, data resolution of, and amount of storage being utilized by, the at least one source sensor. In another refinement, collecting computing device 18 is operable to communicate with a plurality of source sensors on a targeted individual or one or more source sensors on multiple targeted individuals simultaneously. In another refinement, collecting computing device 18 synchronizes communication and the information derived from each of the one or more sensors (e.g., one or more data signals or readings) that are in electronic communication with the collecting computing device. This includes the one or more commands sent from the at least one sensor to the system, which may include examples such as a pre-streaming handshake between the sensor and the system to ensure the reliability of both parties, as well as encryption protocols. It also includes synchronization challenges with the one or more data signals or readings. As an example, there may be a mismatch in the timings utilized by each sensor. A sensor's output received by the computing subsystem may be different (for example, by milliseconds) than another sensor even if received by the computing subsystem at the same time. Therefore, the collecting computing device can be configured to synchronize the data streams to ensure that both streams are aligned. In some variations, the system is operable to save one or more preferences for one or more users. In a refinement, the one or more preferences includes one or more sensor parameters (e.g., settings).

Still referring to FIG. 1, collecting computing device 18 can include cloud server 20. In addition to collecting computing device, cloud server 20 can be operable to communicate either directly or indirectly with one or more computing devices, sensors, or a combination thereof. It should be appreciated that both collecting computing device 18 and cloud server 20 can include a single computer server or a plurality of interacting computer servers. In this regard, collecting computing device 18 and cloud server 20 can communicate with one or more other systems—including each other—to monitor the one or more individuals via the one or more sensors, including all data collection, acquisition, and/or distribution requests related to the animal data (e.g., by a third party system; by one or more requirements). In a refinement, cloud Server 20 is operable to take on one or more of the functionalities of collecting computing device 18.

Cloud server 20 can be one or more servers that are accessible via the internet or other network. Cloud server 20 can be a public cloud, a hybrid cloud, a private cloud utilized in conjunction with collecting computing device 18, a localized or networked server/storage, localized storage device (e.g., n terabyte external hard drive or media storage card), or distributed network of computing devices. In a refinement, cloud server 20 includes multiple cloud servers 20. In another refinement, cloud server 20 is associated with collecting computing device 18 and operating as part of the same system or within the same network as collecting computing device 18. In another refinement, cloud server 20 is operable to take one or more actions on behalf of collecting computing device 18 (e.g., including creating or modifying one or more evaluation indicators; taking on one or more functionalities of collecting computing device 18; and the like). In another refinement, reference data is accessed by collecting computing device 18 via cloud server 20 or other computing device in communication with the system. In another refinement, reference data is accessed by cloud server 20 via collecting computing device 18 or other computing device in communication with the system. FIG. 1 also shows that a computing device 22 can be local to the individual communicating with the sensor and optionally with collecting computing device 18. Similarly, a sensor can be wired to or in direct wireless communication with a sensor (e.g., a respirator).

In a refinement, collecting computing device 18 is operable for two-way communication with the one or more source sensors as depicted by connections 24 and 26 where the system can receive data from the one or more source sensors and send one or more commands to the one or more source sensors. In this regard, the collecting computing device is operable to create one or more commands that can be accepted (e.g., received, read) by the sensor, and the sensor is operable to accept (e.g., receive, read) the one or more commands. For example, the system may send one or more commands to the one or more sensors to change one or more parameters (e.g., functionalities) of a sensor (e.g., change the gain, power mode, or sampling rate, start/stop streaming, update the firmware). In some cases, a sensor may have multiple sensors within a device (e.g., accelerometer, gyroscope, ECG, etc.) which can be controlled (e.g., each, subset, collectively) by the system. This includes one or more sensors being turned on or off, and increasing or decreasing sampling frequency or sensitivity gain. The system can be configured to control any number of sensors, any number of functionalities, and stream any number of sensors on any number of targeted individuals through the single system. Advantageously, the system's ability to communicate with the one or more sensors can enable real-time or near real-time collection of the sensor data from the one or more sensors to the system. In another refinement, at least one of the one or more source sensors provide animal data to at least one computing device (e.g., collecting computing device 18) when the selection and enablement (e.g., activation) of the one or more source sensors to provide animal data to the one or more computing devices occurs. The gathered animal data (e.g., including inputted, imported, collected) can be collected either directly via collecting computing device 18 or indirectly (e.g., via cloud server 20 or another computing device). In a refinement, collecting computing device 18 is configured to communicate (e.g., intelligently) with one or more computing devices. In another refinement, the one or more commands are transmitted (e.g., intelligently) by collecting computing device 18 to one or more computing devices or one or more sensors, which in turn communicate the one or more commands to the one or more source sensors.

In addition to gathering animal data, intelligent monitoring system 10 can be configured to create or modify one or more computed assets, predictive indicators, insights, evaluation indicators, or a combination thereof. The creation or modification of the one or more computed assets, predictive indicators, insights, evaluation indicators, or a combination thereof, can occur via collecting computing device 18, cloud sever 20, one or more other computing devices in communication in communication with collecting computing device 18 or cloud server 20, or a combination thereof. In a refinement, collecting computing device 18 or cloud 20 can be configured to gather one or more computed assets, predictive indicators, insights, or evaluation indicators from one or more source sensors, other computing devices, or each other.

In a refinement, collecting computing device 18 can include one or more display devices 30 operable to display at least a portion of the animal data readings, information related to the one or more source sensors, information related to the one or more sensor parameters, information related to contextual data, information related to the at least one variable, or a combination thereof. Typically, a display device communicates information in visual form, and allows for two-way communication (e.g., the display device can provide information to a user; the display enables a subject to take one or more actions via the display; the display device can provide an ability for the user to communicate information with the system, such as an ability for a user to provide one or more inputs to operate the program, provide requested information to the system, and the like). in some variations, a display device can be configured to communicate information to a user, and receive information from a user, utilizing one or more other mechanisms including via an audio or aural format (e.g., verbal communication of information), via a physical gesture (e.g., a physical vibration which provides information related to the one or more biological readings, a physical vibration which indicates when the data collection period is complete, or a physical gesture to induce a biological-based response from the individual's body can be captured as animal data via one or more sensors), or a combination thereof. In some variations, the display device enables a user to take one or more actions within the display or includes one or more components that enables a user to take one or more actions (e.g., touch-screen enabling an action; use of a scroll mouse or selection device that enables the user to navigate and make selections, such as selecting sensors or sensor parameters; voice-controlled action via a virtual assistant or other system that enables voice-controlled functionality; eye-tracking within spatial computing systems that enables an eye-controlled action; a neural control unit that enables one or more controls based upon brain waves; and the like). In a refinement, a gesture controller that enables limb (e.g., hand) or body movements to indicate an action may be utilized to take one or more actions. In another refinement, the display may act as an intermediary computing device to communicate with another one or more computing devices to execute the one or more actions requested by a user. In another refinement, the display may not include any visual component in its communication or receipt of information (e.g., as in the case of a smart speaker, hearables, or similar computing device that does not include any visual screen to interact with and is operable via a virtual or audio-based assistant to receive one or more commands and take one or more actions. In this example, the smart speaker or hearables can be in communication with another computing device to visualize information via another display if required). In some variations, the information communicated to a user (e.g., targeted individual, administrator, data acquirer, and the like) may be animal data-based information such as the type of animal data, activity associated with the animal data or other metadata (e.g., contextual data), insights or predictive indicators, and the like. For example, the display device may not communicate the signals or readings associated with the animal data for the user to interact with but may communicate the type of animal data (e.g., the display may not provide a user's actual heart rate values but may display the term “heart rate” or “HR” or a symbol related to heart rate-such as a heart-which the user can select and define terms related to their heart rate data). In a refinement, display device 30 communicates information in an animal and/or machine-readable or interpretable format. In another refinement, display device 30 is operable to take one or more actions on behalf of collecting computing device 18 or cloud server 20 (e.g., including taking on one or more of the functionalities of collecting computing device 18 and/or cloud server 20).

In a variation, display device 30 can include a plurality of display devices that comprise the display. In addition, a display that is not included as part of collecting computing device 18 may be in communication with collecting computing device 18 (e.g., attached or connected to, from which communication occurs either via wired communication or wirelessly; as a separate computing device from collecting computing device 18 but in communication with the system). Furthermore, the display device may take one or more forms. Examples of where one or more types of animal data may be displayed include via one or more monitors (e.g., via a desktop or laptop computer, projector; a screen attached to one or more sensors or integrated with one or more computing devices that include one or more sensors), holography-based computing devices, smart phone, tablet, a smart watch or other wearable with an attached or associated display, smart speakers (e.g., including earbuds/hearables), smart contact lens, smart clothing, smart accessories (e.g., headband, wristband), or within a head-mountable unit (e.g., smart glasses or other eyewear/headwear including virtual reality/augmented reality headwear) where the animal data (e.g., signals/readings, insight, predictive indicator, and the like) or other animal data-related information can be visualized or communicated. In another refinement, the display may include one or more other media streams (e.g., live-stream video, highlight clips, one or more digital objects), which in some variations may also incorporate the animal data (e.g., video with live stream animal data). In a refinement, the display operates an application that provides one or more fields for a user to make one or more selections (e.g., provide one or more inputs) related to the one or more sensors (e.g., including their one or more parameters), the one or more targeted individuals, the one or more use cases or requirements associated with the one or more targeted individuals, and the like. In a variation, the one or more fields that enable one or more inputs can provide the system with one or more preferences of the targeted individual related to the use of their data.

Advantageously, collecting computing device 18 is operable (e.g., configured) to utilize one or more Artificial Intelligence techniques to intelligently gather the animal data from the one or more source sensors and intelligently transmit one or more commands either directly or indirectly to the one or more source sensors 12 to create or modify one or more sensor operating parameters, initiate the implementation of one or more sensor operating parameters, or a combination thereof. The gathering of data can include one or more evaluations or determinations (e.g., via the at least one evaluation indicator)—based upon one or more variables—made intelligently (e.g., autonomously, semi-autonomously, dynamically, automatically, semi-automatically, or a combination thereof) by the computing system (e.g., with or without input from one or more other sources such as a user) related to information such as which sensors to stream from, how much data to collect (e.g., continuous vs intermittent; real-time vs not real-time), when to collect the data, what data to collect, one or more operating parameters related to the one or more sensors from which data is being gathered, how the data needs to be used, where to send the data, and the like.

The one or more commands can include both direct commands, indirect commands, or a combination thereof. Direct commands can include direct communication from the collecting computing device to the one or more sensors. Indirect commands can include communication from the collecting computing device to one or more sensors via an intermediary (e.g., another computing device, another sensor, or a combination thereof). Such commands may include one or more instructions to the one or more sensors to change (e.g., modify) to one or more sensor parameters, or initiation (e.g., activation) of one or more sensor parameters, which can be related to one or more data gathering functions (e.g., start/stop streaming, start/stop data collection) for each of the one or more sensors or sub sensors, the frequency of data collection, sampling rate (e.g., how many times per second or minute is data being collected), frequency of data gathering (e.g., how many times does the data get sent to a display device for rendering—in one illustration, heart rate may be sent to the display device for rendering once every second whereas blood pressure once every hour), type of data being gathered, sampling rate of each source sensor (e.g., including sub-source sensors within each sensor), gain of each sensor (or sub sensors), mode of operation, data range, data type, the firmware, power save mode, power on/off mode, one or more actions taken related to the data (e.g., transformative actions), and the like. In a refinement, the collecting computing device is configured to intelligently create, modify, or access one or more commands that provide the one or more instructions to the one or more source sensors to perform the one or more actions

In a refinement, at least one of the one or more source sensors provides animal data to at least one computing device when the selection and enablement of the one or more source sensors to provide animal data to the one or more computing devices occurs. In another refinement, one or more commands can be transmitted to each of the one or more source sensors, a subset of the one or more source sensors (e.g., the same command going to multiple sensors; the same command going to a subset of sensors while another subset of sensors receive different commands; the same command being distributed to a subset of sub-sensors within a sensor while a different command is distributed to another subset of sub-sensors within the same sensor), or all the source sensors via the collecting computing device, cloud server, another computing device in communication (e.g., direct, indirect) with the collecting computing device or cloud server, or a combination thereof. In another refinement, such transmission can occur simultaneously, concurrently, or across other interval periods.

Characteristically, at least one variable or a derivative thereof is created, gathered, identified, or observed by the collecting computing device, cloud server, another computing device in communication with the collecting computing device or cloud server, one or more sensors, or a combination thereof. The at least one variable or its one or more derivatives-which is directly or indirectly related to the one or more source sensors, the one or more targeted individuals, or the animal data in many variations-acts as a source of information to the collecting computing device (e.g., it provides information to the collecting computing device), the information inducing the collecting computing device to create, modify, access, or a combination thereof, at least one evaluation indicator (e.g., with “access” related to the evaluation indicator meaning that a reference evaluation indicator from the reference database is accessed based upon the at least one variable and other information created, gathered or observed by the system to become an evaluation indicator, with the system operable to make one or more modifications to the at least one evaluation indicator to enable the requisite instructions to be provided to the one or more source sensors via one or more commands). The at least one evaluation indicator induces the collecting computing device to create, modify, or access one or more commands (e.g., sensor commands) related to one or more sensor operating parameters (e.g., creating, modifying, setting, or a combination thereof, the one or more sensor operating parameters; enabling or disabling the streaming or collection/provision of animal data from one or more source sensors, and the like) and transmit the one or more commands to the one or more source sensors, which may occur immediately upon the creation, observation, or gathering of the at least one variable by the collecting computing device, over a period of time, or at a future point in time. In a refinement, the at least one variable or its one or more derivatives acts as a source of information to the collecting computing device, the information inducing the collecting computing device to create, modify, or access one or more commands related to one or more sensor operating parameters and transmit the one or more commands to the one or more source sensors, which may occur immediately upon the creation, observation, or gathering of the at least one variable by the collecting computing device, over a period of time, or at a future point in time. In many variations, the one or more commands are provided to the one or more source sensors to at least one of: (1) identify, evaluate, assess, mitigate, prevent, or take one or more risks, (2) to fulfill one or more requirements, obligations, or use cases; (3) to evaluate, assess, or optimize animal data-based performance for a targeted individual or group of targeted individuals; (4) achieve one or more targets; (5) to create, enhance, modify, acquire, offer, or distribute one or more products (e.g., insurance products, sports betting or fantasy sports products, and the like); or (6) enable the use of such data to create monetization opportunities based upon the gathered animal data. The information is derived either directly or indirectly from the at least one variable (i.e., the derived information) and can include animal data, contextual data, other metadata, or a combination thereof. In a refinement, the at least one variable is categorized as contextual data. In another refinement, the at least one variable or its one or more derivatives provide information that enables the system to make one or more recommendations, assessments, or determinations (e.g., via at least one evaluation indicator) related to what steps the system should take in order to execute one or more use cases with one or more sensors and their associated operating parameters, what one or more sensor(s) should be (currently or future) utilized for any given use case, what sensor parameter(s) should be (currently or future) modified based upon the use case, the degree to which the one or more sensor parameter(s) should be (currently or future) modified based upon the use case, and the like.

In a variation, the at least one variable includes at least one of: time (e.g., over a duration of time, when the information is required, duration of the data collection period), animal data (e.g., inputted or gathered animal data; one or more animal data readings or derivatives, which can include a combination of animal data readings to create new animal data readings, new data sets, or combined data sets that enable new information to be derived—e.g., new heart rate-based data sets; computed assets, insights, predictive indicators, and the like), reference data (e.g., reference animal data, other reference data), contextual data, one or more sensor readings (e.g., including achievement of a threshold, limitation, milestone, or the like, within the data collection period; sensor readings that may include at least a portion of non-animal data), data storage thresholds, monetary considerations (e.g., data storage costs, cost thresholds or allotted storage based on cost; monetary considerations which may induce the system to provide one or more commands to one or more sensors, such as the purchase of sensor data for a specific period of time which induces the collecting computing device to begin streaming or stop streaming data from one or more sensors; pricing or monetary target for the animal data), one or more preferences (e.g., terms, conditions, permissions, restrictions, rights, requirements, requests, and the like established by the data provider, data acquirer, or a combination thereof, and associated with the animal data; consent from the data provider, owner, licensee, licensor, administrator, or other controller of data), one or more events, one or more occurrences, latency information (e.g., latency requirements, speed at which data is provided), sensor signal strength (e.g., in some variations, the system can be configured monitor signal strength, particularly real-time or near real-time signal strength), the use case (e.g., the animal data being used as an input to create a real-time or near real-time prediction; the data being used to create a new sports wager; the requisite animal data for any given health evaluation; the requisite animal data for an insurance evaluation), one or more targets (e.g., monetary target, data collection target, threshold target), one or more requirements (e.g., requirements for data collection, one or more inputs (e.g., requirements or obligations that the system is required to fulfill—or established targets—based upon one or more inputs, such as an input to create a real-time wager or prediction, or an input to collect data to fulfill one or more codes such as a CPT code; a user input, a data provider input, a data acquirer input, or the like), power availability (e.g., battery life of the sensor), request by one or more users (e.g., medical professional, insurance company, fitness provider, sports betting operator), sensor type, data type (e.g., raw vs processed data), placement of sensor, body composition of the subject, bodily condition of the subject, one or more medical conditions of the subject, health information of or related to the subject, activity (e.g., activity in which the animal data is collected; subject activity such as physical activity, activity monitored via one or more computing devices, and the like; an activity can also be one or more actions which can include placing one or more bets or wagers, or selecting a fantasy sports line up or team), one or more actions (e.g., by the one or more targeted individuals; by another one or more individuals; associated with the one or more targeted individuals), environmental conditions (e.g. if the data was collected in a dangerous condition, rare or desired condition, and the like), one or more previous sensor readings, quality of data (e.g., a rating or other indices applied to the data, completeness of a data set, noise levels within a data set, whether data is missing), size of the data set (e.g., size of the required data set; size of the data set as to not exceed certain storage thresholds; volume of data collected), system performance (e.g., system speed, system performance issues, restrictions, limitations, availability, and the like), collecting computing device performance (e.g., including restrictions, limitations, availability, and the like), cloud server performance (e.g., including restrictions, limitations, availability, and the like), performance of one or more other computing devices in communication with the system, or a combination thereof. In a refinement, information derived from a combination or two or more variables is utilized to induce the collecting computing device or other computing device in communication with the collecting computing device to automatically initiate one or more actions to create or modify at least one evaluation indicator. In another refinement, the tunable variation in the one or more source sensor parameters act as one or more variables which induces a computing device to create or modify at least one evaluation indicator, from which one or more commands are created, modified, or accessed for one or more other source sensor parameters (e.g., which may be included in the same source sensor or different source sensor). For example, a change in the measurement period for one source sensor can alter the parameters for other source sensors associated with the changed measurement period (e.g., including sub-source sensors). In a refinement, the at least one variable includes one or more derivatives of the at least one variable. In another refinement, the at least one variable can be the one or more parameters (e.g., settings) of the one or more source sensors or their associated one or more computing devices operable to be created, modified, set, or a combination thereof. In another refinement, the at least one variable can be information derived from the transmission subsystem and/or one or more computing devices in communication with (e.g., directly or directly) the one or more source sensors or with the collecting computing device gathering the animal data.

In a refinement, the at least one variable can be an event or occurrence (e.g., biological response) that happens to another one or more individuals. For example, in the case of a sporting event such as a boxing match between boxer A and boxer B whereby one or more source sensors gather animal data from each boxer (e.g., a source sensor is attached to the body of each boxer or an apparatus on the body of the each boxer), the system can be configured to send one or more commands to one or more source sensors on a targeted individual based upon an event or occurrence of the other one or more targeted individuals (e.g., the system turns on/off or fine tunes the one or more source sensors attached to boxer B as soon as the source sensor attached to boxer A detects a punch being thrown by boxer A, or a punch is observed by the system via one or more optical-based camera sensors which can detect the punch via one or more images or sequence of images displayed at a given frequency, such as video). In another example, intelligent monitoring can occur in a sport like cricket whereby data collection from one or more source sensors on a runner's body starts or the frequency of data collection increases as soon as the one or more source sensor(s) attached to the batsman on strike detects one or more tunable thresholds.

In a refinement, the system can include a system and sensor performance tracker based upon the at least one variable and the one or more source sensors with logging and auditing capabilities and configured to generate one or more reports (e.g., on-demand reports), monitor sensor-to-system latency, monitor system speed, create alerts (e.g., real-time or near real-time alerts) for system or sensor performance issues, and monitor other key performance indicators and tunable thresholds related to collection and use of sensor-based data.

In a refinement, the system can be configured to operate as a sensor-based monitoring system (e.g., health monitoring system; remote health monitoring system) whereby an evaluation of one or more variables created, gathered, identified, and/or observed (e.g., changes in sensor readings, alerts initiated based upon sensor readings or changes in the individual's body) automatically initiate the system to modify one or more operating parameters (e.g., adjust the source sensor's sampling rate, frequency, or rate of animal data collection; provide the animal data to another data computing device, or provide access to another computing device), activate or deactivate one or more sensors (e.g., initiate one or more new sensors to obtain additional animal data-based information in response to the at least one variable), or a combination thereof, associated with one or more targeted individuals. Characteristically, the sensor-based monitoring system can be configured to track any sensor-based information, including non-animal data derived from one or more sensors, as well as create or modify sensor parameters for such sensors, as well as activate or deactivate such types of sensors, based upon observation, identification, creation, or gathering of at least one variable. The sensor-based monitoring system can be configured to operate in real-time or near-real-time. The sensor-based monitoring system can be further configured to track a single individual or a plurality of individuals.

In a refinement, the system can be configured to enable a user to create, modify, set, or a combination thereof, one or more monetary targets related to the value of their animal data (e.g., which may be their own animal data, or animal data of another one or more targeted individuals if the user is an administrator; in this example, the user can set a monetary target for animal data derived from a single targeted individual or from a group of targeted individuals) based upon one or more variables (e.g., the specific types of animal data operable to be gathered by the system, the one or more sensors operable to communicate with the system, the one or more permissions or preferences established by the individual related to the type of animal data that can be included as part of the monetary target, the contextual data associated and available with the animal data, and the like). The monetary target initiates the system to evaluate the requisite animal data to achieve the monetary target in light of the one or more variables, create a data collection plan based upon the one or more sensors with the requisite sensor operating parameters to collect the requisite animal data to achieve the monetary target (or dynamically modify a data collection plan if the user modifies the monetary target of if there is a change in the one or more variables, such as a sensor not operating or functioning), and execute the plan to collect the requisite data based upon the one or more sensors and the requisite sensor operating parameters to achieve the monetary target. In another refinement, the system can be configured to transform the collected animal data and associated metadata (e.g., one or more preferences, other contextual data) into one or more digital assets (e.g., digital currency) that can be used to acquire other consideration (e.g., cash, goods, services, and the like).

In a refinement, based upon information derived from the at least one variable, the system takes one or more actions, the one or more actions including one or more modifications (e.g., turns on/off one or more sensors, creates of modifies one or more sensor parameters) to one or more animal data-based sensors, one or more non-animal data-based sensors, one or more computing devices, or a combination thereof. For example, based upon the at least one variable (e.g., the animal data readings of an individual), the system creates, access, modifies, or a combination thereof, one or more evaluation indicators which induces the collecting computing device to automatically change one or more sensor parameters (e.g., the system can adjust the height or incline of a bed based upon the animal data readings). In another example, based upon animal data readings (e.g., a high blood pressure, weight gain), the system can be operable to configure another sensor (e.g., refrigerator) to determine (e.g., via one or more scans or other methods) which foods the individual is low on (or out of stock) that can improve the one or more animal data readings, or to recommend the types of food to improve the one or more animal data readings. In another example, based upon the at least one variable (e.g., one or more animal data readings) and the at least one evaluation indicator, the system initiates another computing device to create one or more personalized meals (e.g., drink) at a given time or on a given schedule (e.g., which can be a tunable parameter) that incorporates one or more ingredients selected based upon the one or more animal data readings to improve the one or more readings (e.g., lose weight, decrease blood pressure or glucose levels). Characteristically, the system initiates the computing device to create one or more personalized meals (e.g., drink) by providing one or more instructions (i.e., via one or more commands) to the one or more sensors associated with the computing device that create, modify, access, or a combination thereof, the meal (at least in part) based upon the evaluation indicator (e.g., the output of the evaluation indicator recommends the combination of ingredients the computing device should include for the meal).

In a refinement, the at least one variable is derived from or combined with, at least in part, contextual data. For example, based upon the individual's age, weight, nutritional habits (e.g., including current nutritional intake), sensor readings, target(s) (e.g., weight loss goals), inputted data (e.g., how the individual feels), and the like, the system can be configured to modify the one or more sensors (e.g., turn on one or more other sensors; change one or more sensor parameters) to obtain information from which the system: (1) derives one or more recommendations (2) identifies, evaluates, assesses, prevents, mitigates, or takes one or more animal data-based risks (e.g., including odds associated with the one or more risks), (3) fulfills one or more requirements, obligations, or plans created for one or more use cases; (4) achieves one or more targets; (5) evaluates, assesses, or optimizes animal data-based performance for a targeted individual or group of targeted individuals (e.g. biological performance, monetary performance), (6) creates, enhances, modifies, acquires, offers, or distributes one or more products, (7) enables identification of one or more monetization opportunities with the gathered data based upon the gathered animal data, or a combination thereof. Characteristically, based upon the one or more recommendations, the one or more risks, the one or more products, the one or more monetization opportunities, the optimization of animal data-based performance, the requirements/obligations/use cases/targets, or a combination thereof, the system can be configured to create or modify one or more sensor parameters, activate or deactivate one or more sensors, or a combination thereof. In this example, the one or more sensors can be one or more animal data-based sensors, one or more non-animal data-based sensors, or a combination thereof. For example, based upon the individual inputting nutrition information (e.g., providing the system what their last meal consisted of), the system can be configured to modify one or more sensors (e.g., turn on a sensor, activate a sensor, modify a sensor setting) to obtain animal data (e.g., one or more animal data readings), non-animal data, or a combination thereof, from which the system can make one or more recommendations (e.g., based upon their recent nutritional intake over a defined period of time such as last n days, the system activates one or more sensors to gather one or more animal data readings, the system being further configured to automatically recommend a nutrition plan or exercise plan which can include the one or more types of food for the individual's next one or more meals based upon the one or more animal data readings, the time period in which they should eat the food, the types of exercises and time of today to exercise based upon the nutrition plan, or the like. In this example, system may activate sensors or modify sensor parameters such as the frequency of data collection to monitor additional animal data readings based upon the initial animal data readings and the contextual data). In another refinement, the system provides one or more alerts to the one or more individuals (e.g., notifications via a display via one or more computing devices or via one or more sensors) related to the one or more risks, the one or more products, the one or more monetization opportunities, the optimization of animal data-based performance, the requirements/obligations/use cases/targets (e.g., fulfillment of such obligations or status updates), or a combination thereof.

In a refinement, the system can be configured to gather information from one or more sensors collecting non-animal data and one or more sensors collecting animal data to (1) make one or more recommendations to the individual or other user, (2) identify, evaluate, assess, prevent, mitigate, or take animal data-based risk, (3) evaluate, assess, or optimize animal data-based performance (e.g. biological performance, monetary performance), (4) fulfill one or more requirements, obligations, or plans created for one or more use cases; (5) achieve one or more targets, (6) create, enhance, modify, acquire, offer, or distribute one or more products, (7) enable identification of one or more monetization opportunities with the gathered data, or a combination thereof. Based upon the system's one or more determinations related to the one or more recommendations, risks, products, monetization opportunities, requirements/obligations/use cases/targets, performance optimization, or a combination thereof, the system can be configured to create or modify one or more sensor parameters for each or a subset of the one or more sensors, activate or deactivate one or more sensors, or a combination thereof. In this example, the one or more sensors can be one or more animal data-based sensors, one or more non-animal data-based sensors, or a combination thereof. For example, the system may be communication with one or more sensors located on a fluid cannister (e.g., bottle) that provides information about its fluid content (e.g., water). The system may further determine based upon the evaluation indicator that the individual is dehydrated based upon the animal data readings (e.g., hydration data) and the amount of fluid that the individual has consumed over n period of time in light of other contextual data, such as activity, environmental temperature, total time of exercise, and the like. The creation or modification of the at least one evaluation indicator enables the system to provide a recommendation (e.g., drink more water based upon the fluid content). The system can be further operable to instruct the one or more sensors to take one or more actions via one or more commands (e.g., modify sensor parameters for each or a subset of source sensors in order to monitor the individual to ensure the individual is not at further risk, such as heat stroke or kidney damage/failure. In this example, the system may create multiple evaluation indicators to as the system monitors the individual to determine a probability of heat stroke or kidney damage/failure, and recommend one or more actions based upon the determined probability).

In a refinement, the derived information from the at least one variable can include one or more changes related to the at least one variable or changes between variables. For example, derived information can include changes between ECG patterns or a combination of animal data readings. In another example, the system may generate a predictive indicator before and after an event, with the evaluation of the difference between the first reading and second reading inducing the system to automatically initiate the creation, modification, or access of one or more commands, as well as the transmission of the one or more commands to the one or more sensors. The at least one variable can include animal data, non-animal, or a combination thereof. In a refinement, a variable comprising the at least one variable (e.g., a variable that is included as part of the one or more variables that comprise the at least one variable) can be comprised of multiple variables within the variable.

In another aspect, collecting computing device 18 automatically takes one or more actions based upon information derived from the at least one variable, which can include a combination of two or more variables in some variations (e.g., animal data readings, time, and activity). A combination of variables can include variables that are categorically similar—for example, two or more different data streams from sub-sensors in the same sensor (e.g., heart rate, ECG, and respiration data from the same sensor) or different sensors.

In a variation, at least a portion of the derived information induces the collecting computing device or another computing device in communication with the collecting computing device to automatically and/or dynamically initiate one or more actions to create or modify at least one evaluation indicator. The one or more actions can include one or more: calculations, computations, derivations, extractions, extrapolations, simulations, creations, combinations, comparisons, modifications, enhancements, estimations, evaluations, inferences, establishments, determinations, conversions, deductions, observations, interpretations, or a combination thereof. In a refinement, automatic and/or dynamic initiation occurs utilizing one or more Artificial Intelligence techniques. In another refinement, the at least one evaluation indicator is created by utilizing two or more variables. For example, the system may utilize reference data (e.g., a subject's baseline animal data) and the subject's real-time sensor readings to determine that a medical episode is potentially occurring, which triggers the system to initiate one or more commands related to the one or more sensors or its readings (e.g., the system initiates new sensors to collect animal data; the system increases the sampling rate of one or more sensors; the system activates an optical sensor to record video or provide two-way video communication—such as through a mobile phone or other computing device—with a medical service or other individual; the system sends the data to a third-party system to alert of the possible medical episode).

In another aspect, the at least one evaluation indicator initiates, preferably automatically and/or dynamically, the collecting computing device to transmit one or more commands to the one or more source sensors, the one or more commands including at least one of: (1) selecting and enabling (e.g., activating) the one or more source sensors to provide animal data (e.g., the providing of animal data can occur in a streaming, intermittent, continuous, and/or point-in-time manner, as well as in a real-time or near real-time capacity in some variations) to one or more computing devices which can include the collecting computing device; (2) selecting and creating, modifying, setting, or a combination thereof (e.g., configuring), one or more sensor parameters for one or more sensors to provide animal data to one or more computing devices, the one or more sensors becoming one or more source sensors upon the one or more sensors being operable to provide the animal data to the one or more computing devices; (3) selecting and stopping (e.g., deactivating, preventing) the one or more source sensors from providing animal data to one or more computing devices which can include the collecting computing device; (4) creating, modifying, setting, or a combination thereof, one or more sensor parameters for each (e.g., or a combination/subset of sensors, or all sensors collectively) of the one or more source sensors (e.g., creating or modifying one or more sensor parameters for each of the one or more source sensors includes both creating or modifying one or more sensor parameters for a subset of the one or more source sensors as well as for all the one or more source sensors) which change one or more actions taken by the one or more source sensors or one or more computing devices in communication with the one or more sensors (e.g., change includes change in functionality of the sensor or its associated components, such as a change in sampling rate, a change in mode—turning it off, making the sensor stream at a different sampling rate, and the like; it also includes modifications of the one or more operations of the sensor—e.g. how it behaves, what the sensor does, and the like; change also includes changes to the computing device associated with the sensor, such as a changes in parameters set—such as thresholds, limits, data collection period, and the like—by the computing device or changes in its configurations; combinations like selecting and modifying include selecting and modifying one or more sensor parameters related one or more characteristics of the animal data including rate at which the animal data is gathered, the type of animal data being gathered, and the like; in a variation, a change in action can mean not taking any action at all); or (5) a combination thereof. In this context, “change” includes enabling or preventing an action or multiple actions from occurring. In a refinement, the collecting computing device transmits the one or more commands (e.g., intelligently) to another one or more computing devices in communication with, either directly or indirectly, the one or more source sensors.

In a refinement, the at least one evaluation indicator initiates, preferably automatically and/or dynamically, the collecting computing device to transmit one or more commands to another one or more computing devices, the one or more commands including at least one of: (1) provide at least a portion of animal data derived from the one or more source sensors from one computing device to another computing (e.g., with the provision of animal data occurring in a streaming, intermittent, continuous, and/or point-in-time manner, as well as in a real-time or near real-time capacity in some variations); (2) stopping the one or more computing devices from providing animal data derived from the one or more source sensors to another one or more computing devices; or a combination thereof. In this refinement, enabling a source sensor to provide data can also mean enabling a computing device collecting the data from the source sensor to provide at least a portion of such data from the source sensor to another computing device. For example, there may be request for animal data (e.g., via one or more inputs) that is already being collected via the collecting computing device, so a command is created to instruct the collecting computing device to send at least a portion of the sensor-based animal data to another computing device. In another refinement, the at least one evaluation indicator initiates, preferably automatically and/or dynamically, the collecting computing device to transmit at least one command to the one or more source sensors and at least one command to another one or more computing devices.

In a refinement, the evaluation indicator (e.g., including its one or more outputs) is compared with one or more reference evaluation indicators (e.g., which can be categorized as reference data), whereby the outcome of the comparison initiates the collecting computing device to create, modify, or access (e.g., dynamically, automatically, or both) one or more commands that provide one or more instructions to the one or more source sensors and transmit (e.g., in some variations, automatically and/or dynamically) the one or more commands to the one or more source sensors, the one or more commands including at least one of: (1) selecting and enabling the one or more source sensors to provide animal data to one or more computing devices (e.g., which can include selecting and gathering data—via the collecting device or another computing device—from one or more source sensors enabled to collect data, already programmed to collect data, or already collecting data); (2) selecting and creating, modifying, setting, or a combination thereof (e.g., configuring), one or more sensor parameters for one or more sensors to provide animal data to one or more computing devices, the one or more sensors becoming one or more source sensors upon the one or more sensors being operable to provide the animal data to the one or more computing devices; (3) selecting and deactivating the one or more source sensors (e.g., stopping the one or more source sensors from providing animal data to one or more computing devices); (4) creating, modifying, setting, or a combination thereof, one or more sensor parameters (e.g., settings) for each of the one or more source sensors (e.g., which change one or more actions taken by the one or more source sensors or one or more computing devices in communication with the one or more sensors; this can also include instructions to the one or more source sensors related to where to send data, what type of data to send, frequency data provision, and the like); or (5) a combination thereof. In a refinement, the evaluation indicator can be a threshold or an absolute value (e.g., when the subject is engaging in a specific activity in specified conditions and in light of other contextual information, x and y are the ideal settings for sensor b for use case z), which can be utilized as a reference evaluation indicator to direct the system when evaluating the at least one variable.

In another aspect, the creation, modification, setting, or a combination thereof, of the one or more sensor parameters for each of the one or more sensors, a combination of the one or more sensors, a subset of one or more sensors within each sensor (e.g., sub-sensors within a sensor), or a subset of sensors within a group of sensors, are related to a data gathering function (e.g., start/stop streaming, start/stop data collection) for each of the one or more sensors or sub-sensors (e.g., one or more sensors within a source sensor), which can include, but is not limited to, the frequency of data collection, start/stop streaming of data, start/stop data collection, sampling rate (e.g., how many times per second am I collecting the data), frequency of data gathering (e.g., how many times does the data get sent to a display device for rendering; in one illustration, heart rate may sent to the display device for rendering once every second whereas blood pressure once every hour), sampling rate of each source sensor (e.g., including sub-source sensors within each sensor), gain of each sensor (or sub sensors), mode of operation, data range, data type, firmware, power save mode, power on/off mode, and the like. In a refinement, the one or more sensor parameters are created, modified, set, or a combination thereof, for one or more sub-source sensors within the one or more source sensors. For example, in some variations, the system can change a sensor parameter for a single sub-sensor within a sensor while not affecting the other sub-sensors within the sensor or their associated parameters.

In another aspect, the creation, modification, setting, or a combination thereof, of the one or more sensor parameters occurs for two or more sensors via a single command. The system can be configured to enable creation, modification, setting, or a combination thereof, of the one or more sensor parameters for two or more sensors (e.g., which includes two or more sub-sensors within a single sensor) to occur simultaneously. In a refinement, the creation, modification, setting, or a combination thereof, of the one or more sensor parameters occurs concurrently for two or more sensors via the single command. In another refinement, the activation or deactivation of two or more sensors occurs via a single command.

In another aspect, collecting computing device 18 enables one or more inputs (e.g., from a user such as an administrator, data owner/provider, data acquirer, or the like via one or more displays or previously inputted via the reference data, from one or more Artificial Intelligence-based commands, from one or more other computing devices) that allows for one or more configurable cycles to occur (e.g., run) in order to obtain additional animal data from the one or more source sensors, different data from the one or more source sensors, or a combination thereof. For example, a doctor may provide multiple inputs where they want n number of sensors to collect data in a specific order for a specific duration of time (e.g., heart rate for 30 seconds, then stop heart rate and collect respiration data for 20 seconds, then stop respiration and collect blood pressure data). The one or more inputs can be configurable whereby the user can create or modify the one or more cycles (e.g., the doctor creates a cycle that collects heart rate data for 30 seconds, then adds respiration data collection, then stops heart rate data collection and adds blood pressure data collection, and the like), which can occur in real-time or near real-time as the user is operating the system. In a variation, one or more Artificial Intelligence techniques may be utilized to automatically (e.g., and/or dynamically) add or remove one or more sensors for data collection (e.g., or activate/deactivate one or more sensors) or set, change, or modify one or more parameters related to the one or more sensors. In another variation, one or more Artificial Intelligence techniques can be utilized to create the content of the cycle (e.g., what sensors should be used, what metrics should be collected, what operating parameters should be set for each sensor such as sampling rate, etc., and the like based upon the one or more other variables, which can include the specific one or more conditions of the subject). In a refinement, the one or more configurable cycles are automatically and/or dynamically created, modified, set, or a combination thereof, based upon one or more Artificial Intelligence techniques.

In another aspect, intelligent monitoring system 10 (e.g., via collecting computing device 18, cloud server 20, or a combination thereof) is configured to create, modify, set, or a combination thereof, one or more sensor parameters for multiple sensors simultaneously. In a refinement, a modification of one or more sensor parameters can be implemented via the same command to change the same parameter across multiple sensors or via a different one or more commands for each sensor or subset of sensors. In another refinement, one or more parameters are created, modified, set, or a combination thereof, for two or more of the source sensors, with at least two of the two or more source sensors receiving different commands. In another refinement, a single command is comprised of a plurality of commands. In another refinement, two or more parameters are created, modified, set, or a combination thereof, for at least one of the source sensors of the multiple source sensors. In still another refinement, each source sensor (e.g., including sub-source sensors within the source sensor) of the one or more source sensors, a subset of the source sensors, or all the source sensors in communication with the collecting computing device have at least one different sensor parameter created, modified, or set (or configured to be created, modified, or set).

In another aspect, at least one of the one or more source sensors can be self-regulating, at least in part, and contains at least one computing device that enables at least one of the one or more source sensors to automatically create, modify, set, or a combination thereof, one or more sensor parameters (e.g., settings). In a refinement, the one or more sensor parameters can be created, modified, or set based upon the at least one variable. For example, self-powered sensors can use internal tools to regulate sampling rate, frequency of data collection, frequency of data transmission (e.g., providing data to another computing device), frequency of sensor(s) utilized to collect data (e.g., the sensor may be comprised of multiple sub-sensors, and the sensor regulates the frequency with which each sub-sensor collects data), and the like to regulate (e.g., save) power. In another refinement, one or more Artificial Intelligence techniques are utilized in one or more of the actions taken by the source sensor or associated computing device to self-regulate the one or more source sensors.

In another aspect, collecting computing device 18 can be configured to create, modify, set, or a combination thereof, one or more sensor parameters based upon at least one animal data reading that is derived from two or more source sensors (e.g., including sub-source sensors), two or more data types (e.g., metrics), or a combination thereof.

In another aspect, collecting computing device 18 can be configured to initiate communication with at least one of the one or more sensors (e.g., source sensors) based upon one or more animal data readings from one or more other source sensors, and provide one or more commands to the at least one of the one or more sensors (e.g., source sensors) to take one or more actions as described herein (e.g., a source sensor is selected and data streaming to the collecting computing device or other computing device in communication with the collecting computing device is initiated based on one or more animal data readings from one or more other sensors). In a refinement, collecting computing device 18 runs one or more simulations using at least a portion of the animal data, the output of which initiates the computing device to automatically take the one or more actions to create, modify, set, or a combination thereof, one or more sensor parameters. In a refinement, the one or more simulations occur utilizing one or more Artificial Intelligence techniques.

In another aspect, one or more Artificial Intelligence techniques can be utilized to execute one or more of the actions taken intelligently by the system which can include, but are not limited to: (1) gathering animal data from the one or more source sensors; (2) creating, modifying, or accessing one or more commands that provide one or more instructions to the one or more source sensors to perform one or more actions; (3) transmitting the one or more commands either directly or indirectly to the one or more source sensors to create or modify one or more sensor operating parameters; (4) creating, gathering, identifying, or observing the at least one variable; (5) initiating one or more actions; (6) creating or modifying at least one evaluation indicator; (7) creating, modifying, or accessing one or more commands that provide one or more instructions to the one or more source sensors; (8) transmitting the one or more commands to the one or more source sensors; and the like. In another aspect, one or more Artificial Intelligence techniques can be utilized to execute one or more of the actions taken intelligently by the system which can include, but are not limited to: (1) selecting (e.g., Artificial Intelligence-based selection of) one or more sensors; (2) creating, modifying, setting, or a combination thereof, of their one or more associated operating parameters (e.g., including settings, functionalities, and the like); (3) the enabling of the one or more sensors to provide animal data to a computing device (if required); (4) the stopping of the one or more sensors from providing animal data to a computing device (if required); (5) the configuring of one or more sensors to provide animal data to a computing device; and the like. For definition purposes, Artificial Intelligence techniques can include, but are not limited to, Machine Learning techniques, Deep Learning techniques, Statistical Learning techniques, or other statistical techniques. In a refinement, one or more Artificial Intelligence techniques can be utilized in the one or more actions taken by the collecting computing device, cloud server, the one or more sensors, or other computing device(s) in communication with the collecting computing device, cloud server, or one or more sensors that occur automatically and/or dynamically.

In a variation, one or more Artificial Intelligence techniques are used to intelligently gather the animal data from the one or more source sensors, intelligently communicate with one or more computing devices, intelligently transmit the one or more commands either directly or indirectly to the one or more source sensors to create or modify one or more sensor operating parameters (and/or turn on or off one or more sensors), or a combination thereof. In another variation, the AI utilizes the one or more evaluation indicators to determine the manner in which the system intelligently gather the animal data from the one or more source sensors, intelligently communicate with one or more computing devices, intelligently transmit the one or more commands either directly or indirectly to the one or more source sensors to create or modify one or more sensor operating parameters (and/or turn on or off one or more sensors), and the like.

In a refinement, one or more Artificial Intelligence techniques (e.g., which includes Artificial Intelligence-based techniques) can be utilized to compare the gathered animal data from the one or more source sensors or its one or more derivatives with (e.g., or against) reference data by one or more computing devices to create, modify, or enhance at least one evaluation indicator. Such comparisons can include other gathered information including contextual data, information derived from (or related to) the at least one variable, gathered information from other individuals, and the like. In some cases, the use of one or more Artificial Intelligence techniques enables the AI to create a digital picture of the subject's body and its associated biological functions/responses derived from animal data (e.g., create a digital map of biological functions or responses associated with contextual data and other data that is specific to an individual or a subset of individuals; in many variations, it may be unique to the individual or subset of individuals) in order to execute one or more evaluations, and/or create, modify, or enhance at least one evaluation indicator. For example, by utilizing one or more Artificial Intelligence techniques, the system can analyze the reference data, animal data, gathered from the one or more source sensors, the least one variable, and contextual data (if different from the at least one variable) to create, modify, or enhance one or more evaluation indicators that can identify one or more characteristics related to the individual (e.g., identify of one or more medical conditions related the targeted individual; identify one or more biological responses of the targeted individual or that the targeted individual is engaged in; identify the targeted individual), the requisite one or more actions to be taken by the system (including actions to be taken by each of the one or more source sensors), and the like. Given that machine learning and deep learning-based systems are set up to learn from collected data rather than require explicit programmed instructions, its ability to search for and recognize patterns that may be hidden within the reference animal data and the gathered sensor data from the one or more source sensors enable machine learning and other AI-based systems to uncover insights from collected data that allow biological-based identifiers (e.g., unique identifiers), signatures, patterns, and the like to be uncovered for each individual based upon their animal data. Advantageously, because machine learning and deep learning-based systems use data to learn, it oftentimes takes an iterative approach to improve model prediction and accuracy as new data or preferences enter the system, as well as improvements to model outputs (e.g., predictions) and related accuracy derived from feedback provided from previous computations made by the system (which also enables production of reliable results). In such a scenario, new animal data from the one or more source sensors, new reference data (e.g., reference animal data), new contextual data, or the like entering the system at any given time enables a new, deeper understanding of the individual based upon a broader set of data.

By utilizing one or more Artificial Intelligence techniques such as machine learning, deep learning, or statistical learning techniques, the system can identify one or more patterns in the reference data that make collected data sets-coupled with information related to sensors, sensing parameters, and/or computing devices from which the data is derived, as well as the at least one variable-unique, searchable, and/or identifiable when compared to the other one or more reference data sets. For example, with the system being operable to create at least one evaluation indicator for each individual or group of individuals, medical condition, biological response, use case, and the like based upon the reference data, the system can analyze the incoming sensor-based data from a targeted individual (e.g., in conjunction with the one or more variables and other metadata, which may include other animal and/or non-animal data) to identify one or more unique characteristics within the targeted individual's animal data (e.g., one or more unique biological characteristics, which—either alone or in combination—can create one or more unique biological patterns or signatures or the like specific to that individual, medical condition, or biological response) to derive an evaluation indicator that directs the system to take one or more actions related to the one or more sensors (e.g., selection of the one or more sensors, turning on/off one or more sensors, creating or modifying one or more sensor parameters, or a combination thereof). In this example, the system may recognize a heart arrhythmia in an individual (e.g., based upon their baseline data), so the system automatically configures an ECG-based source sensor to collect ECG data at a higher sampling rate.

In a refinement, one or more Artificial Intelligence techniques are used to create, modify, or access one or more commands that provide one or more instructions to the one or more source sensors (and/or their associated computing devices) to perform one or more actions. The AI can be used to create or modify the one or more instructions, to identify the one or more actions required to be performed, and the like. Actions can include, but are not limited to, what one or more sensor(s) to modify, what one or more operating parameters to modify, how to modify, when to modify, where to modify, duration of modification, where to send the data, volume of data to send, frequency of sending data, what variables that impact animal data to introduce, remove, or modify (e.g., substance administration, stimuli, respiratory support, and the like) and degree of introduction/removal/modification, and the like. In a variation, the AI utilizes the one or more evaluation indicators to determine the one or more instructions and/or the one or more actions to be taken by the system.

Characteristically, the system can be configured to learn (e.g., via one or more Artificial Intelligence techniques) the one or more requirements, obligations, or targets for any given use case or requirement (e.g., with the one or more use cases, requirements, and associated obligations or targets being included as part of the reference database as reference data or other reference information), including data collection requirements, sensor-based requirements and their associating operating parameters, computing device requirements (e.g., including associated software/hardware/firmware requirements), contextual data requirements, transmission subsystem requirements, data transformation requirements, data distribution requirements, and the like in order to automatically evaluate incoming information (e.g., incoming animal data; incoming requests for data based on use cases; and the like) and create, modify or access the requite one or more evaluation indicators in order to (1) determine the requisite one or more instructions to provide to the one or more sensors (e.g., and/or their associated computing devices) based upon the requisite one or more actions the system determines that the one or more sensors (e.g., and/or their associated computing devices) need to take; (2) create, access, or modify the requisite one or more commands to send the one or more instructions that configure the sensors and their associated operating parameters (e.g., and/or their associated computing devices) in a way that meets the requirements, obligations, or targets of the one or more use cases; and (3) transmit the one or more commands to the one or more sensors either directly or indirectly to modify the one or more operating parameters.

In a refinement, one or more Artificial Intelligence techniques apply one or more trained neural networks, machine learning techniques, or a combination thereof. For example, the one or more trained neural networks utilized can include, but not be limited to, one or more of the following types of neural networks: Feedforward, Perceptron, Deep Feedforward, Radial Basis Network, Gated Recurrent Unit, Autoencoder (AE), Variational AE, Denoising AE, Sparse AE, Markov Chain, Hopfield Network, Boltzmann Machine, Restricted BM, Deep Belief Network, Deep Convolutional Network, Deconvolutional Network, Deep Convolutional Inverse Graphics Network, Liquid State Machine, Extreme Learning Machine, Echo State Network, Deep Residual Network, Kohenen Network, Support Vector Machine, Neural Turing Machine, Group Method of Data Handling, Probabilistic, Time delay, Convolutional, Deep Stacking Network, General Regression Neural Network, Self-Organizing Map, Learning Vector Quantization, Simple Recurrent, Reservoir Computing, Echo State, Bi-Directional, Hierarchal, Stochastic, Genetic Scale, Modular, Committee of Machines, Associative, Physical, Instantaneously Trained, Spiking, Regulatory Feedback, Neocognitron, Compound Hierarchical-Deep Models, Deep Predictive Coding Network, Multilayer Kernel Machine, Dynamic, Cascading, Neuro-Fuzzy, Compositional Pattern-Producing, Memory Networks, One-shot Associative Memory, Hierarchical Temporal Memory, Holographic Associative Memory, Semantic Hashing, Pointer Networks, Encoder-Decoder Network, Recurrent Neural Network, Long Short-Term Memory Recurrent Neural Network, or Generative Adversarial Network.

In another refinement, the evaluation indicator is created, modified, or enhanced utilizing one or more Artificial Intelligence techniques via the use of one or more neural networks. In general, a neural network can support the system with a variety of pattern recognition-based tasks (e.g., support in the identification, creation, modification, and/or enhancement of the evaluation indicator) and other described functions that require a relational understanding of gathered data (e.g., animal data, non-animal data, contextual data, reference data, and the like) and the at least one variable to support the creation or modification of the evaluation indicator, as well as support the system in generating artificial animal data after being trained with real animal data. In the case of artificial data creation, animal data (e.g., ECG signals, heart rate, biological fluid readings) is collected from one or more sensors from one or more target individuals typically as a time series of observations. Sequence prediction machine learning algorithms can be applied to predict possible animal data values based on collected data. The collected animal data values will be passed on to one or more models during the training phase of the neural network. The neural network utilized to model the non-linear data set (or in some variations, linear data set) can train itself based on established principles of the one or more neural networks. In another refinement, the one or more Artificial Intelligence techniques include execution of one or more trained neural networks. In another refinement, one or more of the aforementioned trained neural networks are utilized to create or modify the at least one evaluation indicator and/or support one or more system functions that enable the creation, modification, setting, or a combination thereof, of one or more sensor commands.

In another refinement, an evaluation indicator is created, modified, or enhanced using one or more Artificial Intelligence techniques based upon a subject's one or more biological-based signatures, identifiers, patterns, and the like from one or more types of animal data. In this refinement, the system can leverage the one or more Artificial Intelligence techniques to predict what the subject's body will do in one or more modeled scenarios (e.g., via one or more simulations) and create or modify one or more evaluation indicators in order to compare existing animal data (e.g., reference data, data derived from one or more source sensors or computing devices, and the like) with the subject's future animal data (e.g., simulated data) at any given point in time. For example, if the subject exhibits one or more readings that the system determines—e.g., via the one or more evaluation indicators—to be abnormal based upon a comparison with the reference data or one or more thresholds created for the data type (or the like), the system can execute (e.g., run) one or more simulations to predict what the subject's one or more animal data readings should look like (e.g., range of normal readings for that particular individual). Based upon a comparison (e.g., via an evaluation indicator) between the current animal data readings, the reference data, and the one or more simulation outputs, the system can enable/disable one or more sensors and/or change one or more sensor parameters to collect new types of data, change characteristics via the one or more parameters related to data already being collected by the one or more sensors, and the like.

In a variation, the system can be configured to utilize simulated data generated via one or more Artificial Intelligence techniques to predict one or more actions related to the targeted individual based upon their animal data (e.g., what the individual may or will do based on their animal data), and then create, modify, or access one or more commands and transmit the one or more commands to the one or more sensors either directly to the one or more sensors or indirectly (e.g., via another computing device) based upon the one or more outputs of the one or more simulations (e.g., to turn on/off a sensor or change one or more sensor parameters/settings/configurations). For example, the system may predict that a targeted individual is going to have a specific medical episode (e.g., heart attack) within a certain time period via one or more simulations and transmit one or more commands to the one or more sensors based upon the simulation output (e.g., the system may turn on or activate one or more sensors to collect more data, or increase the sampling rate of one or more of the sensors).

In a refinement, the system can be configured to utilize one or more Artificial Intelligence techniques and reference data to learn about the subject, the animal data gathered from the one or more source sensors, the context in which the data was gathered, and the one or more outcomes or outputs to predict one or more characteristics or behaviors of—or related to—the data based upon subject and the context including, but not limited to, cadence, timing, volume, gaps, and the like. Based upon the one or more predictions, the system can then create one or more commands to modify the one or more sensor parameters (e.g., update the parameters).

In another refinement, the system can be configured to utilize one or more Artificial Intelligence techniques to predict one or more future characteristics of animal data derived from the one or more source sensors (e.g., behaviors of the data, flow of the data) based upon the reference data (e.g., using related past data). The system can employ one or more AI techniques (e.g., reinforcement learning) where the system is configured to adjust one or more sensor parameters on the fly such that the one or more modifications to the one or more sensor parameters produces the most optimal data output as it pertains to the use of the data for that particular use case.

In another aspect, collecting computing device 18 creates, modifies, or gathers one or more thresholds associated with the at least one variable, wherein exceeding, meeting, or going below the one or more thresholds initiates the one or more actions (e.g., turning on/off one or more sensors, creating, modifying, setting, or a combination thereof, one or more sensor parameters, or a combination thereof). The one or more thresholds can be created or modified dynamically utilizing one or more Artificial Intelligence techniques.

In another aspect, one or more schedules for data gathering (e.g., collection) from the one or more source sensors for the at least one targeted individual are created or modified automatically (e.g., and/or dynamically) utilizing one or more Artificial Intelligence techniques based upon the at least one variable.

In a refinement, one or more commands change, adjust, and/or modify administration of one or more substances that are based upon the animal data (e.g., one or more readings from the animal data). Substances can include drugs, prescriptions, medications, or any physical matter (e.g., including liquid matter) or material. Administration includes strength, quantity, dosage, timing, and frequency of substances, as well as the actual release, dispense, and application of any given substance. For example, a patient with a disease (e.g., diabetes) may be monitored via one or more sensors that transmit one or more readings to the connection application (e.g., blood glucose readings), as well as a computing device (e.g., remote-controlled device) such as an insulin pump to aid the biological function of providing insulin to the body. Based on the one or more readings from the one or more source sensors (e.g., blood glucose sensor), the collecting computing device may be programmed to transmit one or more commands to the one or more sensors and/or remote-controlled devices (if they are separate or not paired in any way) worn or used by the patient to change, adjust, and/or modify one or more sensor parameters (e.g., release insulin into the patient's body). The command sent by the collecting computing device to the sensor and/or the device (if separate) may be, for example, to increase the sampling rate of the number of readings from the glucose sensor, or adjust the amount of insulin administered to the patient and release the insulin into the patient's body, and the like. The command sent by the collecting computing device may be programmed to be sent automatically based on one or more predefined thresholds (e.g., if the glucose levels are too high, the pump or combined pump/glucose sensor releases insulin, which may be adjusted based on the specific glucose level of the patient). In a variation, the insulin pump may be paired with a glucose sensor to monitor and regulate one or more glucose-related biological functions (e.g., blood sugar levels) based upon predefined thresholds communicated by the collecting computing device. In a refinement, one or more of the parameters (e.g., the amount of insulin administered to the patient) may be modified, at least in part, by another one or more users (e.g., doctor or medical professional). In these scenarios, the collecting computing device can transform the one or more modifications into one or more commands that are sent to the one or more sensors to create, change, set, or a combination thereof, one or more of the operating parameters (e.g., in this case, the amount of insulin being released in the patient's body via the insulin device or insulin sensor based on the glucose reading). In some variations, the collecting computing device makes a calculation, determination, or the like related to the impact of the one or more modifications, which can occur via one or more simulations, accessing reference data, or a combination thereof. In these cases, the collecting computing device can be configured to execute further modifications, or send one or more notifications to one or more users (e.g., doctor) related to the further modification (e.g., to get approval from the doctor that these changes were made prior to the implementation of the changes).

In a refinement, the system is configured to enable the one or more sensors to automatically change (e.g., switch) the one or more computing devices which they are in communication with, and provide data to (e.g., streaming data to), in order to communicate with, and provide data to, another one or more computing devices. An automatic change can be induced by the system intelligently identifying the at least one variable that necessitates the one or more sensors to switch the one or more computing devices which they are in communication with. For example, the individual may have a use case that requires continuous, real-time streaming at a specified sampling rate, but the individual is required to temporarily leave a computing device (e.g., home device or hub) that can support the use case (e.g., physically leave a location). In this case, the system can be configured to automatically change the computing device which is in communication with the sensor for another computing device that is in proximity to the individual (e.g., mobile device, an unmanned aerial vehicle-based computing device) or features one or more characteristics requisite to support the use case (e.g., more computing power; ability to provide data to the requisite end point; and the like) to enable continuous data collection by the system or continuity of data collection, at least in part. In this example, the system can be configured to detect that the individual, their associated source sensor(s), or a combination thereof, are out of range of a computing device and closer to another computing device via one or more signal strength readings between the sensor and each computing device, the identified location of the individual in proximity to each computing device, and the like. In this example, the system can be configured to take one or more actions—such as conduct one or more location/proximity scans for nearby computing devices, which can occur a plurality of times and at any given time, or make one or more evaluations (e.g., via at least one evaluation indicator) of each of the computing devices in range such as an evaluation of requisite computing/processing power or requirements, and the like—to determine the appropriate computing device to pair the one or more sensors with. In another example, the system can be configured to enable continuity in data collection from one or more of the sensors; however, the system may change one or more of the sensor parameters—if required—to ensure that the data being collected by one receiving computing device can be collected by the other one or more receiving computing devices. In a variation, the system can be configured to change one or more sensor parameters (e.g., operating parameters, settings) in order to modify the one or more sensors and ensure the one or more sensors are operable within the limitations, restrictions, parameters, or a combination thereof, of (or associated with) the computing device and vice versa (e.g., the new computing device may not be configured to handle real-time, continuous streaming at a high sampling rate, so the system automatically adjusts the sampling rate, the rate at which data is collected, how the data is stored—meaning the system may configure the sensor to store a tunable amount of data on the sensor or with an adjacent sensor associated with the individual for a period of time in order to ensure storage of the data readings—where it is stored, and the like to maximize the efficiency of the computing device while maximizing data collection opportunities based on the use case. In some variations, the system can be configured to enable a user (e.g., the individual, an administrator, or the like) to select what sensor(s), data type(s), or a combination thereof, are operable to switch computing devices (e.g., which sensors a user wants to continuously stream or collect data from or not).

Characteristically, the system can be configured to identify (e.g., via the at least one evaluation indicator) which computing device the one or more sensors are operable to communicate with (e.g., provide data to, stream to) based upon contextual data gathered by the system (e.g., the system can identify whether the individual is in a location—such as at home—and identify associated computing device(s) in that location with the requisite configurations—such as more computing power, ability to connect with requisite sensors, collect streaming data at the requisite frequency, provide data to one or more other computing devices, and the like—or whether the individual is in another location with another computing device—such as a mobile device—which may have limited computing power, limitations on the numbers of sensors it can connect with simultaneously, or the like). In this example, the system may create or modify automatically one or more sensor parameters based upon the computing device (e.g., the system may stream less data per second to a mobile computing device than a home computing device, or stream from a few number of sensors, or prioritize which sensors are to be streamed compared to other sensors based upon priority of the data being established intelligently by the system or by a user, and the like). In some variations, the system can be configured to enable one or more sensors to automatically switch the one or more computing devices the one or more sensors are in communication with and pair the one or more sensors with one or more other computing devices depending on (1) the individual's location, (2) one or more sensor data requirements based upon the use case. (3) one or more new requirements gathered by the system, (4) one or more limitations of the current computing device being used in light of the requirements by the individual/user, (5) the ability of the one or more computing devices in communication with the one or more sensors to provide the data to the targeted end point(s) (e.g., ensuring the data is sent to the requisite computing device(s), such as third-party computing devices), or a combination thereof.

In a refinement, the system is configured to create, modify, set, or a combination thereof, one or more sensor parameters based the creation or modification of one or more targets, thresholds (e.g., a monetary target or threshold; a milestone), preferences, terms (e.g., user preferences, agreement terms, conditions, permissions, restrictions, rights, and the like), or a combination thereof, associated the animal data. For example, upon a user establishing a monetary target for a future data set to be collected, the system can be configured to automatically modify the one or more sensors (e.g., change sensor operating parameters, change which metrics or what type(s) of animal data are being collected, change which metrics or what type(s) of non-animal data are being collected, turn on/off one or more sensors or activate/deactivate one or more sensors, and the like) in order to collect the requisite data (e.g., animal data, non-animal data, or a combination thereof) to achieve the monetary target. Characteristically, the system will take into account (e.g., via the one or more evaluations of the at least one evaluation indicator) at least one characteristic of the individual, the animal data, the reference data, the contextual data, or a combination thereof (e.g., a medical condition the individual may have, the activity the animal data is collected in, and the like) as it modifies the one or more sensors or its associated parameters (e.g., if the individual has a rare medical condition, the one or more sensors may need to collect less data or less metrics to achieve monetary target than if the individual has no medical condition, then the system may be required to collect more data or more metrics or at a higher sampling rate). In another refinement, the system is configured to create, modify, or access one or more commands that are transmitted to the one or more sensors to modify one or more sensors (e.g., including their one or more parameters) in order to maximize the monetary value of the collected animal data. In some variations, the system also takes into account one or more user preferences. For example, if a sports betting platform, insurance company, health analytics company, or the like wants to create a predictive indicator or insight based upon the animal data (e.g., a sprots betting platform wants to create a prediction to determine whether the athlete going to win the next game or the next point; a healthcare company wants to create a prediction related to whether an individual going to have a heart attack in the next n hours or develop diabetes over the course of the next y years; an insurance company wants to the current health score of an individual compared to other individuals that have similar characteristics; and the like), the system can be configured to automatically identify—via the evaluation indicator—the type of animal data required to generate the one or more predictive indicators or insights and automatically create one or more commands for each (or a subset) of the one or more sensors that modify one or more sensors (e.g., turn on/off one or more sensors, create or modify one or more sensor parameters) to ensure the requisite data (e.g., requisite frequency, requisite quality, requisite quantity, and the like) is collected to generate the predictive indicator or insight.

In another refinement, the system is configured to enable one or more individuals or users to input one or more targets (e.g., monetary targets or thresholds; non-monetary targets or thresholds, which can include value-based targets such as targets related to goods, services, products, and the like; targets), the one or more monetary targets inducing the system to automatically initiate one or more actions to create, modify, or access at least one evaluation indicator, wherein the at least one evaluation indicator provides information to the system that automatically initiates the system to create, modify, or access one or more commands for the one or more sensors, one or more computing devices in communication with (or associated with) the one or more sensors, or a combination thereof, to modify one or more sensor parameters in order to achieve one or more monetary targets, wherein the one or more commands are related to at least one of: type of data being collected, volume of data required, or frequency of data collection, location of where the data is being sent, or duration of data collection period. In another refinement, the system is configured to enable one or more individuals or users to input one or more preferences associated with their animal data (e.g., the at least one variable includes one or more inputs by the at least one targeted individual or other user related to one or more preferences associated with at least one targeted individual's animal data), the one or more preferences inducing the system to automatically initiate one or more actions to create, modify, or access at least one evaluation indicator, wherein the at least one evaluation indicator provides information to the system that automatically initiates the system to create, modify, or access one or more commands for the one or more sensors, one or more computing devices in communication with (or associated with) the one or more sensors, or a combination thereof, to modify one or more sensor parameters in order to conform to the one or more preferences, wherein the one or more commands are related to at least one of: type of data being collected, volume of data required, or frequency of data collection, location of where the data is being sent, or duration of data collection period. Additional details related to an animal data compliance system and method are disclosed in PCT Application No. PCT/US22/11452 filed Jan. 6, 2022; filed Sep. 12, 2022; the entire disclosure of which is hereby incorporated by reference.

In a refinement, the intelligent monitoring system can operate as part of a consideration or monetization system (e.g., marketplace, digital asset exchange) for animal data which distributes (e.g., provides, sells) at least a portion of animal data or its one or more derivatives in exchange for consideration (e.g., goods, services, cash, and the like). In another refinement, upon one or more sensor parameters being created or modified, at least a portion of the gathered animal data is transformed into one or more digital assets used to acquire consideration (e.g., the animal data is utilized as a form of collateral or as a digital currency to acquire other consideration). Additional details related to a system and method for collecting and evaluating animal data as collateral for consideration, as well as a system and method for monetizing animal data, are disclosed in U.S. patent Ser. No. 16/977,454 filed Sep. 1, 2020, and PCT Application No. PCT/US22/43220 filed Sep. 12, 2022; the entire disclosures of which are hereby incorporated by reference.

In a refinement, the intelligent monitoring system can operate as part of a sports wagering system, sports betting integrity system (e.g., which utilizes at least a portion of the sensor-based animal data and contextual data to identify fraudulent behavior in one or more targeted individuals or groups of targeted individuals such as competition/match fixing, with the one or more variables-such as abnormalities in the animal data, contextual data such as score, betting activity, and the like-inducing the system to activate and/or deactivate one or more sensors, change one or more sensor operating parameters for one or more sensors associated with one or more targeted individuals, or a combination thereof), or gamification system that utilizes at least a portion of animal data or its one or more derivatives (1) as a market upon which one or more wagers are placed or accepted; (2) to accept one or more wagers; (3) to create, enhance, modify, acquire, offer, or distribute one or more products; (4) to evaluate, calculate, derive, modify, enhance, or communicate one or more predictions, probabilities, or possibilities; (5) to formulate one or more strategies; (6) to take one or more actions; (7) to identify, evaluate, assess, mitigate, prevent, or take one or more risks; (8) as one or more signals or readings utilized in one or more simulations, computations, or analyses; (9) as part of one or more simulations, an output of which directly or indirectly engages with one or more users; (10) to recommend one or more actions; (11) as one or more core components or supplements to one or more mediums of consumption; (12) in one or more promotions; (13) to evaluate, assess, or optimize animal data-based performance for a targeted individual; or (14) a combination thereof. Additional details related to an animal data prediction system, a system for generating simulated animal data and models, an animal data-based identification and recognition system and method, a system and method for collecting and evaluating animal data as collateral for consideration, and a method and system for generating dynamic real-time predictions using heart rate variability are disclosed in U.S. patent Ser. No. 16/977,278 filed Sep. 1, 2020; U.S. patent Ser. No. 17/251,092 filed Dec. 10, 2020; PCT/US22/26532 filed Apr. 27, 2022; PCT Application No. PCT/US22/43220 filed Sep. 12, 2022; PCT/US22/30939 filed May 25, 2022; the entire disclosures of which are hereby incorporated by reference.

In a refinement, the system may be configured to achieve one or more targets. In one variation, the one or more targets are animal data-based criteria established to fulfill one or more reimbursement codes (e.g., CPT codes). In this variation, the system can store (and access) the one or more reimbursement codes as reference data with the one or more requirements to fulfill the codes. For example, a user (e.g., administrator) can input one or more codes into the system to conduct one or more data collection sessions in order to collect animal data from one or more source sensors from a targeted individual to fulfill one or more reimbursement codes. Based upon the reference data, the system is operable to identify the one or more requirements related to animal data to fulfill the one or more codes based upon previously gathered information. In this example, the system is configured to know the type of animal data required, the type of sensor(s) or computing devices (or a combination thereof) required to collect the data, their associated operating parameters, the quality of the data required, the frequency of data required, the volume of data required, and the like in order to fulfill the requirements of the one or more codes. Characteristically, the system can configure the one or more sensors to meet (e.g., achieve) the needs or requirements of the one or more codes to fulfill the one or more codes. For example, if a user is conducting a home sleep test (HST) for a condition like sleep apnea, the system can be configured to enable a user to input one or more reimbursement codes which allows the system to automatically configure each of the one or more sensors (e.g., including turning on/off sensors, changing the one or more sensor parameters, and the like) to ensure that animal data is gathered in compliance with the one or more codes to fulfill the reimbursement criteria. In one example, an individual may input a CPT code such as 95806, which is a sleep study, unattended, simultaneous recording of, heart rate, oxygen saturation, respiratory airflow, and respiratory effort (e.g., thoracoabdominal movement). In this case, the system can be configured to operate the one or more sensors, including configuring the one or more sensor parameters, to meet the requirements of fulfilling the one or more criteria/obligations of the one or more reimbursement codes based upon the reference data (e.g., a reference database which includes type of animal data required, the type of sensor(s) required to collect data, their associated operating parameters, the quality of the data required, the frequency of data required, the volume of data required, and the like for each of the one or more codes, or subset of codes).

In this variation, the system is also working to gather data based on one or more rules which are derived from the one or more codes. The combination of the one or more rules and the gathered sensor data from the one or more source systems enables the system to identify-via the at least one evaluation indicator-one or more characteristics related to the gathered animal data (e.g., the system identifies that the data is not being collected in the way it needs to be collected, or the type of data being collected does not need the standard for reimbursement; the system identifies that something is not working well between the one or more sensors and the one or more collecting computing devices; the system identifies one or more variables that impacting one or more characteristics related to the animal data such as data quality; and the like) and enables the system to make one or more modifications (e.g., create or modify one or more sensor parameters via one or more commands; turn on/off one or more sensors via one or more commands) or recommend one or more modifications to the user (e.g., administrator, home patient).

In a refinement, the system is configured to operate as a dynamic reimbursement system (e.g., for one or more reimbursement codes) based upon the system learning the requisite one or more sensors, their associated operating parameters, and the one or more associated requirements (e.g., characteristics related to the data collected) to fulfill one or more reimbursements (e.g., insurance reimbursement via the one or more CPT codes).

In a refinement, the system can be configured to enable a user (e.g., data provider, data acquirer, administrator, data owner, manager of data, and the like), the system itself, another computing device, or a combination thereof, to define (e.g., input) one or more use cases, wherein the system automatically configures the one or more sensors, one or more computing devices, one or more transmission subsystems, or a combination thereof, to execute data collection to fulfill the obligations, requirements, or targets of the one or more use cases. For example, based upon the input of a use case, the system can configure the one or more sensors (e.g., define the data collection time period by setting the required number of seconds/minutes/hours or more via the computing device for a use case; enabling the system to automatically start the sensor to initiate data collection and stop the sensor to stop data collection; changing the operating parameters for each or a subset of one or more sensors to meet the use case requirements; and the like) to fulfill the obligations of the use case. In this example, a user may want to collect an athlete's data for a defined period of time (e.g., the 4^{th} quarter of a basketball game). The system can be configured to gather contextual data (e.g., timing & scoring data) to determine—via the evaluation indicator—when the 4^{th} quarter starts so it can automatically initiate animal data collection from the athlete via the one or more source sensors via one or more commands. In a variation, the system utilizes one or more evaluation indicators to evaluate one or more characteristics related to the gathered sensor data from the one or more source sensors (e.g., quality of the data, frequency of data collected, volume of data collected, and the like) in conjunction with the one or more requirements of the one or more use cases (e.g., which can be defined by the user, by the system, by another one or more computing devices, or a combination thereof) to automatically create or modify one or more sensor parameters to fulfill the one or more requirements. In some variations, such evaluations can occur dynamically and in real-time or near real-time.

In another example, a user such as a coach or analyst of a sports team or athlete may want to know a derived insight (e.g., “fatigue level”) for the athlete on the field during a live event. The coach can make a request via one or more inputs to the system (e.g., via the display device) to acquire the real-time or near-real time derived insight. Based upon the one or more inputs, the system can be configured to determine the requisite data to derive the insight (i.e., via the evaluation indicator), automatically configure each of the one or more sensors capturing data from the athlete (e.g., including activating or deactivating one or more sensors and/or modifying one or more sensor operating parameters) to provide the requisite data to the system or other computing device in order to calculate the insight (e.g., fatigue level). The system can make one or more evaluations via the at least one evaluation indicator based upon the context (e.g., the point in time in the match), the reference data (e.g., previously generated fatigue levels for the match, the athlete's typical biological activity based upon the point in time in the match in previous matches, and the like), and other information (if required) to determine the one or more sensor configurations. The ability for the make multiple evaluations dynamically based upon any given variable (e.g., in this case, to monitor the fatigue level of the athlete continuously, such as every second, minute, period, game, or the like) can be a tunable parameter based upon one or more inputs by a user or as determined by the system.

In a refinement, one or more components related to the one or more source sensors are automatically modified (e.g., colors change on the sensor or component associated with the sensor; and the like) based upon the requirement/obligation for the user to take one or more actions (e.g., application process for utilizing the one or more sensors) as determined by the system (e.g., via the at least one evaluation indicator). In another refinement, modifying one or more source sensors includes modifying one or more components related to the one or more source sensors (e.g., turning on or off a gas switch associated with an anesthesia ventilator).

In a refinement, the system can be configured to provide one or more computing devices (e.g., via one or more machine-readable or interpretable format) or one or more users (e.g., via one or more displays or other animal readable or interpretable formats) with one or more status updates related to the one or more source sensors, their one or more parameters, the one or more collecting computing devices, the cloud server, another one or more computing devices in communication with the collecting computing device or cloud server, or the like. Status updates examples include, but are not limited to, information such as ‘in progress,’ ‘complete,’ ‘connected,’ and the like, as well as any updates related to the (1) gathering of the animal data from the one or more source sensors; (2) creation, modification, or access one or more commands that provide one or more instructions to the one or more source sensors to perform one or more actions; and (3) transmission of the one or more commands either directly or indirectly to the one or more source sensors or one or to create or modify one or more sensor operating parameters. In another refinement, it can also include the setting, creation, modification, or a combination thereof, one or more sensor parameters, as well as the distribution of animal data or its one or more derivatives to one or more computing devices.

In a refinement, the system automatically runs one or more simulations on the fly utilizing one or more Artificial Intelligence techniques based upon the animal data (e.g., the one or more sensor readings) to determine the one or more modifications for the one or more source sensor parameters.

In a refinement, the system changes and sets one or more default analysis thresholds based upon one or more characteristics of the individual (e.g., set based upon a personalized baseline of the individual derived from the reference data), the change in the one or more default analysis thresholds resulting in the system creating or modifying one or more source sensor parameters, turning on or off one or more source sensors (which can also mean activating/deactivating one or more source sensors or the like), or a combination thereof.

As an example, the system can be configured to identify the one or more computing devices that are operable and part of the system (e.g., the system knows that the individual has an application installed on their home computing device and mobile phone—or an application accessible via a web browser—all of which are operable to stream data). The system can then identify which of the one or more computing device(s) the one or more sensors should stream to—with each of the one or more sensors streaming to one or more different computing devices in some variations—based on the one or more variables. In this example, the system can be operating, at least in part, via the cloud server.

In a refinement, the system can be configured to create or modify (e.g., dynamically, automatically, or both) one or more data collection plans or schedules (e.g., including treatment plans using one or more sensors, at least in part) based upon the at least one variable (e.g., one or more limitations), with the execution of the one or more plans enabling the system to intelligently: (1) select and enable the one or more source sensors to provide animal data to one or more computing devices (e.g., which can include the collecting computing device); (2) select and configure one or more sensors to provide animal data to one or more computing devices, the one or more sensors becoming one or more source sensors upon the one or more sensors being operable to provide the animal data to the one or more computing devices; (3) select and stop the one or more source sensors from providing animal data to one or more computing devices; (4) create, modify, set, or a combination thereof, one or more sensor parameters for each of the one or more source sensors which change one or more actions taken by the one or more source sensors or one or more computing devices in communication with the one or more source sensors; or (5) a combination thereof. A plan can include a set of information and/or instructions, which can be sequential in nature, which enables a computing device to execute one or more steps to achieve a desired outcome. In a variation, the one or more data collection plans are created or modified based upon one or more use cases (e.g., requirements, targets, limitations) inputted, selected, or agreed-upon by the user. For example, an individual can establish how much data storage they have available over a period of time, with amount of storage and period of time being tunable parameters. Based upon the selected or inputted (or agreed-upon) storage capacity/limit as well as the period of time (e.g., the system has n gigabytes of available storage capacity available over 1 month or n seconds/minutes/days/weeks/months/years), the system can create a data collection plan for the period of time that enables the individual to meet the needs for the one or more use case within the or more limitations. Upon execution of the plan by the one or more computing devices (e.g., which can be preceded by one or more selections, inputs, or consents to accept the plan by the user in some variations), the system can automatically (1) create, modify, or access one or more commands for the one or more source sensors (e.g., each of the one or more sensors; a subset of the one or more sensors; all of the one or more sensors) that provide one or more instructions to the one or more source sensors to perform one or more actions, and (2) intelligently transmit the one or more commands either directly or indirectly to the one or more source sensors to create or modify one or more sensor operating parameters or enable/disable the sensor to perform one or more actions. The system can be configured to provide the one or more commands over a period of time based upon one or more predefined plans (e.g., the system may want data collected from a source sensor with a specific set of operating parameters and a different set of operating parameters at night over the course of n days, so the system automatically makes the one or more adjustments to the sensor operating parameters during tunable day and night times during the n days). In a refinement, the system can be configured to dynamically make one or more modifications to the one or more plans, including modifications to the one or more commands provided to the one or more sensors (e.g., including source sensors) related to its ability to provide animal data or adjustment of its operating parameters, based upon one or more variables. For example, the system may recognize that a sensor ran out of power or the requisite data quality for the data collected (e.g., via the evaluation indicator) did not meet a specified criteria for the use cases/requirement(s). In this case, the system can dynamically make modifications to the one or more sensor commands (e.g., the system may command the sensor to collect data for a longer period of time if the system did not collect enough data or to ensure it has enough “quality data” for its use case) and transmit the one or more commands to the one or more sensors (e.g., each of the one or more sensors; a subset of the one or more sensors; all of the one or more sensors). In a refinement, the system can be configured to provide one or more instructions to the user (e.g., targeted individual, administrator) related to the on the one or more actions required to be taken by the user, which can be communicated to the user via one or more displays or via the one or more sensors.

In a refinement, the system can be configured to intelligently make one or more modifications to the one or more actions taken by one or more computing devices, one or more sensors, or a combination thereof, based upon one or more predefined plans (e.g., data collection plans). The one or more plans can be stored and accessed as part of the reference database. For example, based upon one or more use cases (e.g., requirements, targets) inputted, selected, or agreed-upon by the user, the system can be configured to access the one or more instructions associated with the one or more plans via the reference database and automatically change one or more transmission protocols, collecting computing devices, operating parameters associated with the one or more collecting computing devices, operating parameters associated with the one or more sensors, the one or more algorithms being used to transform the collected data for the use cases, and the like, to achieve the desired outcome. In one example, a user (e.g., sports betting operator, sports bettor) can input the type of wager (e.g. sports wager). Based on the one or more inputs, the system can automatically configure the one or more sensors, one or more computing devices, one or more transmission subsystems, or a combination thereof, to execute data collection to enable the desired outcome, which is a determination (e.g., outcome) of the wager. In a refinement, based upon the one or more inputs, the system can be configured to collect data dynamically in order to enable the system to adjust one or more odds in real-time or near real-time for one or more wagers.

In at least another aspect, a system and method for intelligently selecting sensors and their associated operating parameters is provided. Referring to FIG. 1, system 10 includes one or more source sensors 12ⁱ that gather animal data 14^{j} from at least one targeted individual 16^{k}, where i, j, and k are integer labels. In this regard, computing device 18 in electrical communication with the one or more source sensors 12ⁱ. The collecting computing device 18 is configured to utilize one or more Artificial Intelligence techniques to: (1) intelligently gather the animal data 14^{j} from the one or more source sensors 12ⁱ either directly (e.g., directly from to the one or more source sensors 12ⁱ) or indirectly (e.g., via another one or more sensors 12ⁱ; via another one or more computing devices in communication with the one or more source sensors); (2) create, modify, or access one or more commands that provide one or more instructions to the one or more source sensors 12ⁱ, one or more computing devices in communication with the one or more source sensors 12ⁱ, or a combination thereof, to perform one or more actions; and (3) intelligently transmit the one or more commands either directly (e.g., directly to the one or more source sensors 12ⁱ) or indirectly (e.g., via another one or more sensors 12ⁱ; via another one or more computing devices in communication with the one or more source sensors 12ⁱ) to the one or more source sensors 12ⁱ, the one or more computing devices, or a combination thereof, to create or modify one or more sensors 12ⁱ operating parameters, one or more of the computing device's operating parameters, or a combination thereof. At least one variable is created, gathered, or observed by the collecting computing device 18, the at least one variable being utilized by the collecting computing device 18 to derive information that either directly or indirectly induces the collecting computing device 18 or other computing device in communication with the collecting computing device 18 to automatically initiate one or more actions to create, modify, access, or a combination thereof, at least one evaluation indicator. The at least one evaluation indicator provides information (e.g., via its one or more outputs) to the collecting computing device 18 or other computing device in communication with the collecting computing device 18 that automatically initiates the collecting computing device 18 to create, modify, or access one or more commands that provide one or more instructions to the one or more source sensors 12ⁱ (e.g., to take one or more actions), the one or more computing devices, or a combination thereof, and transmit the one or more commands to the one or more source sensors 12ⁱ, the one or more computing devices, or a combination thereof, the one or more commands including at least one of: (1) selecting and enabling (e.g., activating) the one or more source sensors 12ⁱ to provide animal data 14^{j} to one or more computing devices 18 (e.g., which can include the collecting computing device 18); (2) selecting and enabling (e.g., activating) a computing device gathering animal data 14^{j} from the one or more source sensors 12ⁱ (e.g., directly or indirectly) to provide animal data 14^{j} to one or more computing devices (which can include the collecting computing device 18); (3) selecting and stopping (e.g., deactivating) the one or more source sensors 12ⁱ from providing animal data 14^{j} to one or more computing devices; (4) selecting and stopping a computing device gathering animal data 14^{j} from the one or more source sensors 12ⁱ (e.g., directly or indirectly) from providing animal data 14^{j} to one or more computing devices; (5) creating, modifying, setting, or a combination thereof, one or more sensor operating parameters for each of the one or more source sensors 12ⁱ which change one or more actions taken by the one or more source sensors or one or more computing devices in communication with the one or more source sensors 12ⁱ; (6) creating, modifying, setting, or a combination thereof, one or more operating parameters for each of the one or more computing devices in communication with the one or more source sensors (e.g., direct or indirect communication) which change one or more actions taken by the one or more computing devices, the one or more source sensors 12ⁱ, or one or more computing devices in communication with the one or more source sensors 12ⁱ (e.g., direct or indirect communication, which can include one or more computing devices gathering animal data from another computing device in communication with the one or more source sensors), or a combination thereof; or (7) a combination thereof.

In this aspect, the system can be configured to send one or more commands to the one or more computing devices to modify one or more operating parameters for each or a subset (e.g., which can include all) of the one or more computing devices such that a collecting computing device can instruct another computing device in direct communication with the one or more source sensors, in indirect communication with the one or more source sensors (e.g., via another one or more computing devices), or a combination thereof, to provide the collecting device with requisite data (e.g., which can include animal data already collected by the system via the one or more source sensors) via the one or more commands. In a refinement, a modification of a computing device operating parameter can include a modification of the one or more functionalities that change the one or more actions taken by the computing device. In another refinement, the one or more actions include the provision of collected animal data from one computing device to another computing device based upon a request for the animal data via the one or more commands.

In one example, the system can be configured to enable a sports betting provider to gather the requisite animal data from one or more targeted individuals with the requisite one or more characteristics (e.g., which can be based on the one or more operating parameters associated with the one or more source sensors that captured the animal data) directly from the one or more source sensors, indirectly from the one or more source sensors via one or computing devices in communication (e.g., direct or indirect) with the one or more source sensors, or a combination thereof. The system can be configured to observe/identify, create, or gather at least one variable (e.g., volume of wagers, amount being wagered, creation of a new bet type, request to create a new bet type, odds associated with a wager, and the like). Based upon the one or more evaluations of the at least one variable (e.g., via the at least one evaluation indicator), the system can be configured to create, modify, or access one or more commands that provide one or more instructions to the one or more source sensors associated with the one or more targeted individuals, the one or more computing devices in communication with the one or more source sensors (e.g., direct or indirect) associated with the one or more targeted individuals, or a combination thereof, to gather the requisite data (e.g., animal data, contextual data). For example, the sports betting provider may require specific type(s) of animal data from one or more targeted individuals to create or modify its real-time or near real-time odds, or require specific type(s) of animal data to feed one or more models (e.g., that create one or more probabilities, possibilities, predictions, and the like), or require specific type(s) of animal data to create or modify one or more betting products (e.g., including one or more bets/wagers, prediction products), and the like. In a refinement, based upon the at least one variable (e.g., type of betting product being created or modified; type of prediction or odds being generated; the event information or contextual data associated with any given bet or outcome; and the like), the system can create one or more plans (e.g., intelligently) to gather data (e.g., animal data, contextual data, reference data, and the like) with one or more characteristics (e.g., which can be based on the one or more operating parameters associated with the one or more source sensors that captured the animal data) required to fulfill the one or more requirements related to the at least one variable (e.g., fulfill the one or more use cases). For example, in the event that a sports betting operator offers a micro bet or prop bet (e.g., in the context of baseball, a bet on whether pitcher x will throw more than y number of strikes in the 5^{th} inning versus team z), the system can be configured to create or modify one or more plans to gather animal data (e.g., including the associated characteristics associated with the animal data, which can be based on the one or more operating parameters associated with the one or more source sensors that captured the animal data) related to the one or more variables associated with the bet, including data from pitcher x (e.g., physiological data, biomechanical data, location data, and the like), data from one or more individuals associated with team z (e.g., physiological data, biomechanical data, contextual data for batters on team z facing pitcher x in the 5^{th} inning), contextual data (e.g., batter information, information related to balls and strikes thrown in the game, information related to the event occurrences including occurrences in the 5^{th} inning, and the like), reference data (e.g., historical information for pitcher x versus team z, historical information for pitcher x in 5^{th} innings, and the like), and the like, in order to take one or more actions associated with the one or more bets (e.g., create real-time odds associated with the bet, creating new bets associated with the bet). In a refinement, based upon the one or more source sensors being operable to collect animal data and identifiable by the system (e.g., in communication with, or operable to be communication with, the system, either directly or indirectly), the system is configured to generate one or more bets, betting products, one or more odds associated with one or more bets, or a combination thereof. Bet types can include a proposition bet, spread bet, a line bet, a future bet, a parlay bet, a round-robin bet, a handicap bet, an over/under bet, a full cover bet, an accumulator bet, an outright bet, a teaser bet, and the like. In another refinement, the system dynamically generates one or more new bets, betting products, odds, or a combination thereof, based upon at least one variable being created, gathered, or observed by the system (e.g. which can include new animal data gathered the system)

In at least another aspect, a system and method for intelligently selecting sensors and their associated operating parameters is provided. The system and method includes one or more source sensors that gather animal data from one or more targeted individuals. The system and method also includes a collecting computing device (i) in direct electrical communication with the one or more source sensors, (ii) in indirect electrical communication with the one or more source sensors via one or more other computing devices that are in electrical communication with the collecting computing device and configured to access at least a portion of the animal data derived from the one or more source sensors (e.g., via direct or indirect electrical communication with the one or more source sensors), or (iii) a combination thereof. At least one variable is created, gathered, identified, or observed by the collecting computing device or the one or more other computing devices based upon one or more digital sources of media, the at least one variable being derived from, at least in part, (1) one or more identifications of the one or more targeted individuals or one or more characteristics related to the one or more targeted individuals via one or more digital sources of media; (2) one or more actions [taken by one or more users and] (e.g., via one or more users; taken by one or more users) associated with the one or more targeted individuals, one or more characteristics related to the one or more targeted individuals, or a combination thereof; (3) one or more observations of (or related to) the one or more actions (e.g., via the one or more users; taken by the one or more users) associated with the one or more targeted individuals, the one or more characteristics related to the one or more targeted individuals or a combination thereof. The one or more identifications, actions, observations, or a combination thereof, induce the system to: (1) create, modify, and/or access, and transmit one or more commands to (i) one or more source sensors associated with the one or more targeted individuals, (ii) the one or more other computing devices in direct or indirect communication with the one or more source sensors associated with the one or more targeted individuals (e.g., that are configured to access at least a portion of the animal data derived from the one or more source sensors), or (iii) a combination thereof, and provide animal data derived from the one or more source sensors and associated with the one or more targeted individuals to the collecting computing device (e.g., based upon the at least one variable); and (2) intelligently identify, gather, select, create (e.g., combine), modify, or a combination thereof, one or more digital sources of media based upon (i) the one or more identifications, actions, observations, or a combination thereof; (ii) the one or more commands transmitted to the one or more source sensors, the one or more computing devices in direct or indirect communication with the one or more source sensors (e.g., that are configured to access animal data derived from the one or more source sensors), or a combination thereof; (iii) the provision of animal data derived from the one or more source sensors and associated with the one or more targeted individuals to the collecting computing device, or (iv) a combination thereof, and provide the one or more digital sources of media to the collecting computing device.

In a refinement, the at least one variable is utilized by the collecting computing device to derive information that either directly or indirectly induces the collecting computing device or other computing device in communication with the collecting computing device to automatically and/or dynamically initiate one or more actions to create, modify, and/or access at least one evaluation indicator based upon the at least one variable, wherein the at least one evaluation indicator induces the system to create, modify, and/or access, and transmit the one or more commands. In another refinement, the at least one evaluation indicator provides information to the collecting computing device that automatically initiates the collecting computing device to intelligently identify, gather, select, create (e.g., combine), modify, or a combination thereof, the one or more digital sources of media. In another refinement, the one or more actions taken by the system are taken automatically and/or dynamically. In another refinement, the collecting computing device is comprised of a network of computing devices. In another refinement, at least one of the computing devices in the network of computing devices is in direct electronic communication with the one or more sources of animal data, or indirect electronic communication with the one or more sources of animal data via one or more other computing devices, sensors, or a combination thereof.

In another refinement, the animal data derived from the one or more source sensors and the one or more digital sources of media are combined as personalized media and displayed via one or more display devices. In another refinement, the collecting computing device (e.g., or the one or more other computing devices, or other computing device in communication with the collecting computing device) takes at least one action with the one or more digital sources of media and the animal data, the at least one action including an action of synchronizing the animal data and the one or more digital sources of media, and providing the synchronized information to another computing device, a display device, or a combination thereof. In another refinement, two or more digital sources of media that are intelligently selected by the system based upon the at least one variable are combined as personalized media and displayed via one or more display devices. In another refinement, the collecting computing device (e.g., or the one or more other computing devices, or other computing device in communication with the collecting computing device) takes at least one action with the two or more digital sources of media, the at least one action including an action of synchronizing the two or more digital sources of media, and providing the synchronized digital sources of media to another computing device. In another refinement, the two or more digital sources of media include one or more data sources, video sources, graphical sources, audio sources, or a combination thereof.

In one variation, the system can be configured to collect animal data from one or more source sensors from one or more targeted individuals. The system can also be configured to collect one or more variables from one or more users (e.g., one or more user data variables/user data such as user activity data which can include activities like bets placed). Based upon the animal data from the one or more source sensors (e.g., including animal data operable to be collected) and the one or more variables, the system can utilize one or more Artificial Intelligence techniques to make one or more determinations (e.g., via one or more evaluation indicators) regarding which animal data from the one or more sensors is most applicable to the user based upon the at least one variable (e.g., their activity such as the type of bet placed) and the animal data that is currently available or operable to be available to the system (e.g., all possible data from the one or more source sensors operable to be collected by the system). For example, if the user places a bet based on a specified targeted individual scoring the next goal, the system is configured to identify what targeted individual is related to the bet, when the targeted individual touches or dribbles the ball, when the targeted individual is running towards the goal, when the targeted individual is near the goal, and the like. Once the one or more determinations (e.g., via at least one evaluation indicator) are made that a particular source sensor or subset of source sensors are most applicable to the user based upon the at least one variable (e.g., the user's bet type), the system is configured to make another one or more determinations (e.g., via at least one evaluation indicator) related to the one or more source sensors, associated the animal data, and/or the at least variable (e.g., the system determines what animal data from which of the one or more source sensors or other computing devices is required to be provided to the user based upon the user activity; the system determines what one or more sensor parameters are required to be created or modified based upon the user activity to provide the requisite data to the user based upon the user activity, such as changing the frequency interval for a given sensor attached to an athlete of interest; and the like). Based upon the one or more determinations (e.g., the output of the at least one evaluation indicator), the system creates or modifies and sends one or more commands to the one or more source sensors, or computing devices gathering animal data either directly from the one or more source sensors, to change one or more parameters as determined in the previous step (e.g., the output of the one or more evaluation indicators informs the system of requisite one or more actions to be taken by the system).

For example, the source sensor can be a video camera which provides a live streaming video feed to the system. A user can place a bet or select a fantasy sports lineup, and based upon the type of bet or lineup selected, the system can change the one or more settings of the video camera(s) (e.g., the viewing angle of the camera can change or zoom settings can be changed) and transmit the video stream to the system based on the changed camera settings. This change in the one or more settings of the source sensor results in a dynamic change of the live streaming video feed based on the system determining what a user will find more useful or most valuable in light of the at least one variable (e.g., their bet placed or fantasy team selected). In a refinement, the correlation of at the least one variable (e.g., user activity data), source sensor-based data and metadata relevant to the current event (e.g., contextual data related to the one or more targeted individuals) to the dynamically generated outputs (e.g. live streaming video feed) is captured by the system as reference data and stored such that this can be fed to the Machine Learning algorithm to further fine tune the system's one or more determinations.

In another variation, the system is configured to create, observe, (e.g., including identify) or gather, and evaluate, at least one variable. The output of the one or more evaluations (e.g., via the evaluation indicator) induces the system to select one or more digital sources of media (e.g., video feeds) amongst a plurality of digital sources of media based upon the at least one variable. The system displays (via the one or more display devices) the selected one or more digital sources of media. The system is configured to repeat (e.g., continuously, intermittently, or over the course or a tunable time period) the method for creating, observing, or gathering, and evaluating, at least one variable and customizing the selection of one or more digital sources of media based upon the at least one variable as new variables are gathered, observed, and/or created by the system. In a refinement, based upon the one or more evaluations of the at least one variable, the content within at least one of the one or more selected digital sources is customized by the system to include at least a portion of the animal data, contextual data, or a combination thereof. In another refinement, the at least one variable is identified based upon information derived from the one or more digital source of media.

In a refinement, the system can be configured to: (1) intelligently identify (e.g., via the at least one evaluation indicator) one or more targeted individuals or one or more characteristics related to the one or more targeted individuals (e.g., how fast the targeted individual is running; whether the targeted individual is on the field of play; whether the individual who is part of a subset of running backs has rushed for over n yards; and the like) via one or more digital sources of media (e.g., one or more animal data-based imagery sources such as one or more videos, streaming media, broadcast media, images, pictures, synthetic media featuring AI-generated targeted individuals, simulated media featuring avatars of targeted individuals, video games, other digital media which can be derived from one or more camera, video or other imagery sensors, computing devices, or a combination thereof; name, image, and likeness; audio data sources; other digital asset sources that include one or more characteristics related to the one or more targeted individuals; and the like); (2) enable (e.g., intelligently) one or more actions (e.g. via one or more displays) that are associated with the one or more targeted individuals or one or more characteristics related to the one or more targeted individuals (e.g., enable one or more users to place one or more bets/wagers that include or are related to the one or more targeted individuals; enable one or more users to select or input one or more targeted individuals or one or more characteristics related to the one or more targeted individuals-which can include characteristics related to their animal data-such as selecting one or more targeted individuals for a fantasy sports team, selecting or inputting the name of a targeted individual patient, and the like); (3) intelligently observe the one or more actions (e.g., which can include intelligently gathering or creating information derived from the one or more actions, which can occur via the at least one evaluation indicator) associated with the one or more targeted individuals and/or their one or more associated characteristics (e.g., the system overserving a user's interaction with a targeted individual's animal data via a web site or app; the system overserving a user's one or more selections or inputs); or a combination thereof. The one or more identifications, actions, observations, or a combination thereof, induce the system to (1) create, modify, or access, and transmit (e.g., send), one or more commands to one or more source sensors associated with the one or more targeted individuals (e.g., the one or more source sensors being operable to gather animal data from the one or more targeted individuals), one or more commands to one or more computing devices in direct or indirect communication with the one or more source sensors associated with the one or more targeted individuals that can access (e.g., which can include “or have access to”) at least a portion of the animal data derived from the one or more source sensors, or a combination thereof, to provide animal data from the one or more source sensors associated with the one or more targeted individuals (e.g., either directly or indirectly via the one or more source sensors) to a collecting computing device based upon the one or more identifications, actions, observations, or a combination thereof; and (2) intelligently identify, gather, select, or a combination thereof, one or more digital sources of media based upon (i) the one or more identifications, actions, observations, or a combination thereof, (ii) the one or more commands transmitted to the one or more source sensors or the one or more computing devices in direct or indirect communication with the one or more source sensors that can access at least a portion of the animal data derived from the one or more source sensors, (iii) the provision of animal data from the one or more targeted individuals to the collecting computing device, (iv) or a combination thereof, and provide the one or more digital sources of media to the collecting computing device. In a refinement, the gathering of the one or more digital sources of media can occur via the collecting computing device directly from the source of media (e.g., the one or more sensors/cameras, computing devices, microphones, and the like) or indirectly via one or more computing devices that gather the one or more digital sources of media. In another refinement, the one or more computing devices that gather the one or more digital sources of media are configured to take one or more actions with the one or more sources of digital sources of media (e.g., sync a plurality of media, such as the video and audio data). Upon gathering the animal data and the one or more digital sources of media, the collecting computing device takes one or more actions with the animal data and one or more digital sources of media featuring the one or more targeted individuals, at least in part (e.g., sync the animal data and the one or more streaming or broadcast media sources; provide the synced animal data and the one or more streaming or broadcast media sources to another computing device; and the like). In a refinement, the one or more actions include dynamically generating media content based upon the animal data and the one or more digital sources of media. In another refinement, the one or more actions include dynamically generating media content that combines at least a portion of the animal data gathered by the computing device and the one or more digital sources of media to create the media content (e.g., an integrated display on an application featuring a person's name and their animal data; an integrated live video feed featuring video, audio, graphics, and animal data; and the like). In another refinement, media content that includes the animal data and the one or more digital sources of media is dynamically generated or modified based upon (1) new animal data entering the system (e.g., new types of animal data; new insights derived from animal data; and the like); (2) one or more new (e.g., including previously created but now accessed) identifications, actions, or observations via the system (e.g., based upon the one or more actions of a user or third party; based upon the one or more digital media sources; based upon one or more actions of one or more other computing devices; and the like); or (3) a combination thereof. In another refinement, the one or more actions can include: (1) syncing at least a portion of the gathered animal data and at least one of the one or more digital sources of media; (2) providing the synced animal data and the at least one digital source of media to one or more displays as dynamic media content (e.g., personalized media) viewable by one or more users that includes the animal data and the at least one digital source of media; (3) providing the synced animal data and the at least one digital source of media (e.g., which may be in the form of dynamic media content or separately) to one or more other computing devices, (4), or a combination thereof. In another refinement, the one or more actions can include creating or modifying personalized media based upon the synced animal data and the at least one digital source of media. In another refinement, the one or more identifications, actions, or observations are one or more variables. In another refinement, the one or more digital sources of media include animal data. In another refinement, the one or more digital sources of media include the one or more targeted individuals. In another refinement, the one or more digital sources of media are derived from one or more source sensors and provide animal data associated with the one or more targeted individuals, at least in part.

In many variations, at least one of the one or more source sensors output (e.g., capture, gather, modify, create) one or more digital sources of media. For example, the one or more source sensors can be an optical-based camera sensor of network of camera-based sensors (or plurality of camera-based sensors) that capture live video content featuring the one or more targeted individuals. In this example, the system can be configured to create, modify, or access, and transmit, one or more commands that provide one or more instructions to the one or more one or more source sensors (or one or more computing devices in direct or indirect communication with the one or more source sensors) either directly or indirectly (e.g., via one or more computing devices) to perform one or more actions related to one or more sensor operating parameters or the one or more outputs (e.g. a command to change a sensor setting on the one or more cameras; a command to alter the digital source of media—such as crop a video or display only a portion of the video based upon one or more selections or inputs or observations—via one or more computing devices; and the like). In a refinement, the one or more source sensors capture animal data and output one or more digital sources of media.

In a refinement, the dynamically generated or modified media content is provided to one or more users via one or more display devices for a definable period of time, with the period of time being a tunable parameter and automatically created or adjusted by the system based upon the at least one variable. For example, in the event that a user places a micro bet or prop bet (e.g., in the context of baseball, a bet on whether pitcher x will throw more than y number of strikes in the 3^{rd} inning), the system can be configured to provide the dynamic media content personalized for the user featuring pitcher x and data associated with the bet to the one or more users (e.g., which can include number of balls/strikes, pitch speed, biomechanical data related to the pitcher, reference data, physiological data, and the like) for a defined period of time (e.g., the system grants the user access to the dynamic media content through the completion of the bet, which in this example would be the 3^{rd} inning). In this example, personalized media content can also include (i.e., in some variations) the bet type, the odds associated with the bet, the real-time odds, new bets (e.g., micro bets, prop bets, and the like) associated with the content displayed (e.g., visually) via the one or more display devices (e.g., the system may dynamically generate one or more new bets based upon the content the user is consuming), and the like. In another refinement, the system dynamically generates one or more new markets, bets, or products (e.g., prediction indicator-bases products, insight-based products, computed asset-based products, reference data-based products, and the like) based upon the one or more identifications, actions, observations, or a combination thereof, by the system (e.g., based upon the personalized media content displayed via the one or more display devices). Specific types of bets can include a proposition bet (“prop bet”), spread bet, a line bet, a future bet, a parlay bet, a round-robin bet, a handicap bet, an over/under bet, a full cover bet, an accumulator bet, an outright bet, a teaser bet, and the like. In a refinement, a market or bet includes at least one of a proposition bet, spread bet, a line bet (moneyline bet), a future bet, a parlay bet, a round-robin bet, a handicap bet, an over/under bet, a full cover bet, an accumulator bet, an outright bet, or a teaser bet. In a variation, the one or more new bets or products can be incorporated into the dynamically generated or modified media content in real-time or near real-time (e.g., and adjusted in real-time or near real-time) based upon (1) new animal data entering the system (e.g., new types of animal data); (2) one or more new identifications, actions, or observations by the system; or (3) a combination thereof. In another refinement, the system dynamically generates one or more new bets based upon the one or more observations by the system related to the personalized media content generated for the user. In another refinement, upon creation and distribution of the personalized media content (e.g., via one or more displays; via one or more computing devices that provide the dynamic media content to one or more displays), the system can be configured to enable a revenue sharing between one or more stakeholders (e.g., which can include the one or more targeted individuals) based on the consideration (e.g., currency) derived from each bet (e.g., based on the amount wagered, gross gaming revenue, or other metric) and the consideration received by the collecting computing device or other computing device in communication with the collecting computing device.

In one example, the system can create one or more dynamic media streams personalized for one or more users (e.g., inclusive of data and video/audio content, which can occur in real-time or near real-time to provide a live viewing experience) based upon the one or more actions by one or more users via one or more displays (e.g., a user placing a bet associated with the one or more targeted individuals; one or more selections of one or more targeted individuals via a display device for their fantasy sports team; selection of a patient's name from a subset of names). For example, a sports bettor may place a wager related to one or more targeted individuals or input (e.g., select) animal data-based information the bettor is interested in viewing or consuming (e.g., via a display device) prior to the determination of an outcome. Upon placing the bet and/or providing an input (i.e., one or more variables), the system can be configured to evaluate the bet and intelligently identify the one or more targeted individuals and animal data associated either directly or indirectly with the bet, enable the user to select of one or more targeted individuals associated with the bet and the animal data associated with the bet that the user would like to view or otherwise consume via a display device for a period of time (e.g., through the outcome of the bet), or a combination thereof. Based upon the identification and/or selection, the system can be configured to send one or more commands to the one or more source sensors associated with the targeted individual—or send one or more commands to the one or more computing devices in direct or indirect communication (e.g., via another computing device) with the one or more source sensors that have access to animal data derived from the one or more source sensors—to gather the requisite animal data, as well as gather the one or more digital sources of media associated with the one or more bets or inputs (e.g., imagery sources such as video, images, and/or graphics; audio sources; contextual data such as statistics of the individual, reference animal data; real-time odds related to the bet; additional bets; and the like). The system can be further configured to sync—at least in part—the one or more digital sources of media (e.g., imagery sources, audio sources, contextual data, wager information, and the like) and the animal data to generate (e.g., dynamically) one or more forms of media content (e.g., personalized live stream or broadcast video), or modify (e.g., dynamically) one or more forms media content, based upon the one or more bets or inputs. The manner in which the various elements are presented graphically via the one or more displays (e.g., the one or more digital sources of media, the animal data, and the like) can be a tunable parameter. For example, the dynamically generated or modified media provided to the user can include a plurality of graphical elements incorporated (e.g., integrated) within a window or multiple windows featuring the video, audio, animal data, contextual data, or a combination thereof, via one or more displays (e.g., television, smart phone, tablet, laptop, VR system, AR system, mixed reality system, simulation system, and the like) to enable a customized content consumption experience for the user (e.g., bettor) related to their bet or input (or both) and the animal data. In a variation, the dynamically generated or modified media can include one or more live (e.g., real-time or near real-time) digital sources of media (e.g., video and/or audio feeds) associated with one or more events (e.g., sporting events) and the content of the one or more bets or inputs, with one or more graphical elements incorporated as part of the visual display to present the digital information to the user in conjunction with the one or more video/audio feeds such as the animal data, contextual data, and the like. In a refinement, the system can be configured to intelligently gather the requisite content (e.g., animal data, digital sources of media, contextual data, reference data, and the like) based upon one or more observations of the one or more targeted individuals and animal data associated either directly or indirectly with the bet to dynamically create personalized media for the user. In another refinement, based upon the one or more bets being placed or the one or more fantasy sports lineups selected (e.g., if users place the same type of bet, or users pick the same fantasy sports lineup or team), the same dynamic media content can be provided to a plurality of users. In another refinement, the personalized media includes one or more digital representations (e.g., synthetic media; simulated events) of the real world (e.g., one or more real-world events) with the one or more targeted individuals featured as avatars or as AI-generated media.

In another variation, the animal data, contextual data, and/or other digitized information can be featured within the dynamically generated or modified media content via an application or program that overlays information (e.g., graphically) on other digital sources of media (e.g., live video sources; audio/video, which can include video from one or more optical sensors, a simulation featuring the one or more targeted individuals as avatars presented as representation of the real-world competition; and the like), including combined digital sources of media (e.g., the graphical information can include the animal data and contextual data content directly incorporated into the displayed media content via one or more graphical elements featured within, alongside, below, above, or surrounding the video content, at least in part; characteristically, such an overlay enables at least a portion of the same underlying digital sources—e.g., audio/visual sources—to be utilized for multiple users such as bettors, fantasy sports participants, and the like while enabling customization of the animal data and contextual data based upon the one or more bets or inputs). This can include, for example, wager-based or fantasy sports-based digital information (e.g., overlayed on a video), which can include real-time or near real-time prediction information, information related to the likelihood of any given outcome based on the bet, information related to the accumulation of points for fantasy sports (e.g., which the system can be operable to perform one or more calculations to create and display a personalized real-time or near-real-time indicator or multiple indicators for each user or subset of users related to their fantasy sports points), information related to the animal data, contextual data, reference data, and the like

In another variation, the one or more wagers, fantasy sports selections, or inputs based upon personal preferences of a user can induce the system to intelligently identify the one or more targeted individuals (e.g., the athletes) associated with the one or more wagers (or selections or inputs), the animal data associated with the one or more wagers (or selections or inputs), any other digital sources of media associated with the one more wagers (or selections or inputs), or a combination thereof, and dynamically create or modify media content personalized based upon the one or more wagers, selections, inputs, or a combination thereof, (e.g., a personalized video feed featuring live video content) for the bettor (or fantasy sports participant) based upon the available digital media sources (e.g., video feeds) that can include at least a portion of the one or more targeted individuals' animal data. The personalized media content can utilize one or more digital sources (e.g., one or more live streaming or broadcasting videos) from one or more source sensors (e.g., optical sensors such as cameras). For example, if a sports competition has a 16-camera set up (with 16 different video feeds), the system can be configured to intelligently select the appropriate one or more video feeds at any given time related to the one or more bets (or fantasy sports selections or preference inputs) from each of the 16 cameras in real-time or near real-time to enable a user to view the sports match based upon the system's intelligent selection of the appropriate video feeds based upon their one or more bets or selections or inputs. In a refinement, the content of the dynamically generated or modified media content (e.g., the one or more targeted individuals that are highlighted or selected in the live streaming or broadcast video; the animal data or contextual data associated with the live streaming or broadcast video) can be a tunable parameter based upon or more inputs from one or more users, administrators (e.g., content platforms that provide the dynamic media content service), and/or observations by the system (e.g., which gather information for the system to take one or more actions). In another refinement, the system can provide the user with a plurality of dynamically generated or modified media content simultaneously within a single screen or across multiple screens, with the user being able to customize (e.g., personalize) their content consumption experience (e.g., viewing experience) and select the one or more media they want to consume (e.g., watch). In this example, amongst a plurality of windows featuring media content, the user can select the one or more windows to enlarge in order to better view the content. The system can be configured to enable a user to change the one or more windows being viewed at any given time. The system can also be configured to enable an administrator to charge a fee based on the content being viewed in the one or more windows, the number of windows being viewed, viewing time for each or subset of the one or more windows, and the like. In another refinement, the customized content consumption (e.g., viewing) experience can be sold or distributed to a user via one or more pricing mechanisms (e.g., ad-hoc on a per bet, per event, or per dynamically-generated media content basis, via one or more subscriptions, and the like).

In another refinement, intelligent monitoring system 10 is utilized to generate or modify media content dynamically as part of a media platform or media-based system. The media platform or media-based system can be operable to enable one or more users (e.g., media producer, broadcaster, digital publisher, sports betting platform, fantasy sports platform, fan/customer, content creator, healthcare administrator, or any type of user) to select one or more digital sources of media (e.g., digital media feeds such as video/visual feeds, audio feeds, data feeds, graphics, static imagery, animated imagery, or a combination thereof, to create dynamic media content) via one or more display devices (which can include a display screen featuring multiple media content windows with each window featuring different media content, multiple media content windows featured within a single display screen, multiple display screens with one or more media content windows in each of the display screens featuring different media content, and the like; in some variations, the one or more display devices can include one or more selection devices to control the one or more display devices, including selection of the one or more sources of digital media). Characteristically, the system can be configured for a user to select at least one variable (e.g., via a display device)—which can include the one or more targeted individuals (including groups of targeted individuals) associated with the one or more source sensors on the court/field/competition/activity space the user is interested in viewing, the content the user is interested in consuming (e.g. viewing), which can be based on one or more animal data-based thresholds or targets (e.g., when a player runs faster than 20 mph, when a player's HR reaches above 180 beats per minute, when a team's fatigue level collectively reaches below 50%, and the like), the one or more sports, the one or more types of competition, and the like-across one or more competitions or activities simultaneously, which can include multiple, simultaneous competitions or activities/events. Gathering, creating (e.g., calculating), observing, or a combination thereof, the at least one variable induces the system to take one or more actions (e.g., analyze) with gathered animal data from the one or more source sensors, or one or more computing devices gathering animal data from the one or more source sensors), from each of the one or more targeted individuals (e.g., athletes, participants) individually and/or collectively depending on the selected variable and/or source sensor(s). When the selected one or more variables occur (e.g., it is gathered and occurs; it is calculated and occurs; it is observed to occur), the system is configured to enable the media source displaying the media content (e.g., display device) to automatically (and dynamically) render one or more digital sources of media (e.g., video feed) for the user that incorporates the at least one variable (e.g., graphically as part of the video feed). The system can be configured to automatically (and dynamically) select the one or more media feeds (e.g., dynamic media content) to display to a user via a display device, or provide a user with the option to select the one or more media feeds they would like to consume (e.g., view) via the display device. Such dynamic rendering can occur in real-time or near real-time. In some variations, the one or more digital sources incorporates (e.g., graphically) information related to the at least one variable into the rendered media (e.g., the animal data associated with the at least one variable is included as part of the video feed being rendered; other animal data is included as part of the video feed being rendered; and the like). In a refinement, the display device enables a user to select at least one of the one or more digital sources of media to include in the one or more media feeds. For example, the system can be configured to enable a user to “drag and drop” one or more digital sources of media they are interested in viewing—such as animal data, reference data, contextual data, animated imagery, static imagery, and the like—as part of the live broadcast video and audio feed via the display device touchscreen or other controlling mechanism, and the system can be configured to dynamically incorporate the selected one or more digital sources of media into the live broadcast video via one or more graphical overlays. In another refinement, the one or more graphical overlays being customizable by the one or more users, at least in part. This enables a user to customize the media content they consume with one or more digital sources of media.

In another refinement, and in the context of sports, the at least one variable (e.g., which can be a tunable parameter and/or a selectable parameter by a user), such as a targeted individual achieving an animal data-based threshold or target (e.g., a player's heart rate reaches 95% of their max heart rate), or an one or more actions by one or more users (e.g., placing one or more bets, selecting one or more fantasy sports lineups, and the like) can dynamically modify (e.g., enhance) a digital source of media amongst a plurality of sources of digital media via the display device based upon gathering, observation, creation, or a combination thereof, of the at least one variable. Such enhancement can occur in real-time or near real-time over a tunable period of time. For example, a live stream or broadcast video featuring the targeted individual may be dynamically selected by the system and enlarged on the screen of the display device amongst a plurality of live stream or broadcast videos also being shown on the screen of the display device based upon the gathering, observation, creation, or a combination thereof, of the at least one variable. In another example, the system may switch from one video feed to another video feed within the display that features the selected one or more variables (e.g., a user is interested in viewing all content featuring n targeted individuals or y groups of targeted individuals, so the system can be configured to only feature the video content with n targeted individuals, y groups of targeted individuals, or a combination thereof). The system can then toggle between one or more video feeds within a single display screen based upon another one or more variables being observed, gathered, created, or the like, inducing the system to take another one or more actions (e.g., switching the video feed to another video feed that features the at least one variable). Characteristically, such toggling can occur dynamically and in real-time or near real-time. In one variation, the system is configured to enable multiple video feeds to be rendered simultaneously within a single display window, with the inducing factor for switching between the one or more video feeds based upon the at least one variable (1) selectable by a user (e.g., which can also be a third party), (2) created, modified, observed, or a combination thereof, by the system, or (3) a combination thereof. Its use cases in sports include fan engagement (e.g., broadcast, fantasy sports, sports betting), performance optimization (e.g., in-game coaching and analysis), and the like, as well as non-sports use cases. In another refinement, the at least one variable is derived from at least a portion of animal data via the one or more source sensors.

In a refinement, the system (e.g., collecting computing device or other computing device operating the system's one or more displays) can be configured to create, modify, access, or a combination thereof, one or more wagers based upon the one or more actions by the one or more users (e.g., selections, inputs, other actions) and provide the one or more wagers to the one or more users via one or more displays. Characteristically, the one or more wagers can be incorporated (e.g., graphically) as part of the dynamic media content (e.g., featured within the same content window via the display), and the display device is configured to enable the user to take one or more actions with the one or more graphical elements related to the wager (e.g., place a bet via the graphical element). For example, a user may select their favorite one or more players, or select a function that enables the user to view the real-time heart rates or location-based data while watching a sporting event. In this example, the system can be configured to provide one or more wagers based on the one or more selections (e.g., heart rate or location-based data) to the user via the display as part of the system's rendering of the dynamic media content derived from the one or more digital sources of media. In one variation, the one more wagers can be provided to a user via the display as one or more alerts (e.g., a pop-up shown as a graphical overlay as the dynamic media content, such as a live sporting event, is being viewed/watched by the user).

In a refinement, animal data derived from the one or more source sensors modifies the dynamic media content that is selected and displayed by the system via the one or more display devices. Characteristically, the system can be configured to dynamically select the one or more digital sources of media based upon new animal data being gathered by the system. For example, the system can be configured to change the dynamic media content (e.g., live video content such as a live stream or broadcast) displayed on the display device based upon one or more computed assets, insights, predictive indicators, or the like generated by the system. In one example, if an athlete in competition A reaches an animal data-based milestone or other milestone (e.g., the athlete's heart rate reaches above 190 beats per minute; the athlete's speed exceeds 20.0 mph; the athlete completes 6 passes in a row; and the like), the system can be configured to dynamically change the media content (e.g., the live video/audio broadcast) being displayed from another event to Event A based upon achievement of the one or more milestones. The one or more milestones, targets, or thresholds be tunable parameters established by one or more users, the system (e.g., which can be created automatically and adjusted dynamically based upon information gathered by the system, including what content is most interesting to viewers, what content is most interesting to the user, what content generates the most revenue, and the like), or third party.

In another refinement, the system can be configured to run one or more simulations to create synthetic or other simulated media that recreates one or more events (e.g., sporting events) from which (1) one or more wagers are placed or accepted; (2) one or more wagers are accepted; (3) one or more products are created, enhanced, modified, acquired, offered, or distributed; (4) one or more predictions, probabilities, or possibilities are evaluated, calculated, derived, modified, enhanced, or communicated; (5) one or more strategies are formulated; (6) one or more actions are taken or recommended; (7) one or more risks are identified, evaluated, assessed, mitigated, prevented, or taken; (8) animal data-based performance for a targeted individual is to evaluated, assessed, or optimized; or (9) a combination thereof. Characteristically, the synthetic media can include one or more digital representations of the one or more targeted individuals (e.g., athletes) that includes at least a portion of their real-world animal data. Based upon a selection of the matchup (e.g., Team A from 2019 vs Team B from 2021), the system can be configured to gather animal data from one or more computing devices in communication with the one or more source sensors (e.g., which can include previous communication), send one or more commands to the one or more computing devices to gather the requisite animal data from each (or a subset) of the one or more targeted individuals to incorporate into the one or more simulations to re-create a simulated event from which one or more bets or products are created or modified. In a refinement, the system can be configured to gather animal data from at least one targeted individual via one or more source sensors or via one or more computing devices in communication with the one or more source sensors. For example, the system may run a simulation (and create one or more betting opportunities based upon the one or more simulations) to determine whether real-world player A in 2021 would beat simulated player B in 2016 based upon the real-world animal data collected from player A via the one or more source sensors (e.g., either directly or indirectly) and the real-world animal data collected from player B via one or more computing devices.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-59. (canceled)

60. A system for intelligently selecting sensors and their associated operating parameters comprising:
one or more source sensors that gather animal data from at least one targeted individual; and
a collecting computing device in electrical communication with the one or more source sensors, the collecting computing device configured to utilize one or more Artificial Intelligence techniques to: (1) intelligently gather the animal data from the one or more source sensors; (2) create, modify, or access one or more sensor commands that provide one or more instructions to the one or more source sensors to perform one or more actions; and (3) intelligently transmit the one or more sensor commands either directly or indirectly to the one or more source sensors to create or modify one or more sensor operating parameters, wherein:
at least one variable is created, gathered, or observed by the collecting computing device, the at least one variable being utilized by the collecting computing device to derive information that either directly or indirectly induces the collecting computing device or other computing device in communication with the collecting computing device to automatically initiate one or more actions to create or modify at least one evaluation indicator.

61. The system of claim 60 wherein the at least one evaluation indicator provides information to the collecting computing device or other computing device in communication with the collecting computing device that automatically initiates the collecting computing device to create, modify, or access one or more commands that provide the one or more instructions to the one or more source sensors, and transmit the one or more commands to the one or more source sensors.

62. The system of claim 60 wherein the at least one evaluation indicator refers to one or more of digital signatures, thresholds, identifiers, patterns, trends, scores, actions, features, measurements, anomalies, charts, visual representations, numerical representations, predictions, probabilities, evaluations, comparisons, instructions, projections, or recommendations.

63. The system of claim 60 wherein the one or more actions to create or modify at least one evaluation indicator include one or more calculations, computations, derivations, extractions, simulations, comparisons, modifications, estimations, evaluations, inferences, determinations, interpretations, or observations.

64. The system of claim 60 wherein the collecting computing device is operable for two-way communication with the one or more source sensors.

65. The system of claim 60 wherein the collecting computing device transmits the one or more commands to another one or more computing devices in communication with, either directly or indirectly, the one or more source sensors.

66. The system of claim 60 wherein the at least one variable includes animal data, non-animal data, or a combination thereof.

67. The system of claim 60 wherein the collecting computing device includes one or more display devices operable to display at least a portion of animal data readings, information related to the one or more source sensors, sensor parameters, contextual data, or the at least one variable.

68. The system of claim 60 wherein the animal data is provided in real-time or near real-time.

69. The system of claim 60 wherein the collecting computing device utilizes one or more Artificial Intelligence techniques to automatically create, modify, or access one or more sensor commands based on at least one evaluation indicator.

70. The system of claim 60 wherein the at least one variable includes time, sensor readings, contextual data, data storage thresholds, preferences, latency, sensor signal strength, use case, targets, inputs, power availability, sensor type, data type, placement of sensor, body composition, medical conditions, health information, activity, environmental conditions, previous sensor readings, data quality, data set size, system performance, collecting computing device performance, cloud server performance, or a combination thereof.

71. The system of claim 60 wherein the collecting computing device creates, modifies, or gathers one or more thresholds associated with the at least one variable, wherein exceeding, meeting, or going below the one or more thresholds initiates the one or more actions.

72. The system of claim 60 wherein the collecting computing device is configured to create, modify, or access one or more sensor parameters based on animal data readings derived from two or more source sensors or data types.

73. The system of claim 60 wherein at least one of the one or more source sensors includes two or more biological sensors.

74. The system of claim 60 wherein one or more Artificial Intelligence techniques are utilized to perform the one or more actions.

75. The system of claim 60 wherein at least one of the one or more source sensors gathers non-animal data.

76. The system of claim 60 wherein the one or more commands are transmitted to each of the one or more source sensors, a subset of the one or more source sensors, or all the sensors.

77. The system of claim 60 wherein the collecting computing device enables one or more inputs that allow for configurable cycles to occur to obtain additional or different animal data from the one or more source sensors.

78. The system of claim 77 wherein the one or more configurable cycles are automatically created, modified, set, or a combination thereof, based upon one or more Artificial Intelligence techniques.

79. The system of claim 60 wherein the collecting computing device includes a network of computing devices.

80. A method for intelligently selecting sensors and their associated operating parameters comprising:
gathering animal data from one or more source sensors from at least one targeted individual, the one or more source sensors configured to be in electronic communication with a collecting computing device;
creating, gathering, or observing, via the collecting computing device, at least one variable, the at least one variable being utilized by the collecting computing device to derive information that either directly or indirectly induces the collecting computing device or another computing device in communication with the collecting computing device to automatically initiate one or more actions to create or modify at least one evaluation indicator;
deriving, via the collecting computing device or other computing device in communication with the collecting computing device, information from the at least one evaluation indicator, wherein at least a portion of derived information automatically initiates the collecting computing device to take the one or more actions, the one or more actions including:
creating, modifying, or accessing one or more commands that provide one or more instructions to perform the one or more actions to the one or more source sensors, and
transmitting the one or more commands to the one or more source sensors, the one or more commands including at least one of: (i) selecting and enabling the one or more source sensors to provide animal data to one or more computing devices; (ii) selecting and deactivating the one or more source sensors; (iii) creating, modifying, setting, or a combination thereof, one or more parameters for each of the one or more source sensors which change one or more actions taken by the one or more source sensors or one or more computing devices in communication with the one or more source sensors; or (iv) a combination thereof.

81. The method of claim 80 wherein the collecting computing device is configured to utilize one or more Artificial Intelligence techniques to: (1) intelligently gather the animal data from the one or more source sensors; (2) create, modify or access one or more commands that provide the one or more instructions to (i) the one or more source sensors, (ii) one or more computing devices in communication with the one or more sensors either directly or indirectly, or (iii) a combination thereof, to perform the one or more actions; and (3) intelligently transmit the one or more commands either directly or indirectly to the one or more source sensors to create or modify one or more sensor operating parameters.

82. A system for intelligently selecting sensors and their associated operating parameters comprising:
one or more source sensors that gather animal data from one or more targeted individuals; and
a collecting computing device (i) in direct electrical communication with the one or more source sensors, (ii) in indirect electrical communication with the one or more source sensors via one or more other computing devices that are in electrical communication with the collecting computing device and configured to access at least a portion of the animal data derived from the one or more source sensors, or (iii) a combination thereof, wherein:
at least one variable is created, gathered, identified, or observed by the collecting computing device or the one or more other computing devices based upon one or more digital sources of media, the at least one variable being derived from, at least in part, (1) one or more identifications of the one or more targeted individuals or one or more characteristics related to the one or more targeted individuals via one or more digital sources of media; (2) one or more actions associated with the one or more targeted individuals, one or more characteristics related to the one or more targeted individuals, or a combination thereof; and/or (3) one or more observations of the one or more actions associated with the one or more targeted individuals, the one or more characteristics related to the one or more targeted individuals or a combination thereof, wherein the one or more identifications, actions, observations, or a combination thereof, induce the system to:
create, modify, or access, and transmit one or more commands to (i) the one or more source sensors associated with the one or more targeted individuals, (ii) the one or more other computing devices in direct or indirect communication with the one or more source sensors associated with the one or more targeted individuals, or (iii) a combination thereof, and provide animal data derived from the one or more source sensors and associated with the one or more targeted individuals to the collecting computing device; and
intelligently identify, gather, select, create, modify, or a combination thereof, the one or more digital sources of media based upon (i) the one or more identifications, actions, observations, or a combination thereof; (ii) the one or more commands transmitted to the one or more source sensors, the one or more other computing devices in direct or indirect communication with the one or more source sensors, or a combination thereof; (iii) provision of animal data derived from the one or more source sensors and associated with the one or more targeted individuals to the collecting computing device, or (iv) a combination thereof, and provide the one or more digital sources of media to the collecting computing device.

83. The system of claim 82 wherein the animal data derived from the one or more source sensors and the one or more digital sources of media are combined as personalized media and displayed via one or more display devices.

84. The system of claim 82 wherein the collecting computing device takes at least one action with the one or more digital sources of media and the animal data, the at least one action including an action of synchronizing the animal data and the one or more digital sources of media, and providing the synchronized information to another computing device, a display device, or a combination thereof.

85. The system of claim 82 wherein two or more digital sources of media that are intelligently selected by the system based upon the at least one variable are combined as personalized media and displayed via one or more display devices.

86. The system of claim 85 wherein the collecting computing device takes at least one action with the two or more digital sources of media, the at least one action including an action of synchronizing the two or more digital sources of media, and providing the synchronized digital sources of media to another computing device.

87. The system of claim 86 wherein the two or more digital sources of media include one or more data sources, video sources, graphical sources, audio sources, or a combination thereof.

88. The system of claim 82 wherein the at least one variable is utilized by the collecting computing device to derive information that either directly or indirectly induces the collecting computing device or other computing device in communication with the collecting computing device to automatically initiate one or more actions to create, modify, or access at least one evaluation indicator based upon the at least one variable, wherein the at least one evaluation indicator induces the system to create, modify, or access, and transmit the one or more commands.

89. The system of claim 88 wherein the at least one evaluation indicator provides information to the collecting computing device that automatically initiates the collecting computing device to intelligently identify, gather, select, create, modify, or a combination thereof, the one or more digital sources of media.

90. The system of claim 82 wherein the collecting computing device is comprised of a network of computing devices.

91. The system of claim 82 wherein the collecting computing device is configured to access at least a portion of the animal data derived from the one or more source sensors via direct or indirect electrical communication with the one or more source sensors.
